(19) United States
(12) Patent Application Publication
(10) Pub. No.: US 2020/0387887 A1
(43) Pub. Date: Dec. 10, 2020

(54) Selected place on maps associated uniform resource locator (URL) or selected place associated merchant account based payment transactions, connections, offers, order, deals, reservation and call-to-actions

(71) Applicant: Yogesh Rathod, Mumbai (IN)

(72) Inventor: Yogesh Rathod, Mumbai (IN)

(21) Appl. No.: 17/003,145

(22) Filed: Aug. 26, 2020

Related U.S. Application Data
(63) Continuation of application No. PCT/IB2020/057617, filed on Aug. 13, 2020.

(51) Int. Cl. G06Q 20/32; G06F 16/955

(52) U.S. Cl. CPC G06Q 20/3267; G06F 16/955

(57) ABSTRACT

The present disclosure relates to systems, methods, graphical user interface and devices for identifying identity of merchant based on selected from maps, particular place associated website or webpage uniform resource locator (URL) or selected place on maps and enabling user to directly make payment from user payment account to said identified merchant's account including merchant bank account or debit card. In another embodiment enabling user or merchant to connect with each other via merchant client application and user client application and share or request payloads for the transaction and conduct payment transaction, communication, view orders, status, provide deals, offers, booking and one or more types of call-to-actions. The present disclosure relates to point of sale terminal systems and contactless mobile payment systems and relates to methods and systems for completing a transaction through internet or data network.

### FIELD OF INVENTION

The present invention relates to selecting place on maps including 3^{rd} parties maps application associated website or webpage uniform resource locator (URL) or selecting place on maps and identifying user's identity based on user client application or user client device or login from said opened website and identifying identity of merchant based on said clicked or tapped or selected website or webpage uniform resource locator (URL) or selected place associated merchant's unique identity and enabling user to directly make payment from user payment account to said identified merchant's account including merchant bank account or debit card. In another embodiment enable user or user client device or user client application and merchant or merchant client device or merchant client application to connect with each other and share payloads for the transaction and conduct payment transaction, view orders, status, provide deals, offers, booking or reservation and one or more types of call-to-actions. One or more embodiments described herein relate generally to systems and methods for user and merchant identification for electronic payments. More specifically, one or more embodiments relate to systems and methods of enabling consumer identification and merchant identification for connecting, communicating, processing in-store electronic payment transactions. The present disclosure relates to point of sale terminal systems and contactless mobile payment systems and more particularly relates to methods and systems for completing a transaction through internet or data network.

### BACKGROUND OF THE INVENTION

Many payment technologies including pay via scanning QR code, pay via nearby users based on Bluetooth, pay via selecting from list of locations, pay by swiping debit or credit card via point of sales terminal, pay cash, pay via (NFC), pay via mobile phone number, pay via recognizing face of customer, and other technologies available for making payments. When purchasing goods at an offline store, rather than via an online store, consumers can pay in a variety of methods. Specifically, consumers can pay for goods or services at a variety of stores using cash, physical credit/debit card, or electronically with near field communication. For example, conventional electronic payment systems allow users to perform electronic payment transactions with a merchant (i.e., peer-to-business payment transactions); however, many conventional electronic payment systems lack a secure and/or convenient method automatically determining the identification of the user and merchant during the transaction process.

Other conventional electronic payment systems allow consumers to enter into payment transactions using payment information that users have previously tied to a specific application. For example, some conventional electronic payment systems allow a consumer to install an application that stores payment credentials associated with a user's payment account. When the consumer wants to purchase goods or services from a participating merchant, the consumer navigates to and opens the application on the consumer's mobile device to access and/or provide authorization for an electronic payment transaction. These systems require the consumer to unlock his or her mobile device and find and open the correct application, and in addition provide a password or pin to complete a transaction. As mentioned, although conventional electronic payment systems allow consumers to engage in payment transactions with merchants, conventional systems are often inconvenient and introduce unnecessary and cumbersome steps to process an electronic payment transaction between a consumer and a merchant. In particular, requiring consumers to place a mobile device near a small and very specific location, or requiring consumers to find and open a specific application prior to initiating a payment transaction can often cause the payment transaction process be as slow, and in many cases, less convenient slower than conventional cash-based or card-based transactions.

At present user can find a local business, reserve a service, and pay for bookings or tickets all through the Reserve with Google platform. User can find a business by simply searching for it on Google, in Maps, or in the Google Assistant. Reserve with Google connects to a wide variety of online services that let user book and reserve. Reserve with Google connect Google users with businesses through Google products (Search, Maps, Assistant). Users can make bookings, appointments, and reservations to a service offered by a merchant (business) and provide payment (where required) directly through Google.

At present various maps including Google maps, Bing Maps, and other online maps service providers, facilitates seller or merchant or owner of place of business to list their business or place of business on maps with profile and various types of details including name, address, interior and exterior photos and videos, phone number, website, one or more uniform resource locators (URLs), so customer can search, select from nearby or current place on maps and view associated said profile an details and can take call-to-actions including click or tap on website to impress and engage new customers—and establish business online. A professional website drives sales and let customers call, message, get a quote, book services, place orders, and more—driving conversations and sales. Consumers are more likely to buy from a business that has a website over one that does not.

At present online e-commerce platform enables merchants to set up online store, list products, make them searchable for users and enable users to search products and services, add to cart, and make payment via one or more added and selected payment methods.

Currently many types of payment service providers facilitate in online payments via integrating their services with online websites (card not present) and applications and facilitates in offline payment by providing cloud point of sales and cloud payment services (card present).

Accordingly, there are a number of disadvantages with conventional electronic payment systems and methods.

Present invention enables platform for merchants and users wherein merchant can register with the platform or system or server or application or service and provide place of business details including business name, category, address, description, business hours, menu, products and services offered, offers, interior and exterior photos and videos, website, one or more types of links or uniform resource locator (URLs) or web addresses or tracking links or namespaces, phone number(s), email address(es), one or more selected call-to-actions from list of call-to-actions, location on map, select location or points or geo-coordinates on map, select, edit or draw geofence on map to define place area on map and provide bank details and payment information. In another embodiment enable merchant to provide unique place identity or unique place uniform resource locator (URL) provided by 3rd parties maps or applications or services to merchant while business listing on said maps or other services to identify, import, extract said unique identity associated place or business listing details or business profile for quick registration. In another embodiment platform or server or system verifies place or in another embodiment instruct merchant or owner of place of business to verify place from external or 3rd parties where they listed their business via provided unique code on business place associated phone or provide unique code via postal on business address. After registering, generating and providing unique uniform resource locator (URL) or web address or trackable link or web address or special type of link or web address. In an embodiment instruct merchant to paste or provide said web link or web address or URL to business listing on 3^{rd} parties' maps or applications or services. Platform enables user to register with the system or server by providing name, mobile number and email address and verify user's mobile device via sending one-time password (OTP) on said mobile number. After registration and verification, enabling user to add one or more types of payment methods and verify said payment methods via one or more types of application programming interface (APIs) including bank APIs. After registration, user can open maps application provided by server or system of present invention or user can downloads, installs, updates, and open external or 3rd parties maps application and view current location or current location associated identified current place or select current place on map or select place from displayed nearby places or search and select place from list or maps and in an embodiment optionally can view place associated details including place or business or brand or store name, category, sub-categories, tags, descriptions, address, position or location on map, interior and exterior photos and videos, logo to accurately identify current place an select website or webpage address or namespace or web address or tracking uniform resource locator (URL) or link. In the event of clicking or tapping on listed and verified place or place of business details associated said website or webpage address or namespace or web address or tracking uniform resource locator (URL) or link, invoking or opening said website or webpage address or namespace or web address or tracking uniform resource locator (URL) or link associated website or webpage including website or webpage hosted and manage by merchant or payment interfaces provided by present invention server or system integrated website or webpage via application programming interface (APIs) and software development kit (SDKs) provided by present invention server or system or said place associated or merchant of said place of business associated unique payment page or web age or interface provided by/from server or system of present invention. Present invention enables user to select place on map and select or tap or click on said selected place associated web address or tracking uniform resource locator (URL) or uniform resource locator (URL) and sign-in from displayed said webpage or website. After sign in or login from said presented webpage or website, user can enter amount or use default or pushed amount and select payment method from list of added payment methods or use default or pre-set payment method or automatically select payment method based on inputted amount, available balance and redeemable points to make payment from sign-in user's said selected or pre-set or auto selected account to said user selected said place associated merchant's account or said user selected or clicked or tapped web address or trackable uniform resource locator (URL) or uniform resource locator (URL) associated merchant's account. In another embodiment present invention facilitates direct user to merchant ordering system avoiding or eliminating 3rd parties service providers and middlemen like search engine, maps application to make order or make appointment or booking or reservation of/to/from/with one or more stores, businesses for ordering products, subscribing or booking services, booking of tickets, classes, program & event, making reservation of tables. Merchant can add and update details of products and services including name, brand, photo, video, price, description, quantity, offer, discount, delivery options, associate or select call-to-actions and publish said added or updated products, services and associate options in their website or webpage or integrated user interface provided by present invention server or system within merchant's website or web page or unique web address associated webpage provided by server or system for enabling user to select one or more products and services, select prescribed medicines or auto select medicines based on prescription or select by doctor on behalf of patient or user, select from past ordered products and services, select other one or more options, settings, customization, call-to-actions, select payment methods and make billed payment and make order including in-store order, delivery at particular provided address including home or office delivery or take away. Merchant can add, update their own products and services details and catalogue and fulfill orders including in-store providing ordered products and services, parcel products for take away and delivery products to user provided delivery address. Payment service provided by present invention server or system or partnered 3rd parties integrated payment service providers, payment gateways, and acquirers.

U.S. patent publication number 20120084177 (Tanaka et el), title—Location based transactions describes “a user's location is determined by location information communicated by a user device, such as a smart phone. Merchants near the user location are determined and selected. Merchant payment information is transmitted to the user device so that the user can easily make a payment to the merchant through the user device” Tanaka disclose displaying list of nearby merchants based on current location of user device and enable user to select from a list of merchant names, locations, logos. Tanka does not discloses displaying nearby places including current place on map, so user can easily identify current place based on place surround location information and other places and view other details and can trust place and make payment. Identifying current place associated merchant based on merchant names, locations, logos is time consuming, and tedious. User does not know merchant name, logo, address. User need great effort to ask and verify that and then able to trust and make payment which very time consuming and tedious process. Tanaka does not discloses enabling user to click or tap on selected or current place associated uniform resource locator (URL) to directly make particular amount payment from user's account to said place or place associated URL associated merchant's account.

Generally, most of the retail establishments utilize point of sale terminals (POS terminals) for completing transactions. A point of sale terminal typically includes an internet enabled computer, a barcode scanner, a credit/debit card reader, a printer and other equipment or software used for completing a transaction between the retail establishment and a customer. During the transaction, the merchant calculates an amount owed by the customer by scanning the product barcode, prepares an invoice for the customer and indicates one or more options for the customer to make payment. The one or more options may include one of a cash payments, credit/debit cards, cash cards, digital wallets, online payments and like. Point of sale terminals may use near field communication (NFC) technology that allows communication between the point of sale terminal and an NFC enabled smartphone to complete the transaction. Standard point of sale terminals comprising a computer, digital touchscreen interface, scanner, printer, cards processors and other peripherals are costly and are expensive particularly for businesses or vendors. Furthermore, the conventional point of sale terminals requires periodic software upgrades, vendors have to pay for new licenses or monthly subscription fees and hence involves additional post deployment maintenance cost. Furthermore, customers who use their credit or debit cards when making their purchases run the risk of exposing their personal information (e.g. PINs) to other individuals (vendors). Further, the process of simple invoicing (calculation) and digital payment is decoupled in the conventional POS systems, hence the overall process is more cumbersome. Hence, small businesses face significant challenges in adapting to, and taking advantages of the conventional point of sale terminals.

Therefore, it is with respect to these considerations and others that the present invention has been made.

### OBJECT OF THE INVENTION

The object of present invention is to enable user to select place on maps including 3rd parties maps applications including Google maps applications, Microsoft Bing maps application, TomTom maps application, and other maps applications and select provided website or webpage web address or uniform resource locator (URL) or namespace or tracking uniform resource locator (URL) or particular type web link including short link associated with details of said selected place or place of business or listed place or place of business on maps for invoking or opening associated website or web page hosted by merchant or server or system of present invention, wherein website or webpage comprises integrated present system provided payment user interfaces and services via application programming interface (APIs) and software development kit (SDKs) or unique webpage provided by present invention server or system which facilitates user to login, use default or pushed amount or enter payment amount, use pre-set or automatically selected or select payment methods and make payments from said logged-in user selected account to said user selected place or user selected website associated account or merchant's account via payment gateways hosted, manage and provided by present invention server (e.g. UniPay open source own or white label payment gateway and worldwide acquirer relationships) or 3^{rd} parties payment service providers including white label payment gateways, partnered payment service providers based on revenue sharing including PayPal, Amazon Pay, Stripe, Pay via external wallets including Google Pay, Apple Pay, Pay Later, Pay based on store credit, Pay via Installments, Pay via Points, and like.

The another object of present invention is to enable platform wherein merchant can add, update and list products and services or offers (discount, redeemable points, vouchers, coupons, free services, samples) or deals or group deals and enable their customers to select place of said business or merchant on map and select said selected place on map associated uniform resource locator (URL) or web address or trackable uniform resource locator (URL) and select one or more said listed products or services or offers or deals or participate in group deals (deal happen when pre-set number of users select deal or pre-set amount of order) or reserve or book services from said selected place on map associated clicked or tapped or selected uniform resource locator (URL) or web address or trackable uniform resource locator (URL) and make billed amount payment from said logged-in user's account to said selected place on map associated merchant's account or said selected place on map associated clicked or tapped or selected URL or web address or trackable uniform resource locator (URL) associated merchant's account.

The another object of present invention is to replace current point of sale (POS) at different types of places of business (e.g. Restaurant, Café, Hotel, Gym, Patrol Pump, Parking, Toll, Hospital, Medical store, Car repair, Grocery, Cloth Stores, Theatres and like) located at different locations with Point of Purchase (POP) with user client application installed in or access from user client device (e.g. smartphone). So user can scan and add to cart purchased products via camera application, make payment by using different types of payment methods including debit, credit, wallet, direct bank transfer or UPI, points, crypto currencies, pay later, ay via installments (EMI), pay via store credit and offer and view digital bill or invoice. User can manually order and make payment of asked total billed amount directly from user client device at place of business (in-store or offline store). User can manually order remotely via call or chat or message and make payment of asked total billed amount directly from user client device or make part payment or make payment later as per mutually agreed conditions. User can also make payment and make order (in-store order—takeaway and eat or consume at store or online order—delivery, takeaway and book table, advance order and eat or consume at store) and payment to any selected place on maps. Another object of present invention is to enable merchant to scan purchased products by customer or collect customer ordered products in-store by merchant or staff of merchant and scan purchased products at POS, wherein said POS is integrated or linked or connected with merchant client application. Customer can connect with merchant client application via user client application, so merchant can view details of connected customers and identify customer based on name or nick name, photo, voice, video, nearby location and select customer and send or push or present billed amount or bill or invoice of said scanned and added purchased products to said selected customer, so said customer can receive and view said pushed or sent or presented total billed amount or bill or invoice and make payment from user's pre-set or default or selected account from list of different types of payment methods to said connected merchant's account. The important object of present invention is connecting merchant client application with user client application based on monitored and tracked user device current location and identified location associated place or geofence of place of business and merchant place of business location information and enable merchant to send or push or present bill or billed amount and merchant identity or merchant bank account or debit card information to selected connected person based on viewing at least displayed record or photo or name of connected user or enable user to retrieve or receiving by the user client application from the connected or selected connected merchant client application, merchant bank account or debit card information and enable to make payment of said billed amount from user selected or pre-set or default payment account to said identified merchant account, wherein connection established via one or more communication interface, medium and network including internet data network.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in an embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “network application” refers to a computer-based application that communicates, directly or indirectly, with at least one other component across a network. Web servers, email servers, messaging servers, and game servers are examples of network applications.

One or more embodiments described herein provide benefits and/or solve one or more of the foregoing or other problems in the art with systems and methods to allow users to easily and efficiently engage in secure in-store electronic payment transactions with merchants. In particular, the systems and methods enable selected place on map associated website based electronic payment identification. One or more example embodiments identify a payment account for a user based on login in user selected place on map associated website from a user client device. Example systems and methods identifies identity of user based on logged in user's user identity in user selected place on map associated website from a user client device and identifies identity of merchant based on user selected place on map associated website associated merchant's identity or merchant's account or merchant's bank details. Thus, the systems and methods can use a user selected place on map associated website URL to verify the identity of the user, as well as to identify a payment account for use in processing a payment transaction between the user and the merchant.

One or more embodiments of the systems and methods also authenticate the payment transaction by receiving a payment instruction or confirmation from the user. Specifically, in one or more examples, the systems and methods identify the user and user selected place on map including current or selected place associated website associated merchant from a client device associated with the payment account for the user. After receiving a payment instruction from the user, one or more embodiments process the payment transaction between the merchant and the user.

Accordingly, example embodiments described herein provide a true two-factor authentication process that increases the security of the payment transaction. First, the log in to identify a user is a first factor to authenticates the user. Second, the payment instruction or confirmation or payment request received from the mobile device corresponding to the identified user serves as a second factor to authenticate the user. By using true two-factor authenticating based on selection of place from maps or identified current place at/near user device location or a user at an in-store merchant location and confirming or instructing the payment via the user's client device, the systems and methods can provide a secure payment transaction while also providing increased efficiency and convenience.

Additional features and advantages of the embodiments will be set forth in the description that follows, and in part will be obvious from the description, or can be learned by the practice of such exemplary embodiments. The features and advantages of such embodiments can be realized and obtained by means of the instruments and combinations particularly pointed out in the appended claims. These and other features will become more fully apparent from the following description and appended claims, or can be learned by the practice of such exemplary embodiments as set forth hereinafter.

Embodiments described herein enabling to in the event of selecting place on maps and selecting said selected place associated unique website or webpage uniform resource locator (URL) or link or web address, opening or invoking said selected or tapped or clicked uniform resource locator (URL) associated website or webpage, identifying identity of merchant and associated merchant account including merchant bank account or debit card details based on said selected identified place on maps or selected place on maps associated selected website or webpage uniform resource locator (URL) or link or web address and transferring entered or selected or pushed or default amount from user selected or pre-set or default user account to said identified merchant account.

In one or more embodiments, from the opened or invoked said selected or tapped or clicked uniform resource locator (URL) associated website or webpage, enabling user to select sub-place within or inside said selected place or geofence associated with said selected place from displayed list of sub-places; identifying identity of merchant and associated merchant account including merchant bank account or debit card details based on said selected sub-place; and transferring entered or selected or pushed or default amount from user selected or pre-set or default user account to said selected sub-place associated identified merchant account.

In one or more embodiments enable user to select number including floor number from list of numbers including floor numbers; enable user to use the level switcher to move from floor to floor in the building or switch floors including zoom in and out of a building and go floor to floor with maps including indoor maps or use indoor maps to view floor plans, wherein building may comprises airports, malls, stadiums; receiving, from the user, selection of particular number including floor number; displaying maps including indoor maps or maps of indoor locations or indoor floor plan of a building related to said selected number including floor number; displaying said selected number including floor number associated places on maps including indoor maps or maps of indoor locations or indoor floor plan; enabling user to search and select or select place from said selected number including floor number associated places on maps including indoor maps or maps of indoor locations or indoor floor plan.

In one or more embodiments displaying on maps or list or maps linked list, current location associated place or current location surround place(s) or one or more searched places or nearby places or selected category specific places or bookmarked, favorite, liked, suggested, visited, transacted place(s).

In one or more embodiments identifying user based on log-in information including unique user identity or one or more types of unique user device identity.

In one or more embodiments associating unique website or webpage uniform resource locator (URL) or link or web address with unique place identity or merchant identity.

In one or more embodiments said invoked or opened website or webpage enables user to make entered or selected or pushed amount of payment from user's selected or default or selected account or payment methods including one or more debit cards, credit cards, digital wallets, direct bank transfer or net baking, unified payment interface (UPI), crypto currency, pay later, pay via installments or EMI, payment account, direct carrier billing (DCB) and pay via offers or redeemable points or vouchers or coupons or gift card or store credit to said selected place on maps associated merchant's account or said selected place on maps associated selected website or webpage uniform resource locator (URL) or web address associated merchant's account.

In one or more embodiments invoke said website or webpage from pay-via-place server.

In one or more embodiments invoke said website or webpage from server of merchant and load integrated payment user interface (UI) or child webpage from pay-via-place sever, wherein said invoked or opened website or webpage is integrated with pay-via-place payments webpage or pay-via-place user interface (UI) flows or pre-made user interface (UI) components via Web application programming interface (API) or payments APIs provided by pay-via-place server or application programming interface (API) server.

In one or more embodiments in the event of clicking or tapping or selecting said selected place on maps associated integrated button or control, server receives request to access said clicked or tapped or selected integrated button or control associated payment user interface or payment flow or order and payment user interface or order and payment flow.

In one or more embodiments detect, identify and calculate that selected place is near to monitored and tracked current location of user client device else notify user that said selected place is far from monitored and tracked current location of user client device, wherein near or far is calculated based on pre-set distance in number of meter(s).

In an embodiments enabling user to use displayed, by the hardware processor via the network interface component and the network, place of the plurality of places on maps associated or linked or linked via uniform resource locator (URL) or connected or embedded or integrated or displayed graphical user interface for making payment of particular amount from user payment account to said place associated identified merchant account including merchant bank account or merchant debit card account. In an embodiment enabling user to use displayed particular place associated or linked or integrated displayed graphical user interface to input or enter or select amount or use pre-set or default or pushed amount. In an embodiments enabling user to use displayed particular place associated or linked or linked via uniform resource locator (URL) or integrated or displayed graphical user interface to select or update or change or use pre-set or default payment account associated with the user for making payment of said amount from said user payment account to said place associated identified merchant account including merchant bank account or merchant debit card account. In an embodiment displaying payment graphical user interface at prominent place or beside/with/in/surround particular place icon or image or name or area. In an embodiment in the event of selecting particular place, displaying payment graphical user interface. In an embodiment in the event of selecting particular place, displaying graphical user interface or payment control and in the event of selecting graphical user interface or payment control, displaying payment graphical user interface. In an embodiment in the event of receiving instruction to make payment, debit said amount from the user's payment account and credit said amount to the merchant's account including merchant bank account or merchant debit card account, wherein the server is managed by or connected or integrated with a payment provider. In an embodiments enabling user to select current location associated place, current place, select place from nearby places or select place from selected category specific nearby places, search and select place, select sub-place, select floor and select place from indoor maps, select place from list of places including favorite, liked, bookmarked, visited, transacted, plan to visit places. In an embodiment plotting on the maps graphical user interface, places and associated details, wherein each plotted place associated or integrated with a selectable, accessible and actionable graphical representation or graphical indicator or control or icon or name. In an embodiments identifying user device current location associated place or place of business or merchant based on sufficiently matching monitored and tracked current location of user client device with location information associated with the places from places database, wherein location information associated with the place comprises address, geo-coordinates or GPS coordinates, unique geo code, pre-set pointer on maps, pre-defined geofence. In an embodiment the payment information identifies an account of the seller or merchant to the payment provider. In an embodiment the server is managed by a payment provider. In an embodiment the merchant information identifies an account of the selected place associated merchant to the payment provider. In an embodiments identifying the payment account for the user comprises: identifying a plurality of payment accounts associated with a user account for the user; displaying, to the user client device, a plurality of indicators associated with the plurality of payment accounts; and receiving, from the user client device, a selected indicator from the plurality of indicators associated with the plurality of payment accounts. In an embodiment the plurality of indicators comprises a plurality of payment tokens, each token corresponding to a payment account from the plurality of payment accounts. In an embodiment sending the payment confirmation request to the client device associated with the payment account for the user comprises sending a push notification comprising payment data associated with the in-store payment transaction. In an embodiment sending the payment confirmation request to the client device associated with the payment account for the user comprises sending a push notification comprising payment data associated with the selected place associated payment transaction. In an embodiment identifying the merchant account for the merchant comprises: identifying user selected place or place associated control on maps and identifying said identified place associated merchant account including merchant bank account or debit card.

In one or more embodiments storing and relating or associating merchant's identity or merchant's account or bank or debit card details with uniform resource locator (URL) or web address or namespace; integrating or embedding payments graphical user interface with webpage or website or redirecting user to payment webpage or website; in the event of entering or clicking or selecting said uniform resource locator (URL) or web address or namespace, invoking or opening or redirecting said uniform resource locator (URL) or web address or namespace associated website or webpage; displaying login graphical user interface for enabling user to sign in; after successful login, identifying logged-in user's unique identity and displaying payment graphical user interface comprising input box for entering amount or selection box including combo box or list box for selecting amount or display pushed amount, display user's one or more accounts including default or pre-set or selected account and display or enable make payment control including button, link, image, icon or voice command or one or more types of user senses for making or instructing to make payment of said amount from said identified logged in user's selected account to said uniform resource locator (URL) or web address or namespace associated identified merchant's account.

In one or more embodiments in the event of receiving instruction from user to make payment, debiting said amount to said identified user's account and crediting said amount to said identified merchant's account.

In one or more embodiments user's device including smartphone, smartwatch, tablet, laptop, wearable smart devices and smart devices.

In one or more embodiments payment account(s) or payment methods comprises one or more debit cards, credit cards, digital wallets, direct bank transfer or net baking, unified payment interface (UPI), crypto currency, pay later, pay via installments or EMI, payment account, direct carrier billing (DCB) and pay via offers or redeemable points or vouchers or coupons or gift card or store credit.

In one or more embodiments entering or clicking or selecting said uniform resource locator (URL) or web address or namespace from one or more web browsers and applications.

In one or more embodiments displaying login graphical user interface for enabling user to input user identity and password for sign in or enable user to keep user sign in or enable user to login via recognizing user's biometrics (fingerprint), recognizing user's voice, recognizing user's face, recognizing one or more types of pre-defined expressions or senses or phone screen lock pattern or PIN or password.

In one or more embodiments integrating or embedding payments graphical user interface with webpage or website via application programming interface (APIs), software development toolkit (SDKs), web services and webpage link.

In one or more embodiments enabling user to add and update one or more accounts and change or set or make default selected account from list of said added accounts.

In one or more embodiments in the event of selecting place on maps and selecting said selected place associated unique website or webpage uniform resource locator (URL) or link or web address, opening or invoking said selected or tapped or clicked uniform resource locator (URL) associated website or webpage; displaying list of sub-places in said opened or invoked website or webpage, wherein said one or more sub-places are associated with said selected place and is/are within or inside said selected place or geofence associated with said selected place; receiving, from the user, selection of sub-place; and identifying identity of merchant and associated merchant account including merchant bank account or debit card details based on said selected sub-place; and transferring entered or selected or pushed or default amount from user selected or pre-set or default user account to said selected sub-place associated identified merchant account.

In one or more embodiments enable user to select number including floor number from list of numbers including floor numbers; enable user to use the level switcher to move from floor floor in the building or switch floors including zoom in and out of a building and go floor to floor with indoor maps or use indoor maps to view floor plans, wherein building may comprises airports, malls, stadiums; receiving, from the user, selection of particular number including floor number; displaying indoor maps or maps of indoor locations or indoor floor plan of a building related to said selected number including floor number; displaying said selected number including floor number associated places on indoor maps or maps of indoor locations or indoor floor plan; enabling user to search and select or select place from said selected number including floor number associated places on indoor maps or maps of indoor locations or indoor floor plan; in the event of selecting said place on indoor maps or maps of indoor locations or indoor floor plan and selecting said selected place associated unique website or webpage uniform resource locator (URL) or link or web address, opening or invoking said selected or tapped or clicked uniform resource locator (URL) associated website or webpage; identifying identity of merchant and associated merchant account including merchant bank account or debit card details based on said selected identified place on maps or selected place on maps associated selected website or webpage uniform resource locator (URL) or link or web address; and transferring entered or selected or pushed or default amount from user selected or pre-set or default user account to said identified merchant account.

In one or more embodiments storing merchant associated one or more types of details; relating or associating merchant's identity or merchant's account or bank or debit card details with uniform resource locator (URL) or web address or namespace; integrating or embedding payments graphical user interface with webpage or website or redirecting user to payment webpage or website; enabling user to select merchant including search, browse and select merchant from displayed search results or list or profile page or categories directories of merchants; identifying said user selected merchant's identity, uniform resource locator (URL) or web address or namespace; in the event of selecting merchant or selected merchant associated uniform resource locator (URL) or web address or namespace, invoking or opening or redirecting said uniform resource locator (URL) or web address or namespace associated website or webpage; displaying login graphical user interface for enabling user to sign in; after successful login, identifying logged-in user's unique identity and displaying payment graphical user interface comprising input box for entering amount or selection box including combo box or list box for selecting amount or display pushed amount, display user's one or more accounts including default or pre-set or selected account and display or enable make payment control including button, link, image, icon or voice command or one or more types of user senses for making or instructing to make payment of said amount from said identified logged in user's selected account to said uniform resource locator (URL) or web address or namespace associated identified merchant's account.

In one or more embodiments storing merchant associated one or more types of details comprises business or store or place name, one or more categories and sub-categories, merchant's name, photo logo, address, map, location point or geo-coordinates on map, unique place identity or code, phone number(s), website(s) or uniform resource locators URL(s), email address(es), interior or exterior photos and videos, business hours, ratings, reviews, merchant account details including bank or debit card details and one or more types related or associated details from one or more sources, one or more call-to-actions including participate in group deals, claim offer including voucher, coupon, order including advance order & collect from store or eat at store or takeaway, online order for delivery at provided shipping address, call, chat, message, email, view products and services details, ask for quote, make payment, request support, buy, subscribe, reservation, booking, and one or more types of call-to-actions or user actions.

In one or more embodiments enabling user to search merchant(s) based on keywords, full or part business or store or place name, merchant's, location, category, address, phone number, email address, website, photo, rank, brand name, products or services offered, type or amount of offer, business hour or open or close, logged history including last purchase, visited or transacted place, product or service purchased, date and time and any combinations thereof and search merchant from categories directories or one or more types of lists including bookmarked, visited, transacted, liked, favorite and suggested list.

In one or more embodiments displaying suggested list of merchants based on user's profile, merchant's profile, requirements, relationships, emails, messages, calendar entries, user's logs of transactions, visits, activities, status, participations, check-in locations, data from linked or connected systems, sources, accounts, applications, websites, servers & databases, scan of QR code, voice command, current location, selected location on maps including search and select location or place or select location or place from nearby select locations or places and one or more types of triggers and rules.

In one or more embodiments enabling user to add or enter tip amount or additional amount, negotiate or ask discount, make payment notes or description, cancel payment, provide instructions or request or details, select custom options, select customization options, select settings, add additional order or add-ons, claim one or more types of offers, redeem vouchers or coupons, request invoice or bill or receipt, request pay later or use store's credit or pay via installments or EMI or use points or alternative method or currencies for making payment and select pay after receiving delivery.

In one or more embodiments enabling user to select products or services, make order and make billed amount payment.

In one or more embodiments storing or accessing user related or associated details, wherein user comprises person, merchant or business or place of business; enabling user to search details of users of network based on search query, selection, visiting particular user's profile page and browsing lists or categories directories, selecting from suggested list of users; enabling user to select other user(s) from search results or user profile or one or more types of list of users; displaying graphical user interface (GUI) for enabling user to select or use default or pre-set payment account from list of added payment accounts by user; and displaying graphical user interface (GUI) for enabling user to enter amount or select amount or use default or pre-set amount and instruct to make said amount of payment from said user selected or default or pre-set payment account to said user selected other user's default or pre-set payment account.

Displaying list of users including list of contacts, list of connections including mutually connected users or contacts, followers, following sources, professional contacts, list of bookmarked or visited or liked or transacted places associated merchant, list of search results including search query including address, keywords, category, name, product or service name(s) and list of suggested users based on current location of user client device associated identified place associated merchant, identified nearby users including driver or persons in vehicle, contacts, merchant, categories people or users and anonymous users based on monitored and tracked user devices locations near user, nearby places or nearby selected category specific, calendar entries, subscribed services, logged one or more types of activities including currently accessing website or webpage, installed applications, digital activities, visited profiles of other users, searched products, connections, interactions, actions, locations, status, transactions via linked system, applications, services, websites, devices, servers.

In one or more embodiments user's related or associated details comprises user name, photo, video, one or more type of identities, contact information including home address, location code & location on map, home phone number, user's mobile number, email address, website & social network accounts, relationship and activities with other users, work or business details including address, name, position, role, contact information including phone number(s), email address(es), website and description, logged or shared or posted contents, locations including current location or place or checked in place, updates and status.

In one or more embodiments identifying merchant identity and associated merchant details, merchant bank account details or debit card details based on user selected website URL associated with selected place on maps or selected place on maps associated merchant bank account details or debit card details; generating, by a merchant client application of merchant client device, a payload for the transaction, wherein the payload comprises at least an encrypted payment information; establishing a connection with the merchant client application of merchant client device, by a user client application of a user client device; fetching or receiving or pulling, by the user client application of the user client device, the payload for the transaction from the merchant client application of the merchant client device; communicating, by the user client application of the user client device, the payload for the transaction to an authentication server; and completing the transaction, by the user client application of the user client device, upon successful authentication of the payload for the transaction by the authentication server.

In one or more embodiments generating the payload for the transaction is based at least on an input from a user of the merchant client device.

In one or more embodiments broadcasting the presence of the merchant client device comprises allow to access location of the merchant client application of the merchant client device or turn on use location service of merchant client device and turn on or allow to Wi-Fi scanning and Bluetooth scanning for location accuracy by the user of the merchant client device.

In one or more embodiments authenticating the payload for the transaction by the authentication server comprises: receiving the payload for the transaction from the user device; locating the user device to determine a location of the merchant client device; and authenticating the payload for the transaction if the location of the merchant client device is within a pre-defined location to complete the transaction.

In one or more embodiments in the event of selecting place on maps or in the event of selecting place on maps and selecting said selected place associated website URL and selecting connect button or control from said website or webpage URL associated opened or displayed website or webpage, establishing a connection with the merchant client application of merchant client device, by a client application of a user client device.

In one or more embodiments allowing to connect merchant client application of merchant client device with user client application of user client device by authorized user(s) of merchant client application of merchant client device or allowing to connect user client application of user client device with merchant client application of merchant client device by user client application of user client device may base on sufficiently matching location of said monitored and tracked user client device with said user selected place associated identified location or selected place on maps associated URL associated identified location, wherein location of place of business comprises geo-coordinates, pointer on map, address, geocodes and pre-defined geofence on maps associated with said selected place on map associated identified merchant or said selected place on map associated selected website or webpage uniform resource locator (URL) associated identified merchant.

In one or more embodiments a transaction controller configured for: generating a payload for the transaction, wherein the payload comprises at least an encrypted payment information; establishing a connection with the merchant client application of merchant client device, by a user client application of a user client device; communicating the payload for the transaction to the user device; and indicating a status of the transaction on receiving the status from the user device.

In one or more embodiments identifying merchant identity and associated merchant details, merchant bank account details or debit card details based on user selected website URL associated with selected place on maps or selected place on maps associated merchant bank account details or debit card details; identifying user identity and associated details based on user client application of a user client device logged in user's details including user identity or identified user who selected said place of business from a user client application of a user client device; generating, by a merchant client application of merchant client device, a payload for the transaction, wherein the payload comprises at least an encrypted payment information; establishing a connection between a user client application of a user client device with the merchant client application of the merchant client device, wherein the connection is established based on sufficiently matching location of said monitored and tracked user client device with said user selected place associated identified location or selected place on maps associated URL associated location, wherein location of place of business comprises geo-coordinates, pointer on map, address, geocodes and pre-defined geofence on maps associated with said selected place on map associated identified merchant; sending or pushing or sharing or presenting, the payload for the transaction from the merchant client application of the merchant client device to the selected user client application of the user client device by the authorized user of the merchant client application of the merchant client device; communicating, by the user client application of the user client device, the payload for the transaction to an authentication server; and completing the transaction, by the user client application of the user client device, upon successful authentication of the payload for the transaction by the authentication server.

In one or more embodiments identifying merchant identity and associated merchant details, merchant bank account details or debit card details based on user selected website URL associated with selected place on maps or selected place on maps associated merchant bank account details or debit card details; identifying user identity and associated details based on user client application of a user client device logged in user's details including user identity or identified user who selected said place of business from a user client application of a user client device; generating, by a merchant client application of merchant client device, a payload for the transaction, wherein the payload comprises at least an encrypted payment information; establishing a connection between a user client application of a user client device with the merchant client application of the merchant client device, wherein the connection is established based on sending connecting request by the user from the user client application of the user client device to said selected place or selected place associated selected website URL associated identified merchant client application of the merchant client device and based on setting provided by the authorized user of the merchant client application automatically accepting of said connection request or manually accepting of said connection request by authorized user of the merchant client application; fetching or receiving or pulling, by the user client application of the user client device, the payload for the transaction from the merchant client application of the merchant client device; communicating, by the user client application of the user client device, the payload for the transaction to an authentication server; and completing the transaction, by the user client application of the user client device, upon successful authentication of the payload for the transaction by the authentication server.

In one or more embodiments allowing to connect merchant client application of merchant client device with user client application of user client device by authorized user(s) of merchant client application of merchant client device or allowing to connect user client application of user client device with merchant client application of merchant client device by user client application of user client device may base on sufficiently matching location of said monitored and tracked user client device with said user selected place associated identified location or selected place on maps associated URL associated identified location, wherein location of place of business comprises geo-coordinates, pointer on map, address, geocodes and pre-defined geofence on maps associated with said selected place on map associated identified merchant or said selected place on map associated selected website or webpage uniform resource locator (URL) associated identified merchant.

In one or more embodiments identifying merchant identity and associated merchant details, merchant bank account details or debit card details based on user selected website URL associated with selected place on maps or selected place on maps associated merchant bank account details or debit card details; identifying user identity and associated details; generating, by a merchant client application of merchant client device, a payload for the transaction, wherein the payload comprises at least an encrypted payment information; establishing a connection between a user client application of a user client device with the merchant client application of the merchant client device, wherein the connection is established based on sending connecting request by the authorized user of the merchant client application of the merchant client device to the selected logged in and identified user client application of the user client device and based on setting provided by the user client application automatically accepting of said connection request or manually accepting of said connection request by user of the user client application; sending or pushing or sharing or presenting, the payload for the transaction from the merchant client application of the merchant client device to the selected user client application of the user client device by the authorized user of the merchant client application of the merchant client device; communicating, by the user client application of the user client device, the payload for the transaction to an authentication server; and completing the transaction, by the user client application of the user client device, upon successful authentication of the payload for the transaction by the authentication server.

In one or more embodiments identifying user identity and associated details based on user client application of a user client device logged in user's details including user identity or identified user who selected said place of business from a user client application of a user client device and sufficiently matching location of said monitored and tracked user client device with said user selected place associated identified location or selected place on maps associated URL associated location, wherein location of place of business comprises geo-coordinates, pointer on map, address, geocodes and pre-defined geofence on maps associated with said selected place on map associated identified merchant.

In one or more embodiments allowing to connect merchant client application of merchant client device with user client application of user client device by authorized user(s) of merchant client application of merchant client device or allowing to connect user client application of user client device with merchant client application of merchant client device by user client application of user client device may base on sufficiently matching location of said monitored and tracked user client device with said user selected place associated identified location or selected place on maps associated URL associated identified location, wherein location of place of business comprises geo-coordinates, pointer on map, address, geocodes and pre-defined geofence on maps associated with said selected place on map associated identified merchant or said selected place on map associated selected website or webpage uniform resource locator (URL) associated identified merchant.

In one or more embodiments in the event of entering and dwelling for pre-set duration into identified and predefined geofence associated with particular toll plaza, notifying user to pay particular amount of toll to pass toll plaza, wherein notification or message comprises link to make payment; and in the event of selecting link, opening associated webpage which enables user to make particular amount payment of payment from identified user account to said link associated identified merchant's account.

In one or more embodiments notifying payment confirmation with payment details to user client device and merchant client device.

In one or more embodiments in the event of entering and dwelling for pre-set duration into identified and predefined geofence associated with a patrol pump, connecting identified user client application to said geofence or place of patrol pump merchant client application, wherein identify user client device entered or dwelled into geofence based on sufficiently matching monitored and tracked user client device current location with said location associated geofence associated with a patrol pump; displaying products or services lists or catalogue to enable user to select one or more products and services; in the event of selecting one or more products and/or services and making order, sending and displaying said order details to connected merchant client application; providing one or more types of numbers including token or queue number, pump number and estimated waiting time; displaying order details, total billed amount, estimated waiting time; one or more types of numbers including token or queue number, pump number to the said connected user client application; and in the event of providing indication of full filling of said order including finishing filling of fuel by authorized user of connected merchant client application, automatically make payment of said total billed amount from user client application to said connected merchant client application or said geofence or palace associated merchant account.

In one or more embodiments in the event of entering and dwelling for pre-set duration into identified and predefined geofence associated with a patrol pump, automatically connecting identified user client application to said geofence or place of patrol pump merchant client application, wherein identify user client device entered or dwelled into geofence based on sufficiently matching monitored and tracked user client device current location with said location associated geofence associated with a patrol pump; displaying products or services lists or catalogue to enable user to select one or more products and services and make payment for said order; in the event of selecting one or more products and/or services and making payment of said total billed amount from user client application to said connected merchant client application or said geofence or palace associated merchant account, sending and displaying said ordered details to connected merchant client application; providing one or more types of numbers including token or queue number, pump number and estimated waiting time based on number of connected user client devices or users or vehicles in queue; displaying merchant name and details including business name, address, contact information, order details, total billed amount, estimated waiting time, user actions including chat, call, reactions; one or more types of numbers including token or queue number, pump number, updated token number in queue, status including entered, duration of waiting, ordered, payment done, current or updated number in queue, order full filled and exited to the said connected user client application; displaying entered vehicle number, vehicle type, vehicle colour, vehicle brand, vehicle image(s) or video(s), user name, user photo, user identity, date and time ordered product(s) and/or service(s), total amount paid, generated bill or invoice, provided indication by authorized user(s) of said connected merchant client application and status including entered, ordered payment done, current or updated number in queue, order pending or partially pending or order full filled, exited and disconnected to said connected merchant client application; and in the event of providing indication or marking of full filling of said order including finishing filling of fuel by authorized user of connected merchant client application, automatically send receipt to said connected user client application.

In one or more embodiments in the event of exiting of said vehicle or user client device, automatically disconnecting said user client application with said merchant client application.

In one or more embodiments enabling user to apply membership benefits, store promotion, coupon or voucher codes, redeemable points, patrol pump credit, and automatically apply tax and charges including service charges while calculating total bill amount.

In one or more embodiments in the event of entering and dwelling for pre-set duration into identified and predefined geofence associated with particular patrol pump, notifying user to make order at said patrol pump pay, wherein notification or message comprises link to make order or make order and make payment; and in the event of selecting link, opening associated webpage which enables user to make order and make particular amount payment of payment from identified user account to said link associated identified merchant's account.

In one or more embodiments notifying payment confirmation with payment details to user client device and merchant client device.

In one or more embodiments in the event of entering and dwelling for pre-set duration into identified and predefined geofence associated with a parking, connecting identified user client application to said geofence or place of parking merchant client application, wherein identify user client device entered or dwelled into geofence based on sufficiently matching monitored and tracked user client device current location with said location associated geofence associated with a parking; store start time; start timer; in the event of exit from pre-defined geofence associated with parking, displaying calculated parking charges based on said stored start time, manually provided end time by user or authorized user of merchant client application or current time or time when exit from said geofence associated with the parking, pre-set type of vehicle associated with said user client application of user client device, calculated duration of parking based on said stored start time and said end time, rate or charges of said type of vehicle for particular duration including per hour associated with said geofence associated with the parking and pre-set one or more types of percentage of tax or extra charges on total calculated amount; and automatically make payment of said total calculated or billed amount from said identified user account to said identified merchant account.

In one or more embodiments receiving from a user or a merchant or server admin or server database or external source, by a hardware processor of a server coupled to a user mobile device via a network interface component and a network, place or place of business related or associated details including name, location information including address, pre-defined geofence, points on maps, geo-coordinates and unique place code or identity, website or webpage uniform resource locator (URL), merchant account information including merchant bank account(s) and debit card(s) details related to merchant associated with said place, wherein the account information comprises merchant account identifiers and merchant place of business location information; storing, by a hardware processor of a server coupled to a user mobile device via a network interface component and a network, said details in the storage medium; receiving, by a hardware processor of a server coupled to a user mobile device via a network interface component and a network, one or more criteria and monitored and tracked location information of a user from the user mobile device, wherein the location information comprises GPS coordinates; determining, by the hardware processor, a location of the user based on the location information; determining, by the hardware processor, one or more places based on criteria and a location of the user; generating, using the hardware processor, a map based on monitored and tracked current location of user device or location information, wherein the generated map comprises plotting on the generated map a selectable and actionable graphical representation or graphical indicator or icon of each identified or determined criteria specific place(s) including current place, nearby place or places that are within the predetermined threshold distance of the location of the user, search query including provided or selected location information specific nearby places, selected category specific places and any combination thereof; dynamically displaying on said generated map, by the hardware processor via the network interface component and the network, one or more graphical place indicators to indicate locations of the identified places, wherein in the event of user selecting of particular graphical representation or graphical indicator or icon on a map display, after the map is generated and after the graphical indicator of each identified place is displayed, displaying graphical user interface (GUI), wherein graphical user interface (GUI) enables user to select or click or tap on said place or place of business associated website or webpage uniform resource locator (URL); enabling user to login by using one or more types of login methods and systems; enabling user to enter amount or use pushed or pre-set or default amount or select amount and instruct to make a payment from the user's account including user selected or pre-set or default account to the selected places associated uniform resource locator (URL) associated merchant account or selected place associated merchant account or graphical representation or graphical indicator associated identified place associated merchant account; receiving the webpage or the payment webpage or integrated payment user interface or the user interface, by the hardware processor, a request for a payment indication, wherein the request comprises identity of a user, user payment account, payment amount, identity of merchant or merchant account; processing, by the hardware processor, a payment request to the identified merchant or identified user, received from the user mobile device via the network interface component, without the user having to enter the account information related to merchant; and debiting, by the hardware processor, said amount from user's account and crediting, by the hardware processor, said amount to the merchant's account, wherein the server is managed by or connected with a payment provider.

In one or more embodiments displaying, claiming and activating pay control including pay button or link or image with each place or place associated one or more types of graphical user interface (GUIs) on map; enable user to claim and activate place associated pay control by providing registration details and merchant account information including merchant bank account and/or debit card details; and after verification of details activate or enable or display play control and make them available for customers for making payment to said place associated registered and verified user or merchant and enable said registered and verified user or merchant to accept payment from customers via said place associated pay control.

In one or more embodiments enable merchant to register with the system comprises displaying country specific merchant registration form based on automatically identified country or selected country; enabling to enter unique place identity or unique place link or web address or uniform resource locator (URL) provided by maps including 3rd parties maps including Google Maps or Bing Maps where said place or business is listed to identify place exists on maps including 3rd parties maps applications including Google Maps or Bing Maps; retrieving place associated details from listed place on maps including 3rd parties maps applications including Google Maps or Bing Maps via application programming interface (APIs) provided by said maps including 3rd parties maps including Google Maps or Bing Maps; checking whether said place is verified or not verified on said maps including 3rd parties maps including Google Maps or Bing Maps by using web scrapping or application programming interface (APIs) provided by said maps including 3rd parties maps including Google Maps or Bing Maps; if said place is verified then automatically retrieve, import and fill maximum possible merchant's place details from maps where said place or business is listed on maps including 3rd parties maps application including Google Maps or Bing Maps via application programming interface (APIs) provided by said corresponding maps applications including 3rd parties maps including Google Maps or Bing Maps or enabling merchant to manually enter or input or select details, wherein merchant's place of business details including place or business or store name, category(ies) or sub category(ies), business details, address including shop/office number, street name, area/sector/village, pin code, city/town, state, tax identities (e.g. GST number), phone number, website, email address, position or geo-coordinates on map, photos, videos, logos, business hours, monthly turnover, country specific government identities, current payment methods used by merchant for accepting payments from customers, list and details of products and services offered including name, photo, video, description, price, quantity, offer including discount, deals and merchant account details including merchant bank details including Account No., IFSC Code and/or debit card details where merchant want to receive money; verifying merchant provided mobile number via one time password (OTP); automatically verify said merchant's bank details and/or debit card details, mobile number linked bank accounts or bank account linked mobile number via relevant bank application programming interface (APIs) or one or more types of required application programming interface (APIs) provided by authorized 3rd parties; after successful verification and accepting or agree with terms and conditions of merchant, link bank account with merchant's user account; sufficiently matching address and/or phone number linked with bank account with said provided place of business associated address and/or mobile phone number; generating unique payment webpage link or unique uniform resource locator (URL) or trackable unique uniform resource locator (URL) for said registered merchant based on website uniform resource locator (URL), options selected by merchant including merchant want's customer redirect to Pay-via-place payment webpage or merchant wants to integrate Pay-via-place via APIs or merchant wants to integrate link of Pay-via-place payment webpage with merchant's website or webpage to enable user to click or tap on said integrated or linked or embedded Pay-via-place link or uniform resource locator (URL) to redirect to Pay-via-place payment webpage wherein said Pay-via-place payment webpage comprise link or uniform resource locator (URL) of merchant's website's home page, so user can click on said link or uniform resource locator (URL) of merchant's website's home page to access features and contents of merchant's website; after generating said link or uniform resource locator (URL) instructing merchant to copy and paste said generated and displayed link or unique uniform resource locator (URL) or trackable unique uniform resource locator (URL) in website or URL details of listed place of business on one or more maps applications including 3rd parties maps applications including Google Maps or Bing Maps, so user can click or tap on said pasted or updated or inputted or added link or uniform resource locator (URL); in the event of selecting place on maps and selecting said selected place associated unique website or webpage uniform resource locator (URL) or link or web address, opening or invoking said selected or tapped or clicked uniform resource locator (URL) associated website or webpage; identifying identity of merchant and associated merchant account including merchant bank account or debit card details based on said selected identified place on maps or selected place on maps associated selected website or webpage uniform resource locator (URL) or link or web address; and transferring entered or selected or pushed or default amount from user selected or pre-set or default user account to said identified merchant account.

In one or more embodiments enabling merchant to integrate Pay-via-place UI flows or pre-made UI components via Web (API) or payments APIs, wherein Pay-via-place can be integrated through Web, or through mobile SDKs Android and iOS to collect payments from customers, wherein ay-via-place facilitates multi-instrument payment container and allows customers to pay through UPI, Debit Card, Credit Card, Wallet, Pay via Pay Later or Pay via Installments, Pay via store provided custom credits, Points, Crypto currencies and other payment methods and options.

In one or more embodiments based on merchant's preferences when user click or tapped on website or URL associated or pasted in details of place of business of merchant, user is redirected to unique payment webpage of Pay-via-place, so merchant does not need to develop, maintain and host website.

In one or more embodiments enabling merchant to integrate said generated Pay-via-place payment webpage link or URL at the time of registration of merchant with website or webpage of merchant, so user can click or tap on said link to make payment via Pay-via-place. In one or more embodiments generating QRcode for merchant for enabling their customer to pay also via scanning QR code. In another embodiments assigning a unique merchant identification number (MID) to a registered merchant account to identify it throughout the course of processing activities. In another embodiments providing API keys for integration with pay via place.

In one or more embodiments registration details comprises Business Name, Registration name, personal details, including first and last name, and copies of personal ID documents, Mobile Number including Mobile Number linked with bank account, Email address (optional), Shop Name/Display Name, Select Business Category, Select Business Sub Category, contact person name and contact information, country specific Business Address format including Shop/Office Number, Street Name, Area/Sector/Village, Pin code, City/Town, State, government identification numbers for person identity proof, financial information and tax identification information and business identity and permission proof including social security number, pan card number, Aadhaar number, account information including bank account information including country specific Bank code, Bank Identifier Code, SWIFT code and account number, debit card number, upload image of payments QR code generated and verified by one or more external sources.

In one or more embodiments configuring user to registering with the server system for making payment from user's account to selected place associated merchant's account or selected place associated selected uniform resource locator (URL) associated merchant's account, wherein registration details comprises mobile number, email address, user name, password, one or more types of payment methods including add and verify one or more debit cards, credit cards, wallets, UPI, pre-paid cards, and bank accounts including provide bank account code and account number.

In one or more embodiments place and place of business related or associated details including place name, icon, location information including geo-coordinates or GPS coordinates including latitude and longitude, selected or updated location or pointer on map, address, geocode, geofence including pre-defined, selected and drawn geofence, one or more types, categories, contact information including phone number, email, messaging account name, website, business hours, media including photos, videos, 360 degree views, data fields and associated values, description, products and services details, menu, one or more types of offers including discounts, sale, voucher, free samples or trails, redeemable points, cashback offer, group deals or deals, ratings, reviews, reactions including like, dislike, and emoticons, distance, estimated time to reach or arrive from particular place, routes, traffic conditions, one or more types of user actions or call-to-actions, including directions, share, bookmark, save, view nearby places, make voice call, send message, send e-mail, make video call and report, associated or related merchant information including payment information, account information, bank account information, and one or more types of unique identities and accounts details.

In one or more embodiments types of places includes shopping stores, restaurants, grocery stores, pharmacies and chemists, patrol pumps, ATMs, selling counters inside shop, hospital, banks, beauty parlor and salon, lounge, coffee shop, hotel, toll, pathology labs, multiplexes theatres, bust stop, railway stations, home or apartment or building, office, industry and manufacturing, warehouse or storage, stations, centers, school, college, class, hawkers or venders, spiritual center including temple, auditorium, museum, art gallery, boat station, cycle stand, dealers or distributors, small shops, parking including car parking, mall, garden, point of interest, tourist places, canteen, gym, service centers, clubs including sports clubs, halls, stadium, swimming pool, beach, beach stores, race course, amusement park, resorts, zoo, park, sub-place inside place, library, cab stations, government buildings and dynamic indoor or outdoor event space or event places including fair, exhibitions, conference, festival, party, circus.

In one or more embodiments displaying one or more types of applications, graphical user interfaces, forms, wizards, lists, directories and catalogues of products and services and associated details, menu, web page, website, one or more types of data, information, content and media, notifications, messages, status, logs, offers, user actions, reactions, call-to actions and controls before, while and after making of payment.

In one or more embodiments mapping existing merchant account information including merchant bank account or debit card details related to merchant to identified place based on said payment and account information associated verified address or identified place based on said address and enable visitor user of said place to make in-store payment at physical place including store or place of business location based on monitored and tracked current location of the user device and enable said merchant or user to accept payment from place visitor users of digital map.

In one or more embodiments creating place on map based on payment and account information and associated address or business address, name of business or place of business or store, categories, sub-categories, contact information including phone number, email address, website name or address or URL or generated URL at the time of registration and one or more types of information associated or related to place or address associated place, wherein identify geo coordinates or GPS coordinates including latitude and longitude based on said address for displaying or positioning or making place searchable or locating place or place associated or related one or more types of information and call-to-actions on map.

In one or more embodiments enabling user or place associated merchant or staff to provide or update or access said place related or associated one or more types of information including business hour, keywords, tags, categories, sub-categories, hours of business, one or more types of media including photos, videos, 360 degree views, and use place associate one or more types of user actions, controls and call-to-actions including provide ratings, reviews, share place or place location, make call, send message, access website, view directions, view navigation, view route, view estimated time to reach or arrive from/to current place from/to particular place, save or bookmark or add list place, view nearby places or nearby one or more types of places.

In one or more embodiments creating place on map based on already exists data records or one or more types of contents in one or more types of storage medium from one or more sources.

In one or more embodiments enabling user to select particular place on map and claim place or place of business or request manage listing of said place by sending request to server system and provide required one or more types of data or information or documents including to confirm business information including name, address, contact information, website, location information, business, identity of business, identity of place of business and identity of person who claimed or made said request whether said place owned to said requestor or not.

In one or more embodiments enabling user to add new place or place of business and or register or sign up or list or verify business or place by providing required information including business name, business category, address including country, street address, pin code, state, confirm that user wants to add a location customers can visit, like a store or office to show up said place or place of business on maps and enable to search when customers are looking for your business or place or place of business, show or select on map location of place or place of business by dragging and zooming the map and position the marker on the exact spot where place or business is located, confirm acceptance of terms of service and privacy policy associated with maps or maps service provider(s), select preferred verification option including verify business listing by mail, email, phone and based on verified website or verify business or place based on external verification service providers including verify place or place of business from mobile app by providing mobile number and entering one time password (OTP) received on said mobile device or automatically verifying by identifying received one time password (OTP) and providing bank account information including bank code and account number linked or associated with said mobile number, make payment for listing based on one or more types of memberships, subscriptions, payment models and modes.

In one or more embodiments enabling user to manage place, promote business with posting photos and posts, track business analytics to understand customers, respond to customer reviews, offline merchant associated with place can accept digital payments offline on the retail store based on place associated payment and account information or accept in-store payments via location or place associated payment control or graphical user interface (GUI) or accept Payments from place of business on map or request money including send payment links to customers to get paid instantly, conduct bank settlements including direct settlement into merchant's or user's bank account to transfer money directly into merchant's or user's bank account either instantly or within particular period of time, supports all payment methods, track their transactions and payments on a real-time basis, publish deals and offers, provide custom offers, add photos and videos to demonstrate products and services to customers, answer questions of customers, chat directly with customers, report inappropriate reviews, add or remove users to manage listings and provide rights and privileges including view payment transaction details, conduct bank settlement, edit contents including profile, photo, video, logos, URLs, contact information, categories, tags, publish posts, respond to review, make call or send and view received messages, close place or deactivate payment service, edit business hours, edit service, manage multiple places and update said details for selected one or more places, transfer ownership of listings, promote or advertise one or more places or listings of places on map and view detail reports and analytics.

In one or more embodiments a computer store containing data, for each of a plurality of places; wherein enabling to creating, claiming and verifying place, providing or updating place associated structured details including business name, business category, business address, contact information including mobile number, email, website URL, description and merchant payments and account information including bank code, account number, one or more types of legal identification numbers; verifying, storing, listing and making place and associated data accessible to users of network or displaying graphical representation and/or name of said place on map for enabling users of network to select place and view and access associated details and active links or user actions or call-to-actions; enabling users to view and select graphical representation and/or name of current place or place from nearby places, nearby category specific places, searched places on map and view associated details and select or access active link for making payments from user's account to said selected place associated merchant's account; wherein each of the places belongs to one of a plurality of place owners or merchants or authorized persons or admins; wherein each of the places displays at least one active link associated with a commerce object associated with a accepting payment opportunity of a selected one of a plurality of merchants; and wherein the selected place associated merchant, the out-source provider, and the location associated place based transactions and payments service provider are each third parties with respect to one other; a computer server at the outsource provider, which computer server is coupled to the computer store and programmed to: receive from the client application of a mobile device user a signal indicating activation of one of the links displayed by one of the places, opening or invoking standardized payment webpage or integrated payment webpage or payment flow or payment user interface, without redirecting user to different payment webpage provided by different third parties booking, e-commerce, reservation service providers; automatically identify selected place associated merchant payments and account information on which the link has been activated; in response to identification of the merchant payments and account information, automatically retrieve the stored data associated with selected place associated merchant; and using the data retrieved, automatically transmit particular amount of fund from user's account to said identified merchant's account based on said retrieved merchant's payments and account information, without the user having to enter the account information related to merchant.

In one or more embodiments the graphical user interface comprises: accessing from storage medium, uniform resource locator (URL) associated merchant account details including merchant bank account or debit card account details; selecting on a maps interface, a place or a place of business associated uniform resource locator (URL); invoking or opening said selected uniform resource locator (URL) associated webpage or website or user interface comprises payment webpage or payment flow or integrated payment webpage or payment flow; and displaying payment user interface which enable user to entre or select amount or user pre-set or default or pushed amount, select or use pre-set or default payment account of user and enable to select payment button or control for providing payment instruction to make payment of said amount from said user payment account to said selected uniform resource locator (URL) associated identified merchant account including merchant bank account or debit card account, without the user having to enter the account information related to merchant.

Present invention may use accurate location technologies including round-trip time (RTT) technology, round-trip time (RTT) is the technology that will take us to the one-meter level. The key technologies are Wi-Fi RTT (Round Trip Time), GPS dual-frequency and carrier phase measurements. By suing round-trip time (RTT) APIs in Android 9 Pie, one-meter measurement accuracy can be made available in smartphones. Wi-Fi round-trip time (RTT) will enhance indoor location accuracy and enable indoor navigation. Global Navigation Satellite System (GNSS) will achieve sub-meter location accuracy outdoors in open-sky scenarios. The Wi-Fi RTT (Round-Trip-Time) API measure the distance to nearby RTT-capable Wi-Fi access points and peer Wi-Fi Aware devices.

Directly making payments provide contactless payment, quick, convenient and secure system. Likewise user can select products and services and make payment from user selected or pre-set account from list of added different types of payment methods including debit card, credit card, direct bank transfer or unified payment service (UPI), digital wallets, pay later, pay via store or merchant relation credit, pay via installments (EMI), pay via points or offers or vouchers or coupons, pay via crypto currencies to said selected place on maps associated merchant's account directly from user device. User's client application or payment processor or payment network or merchant's server sends said payment details including user identity, transaction number, transaction date and time, selected product(s) and service(s), successfully paid total billed amount, selected payment method to said paid merchant identity or account.

In an embodiment identifying a location information of a first user of a first client application based on monitored and tracked location of a first client device; identifying location information of a second user of a second client application based on monitored and tracked location of a second client device; identifying second client device within predetermined threshold distance of the location of the first client device or identifying first client device within predetermined threshold distance of the location of the second client device; receiving request from the first client application to the second client application or receiving request from the second client application to the first client application to connect; and in the event of establishing connection based on acceptance of request by the first user from the first client application of the first client device or the second user from the second client application of the second client device or automatically establishing connection between the first client application of the first client device with the second client application of the second client device, enabling the first user of the first client application of the first client device or the second user of the second client application of the second client device to take one or more actions or call-to-actions including view received or share or send one or more types of contents, files, forms, data, messages, posts and information, communicate via one or more communication applications and mediums, conduct one or more types of transactions, subscribe, sell, buy, book, request or provide appointment, participate in deal or group deals, claim one or more types of offers or coupons or vouchers, receive, view or provide status, updates, share contact information, connect mutually, follow, view or provide feedbacks or reactions.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates a schematic diagram of an environment in which a payment system and/or in-store checkout and payment and/or order and payment system operates in accordance with one or more embodiments;

FIG. 2 illustrates components of an electronic device implementing various embodiments related to registration, log in, manage profile and payment methods, in-store and/or online making payment and/or making order and payment directly from user client device, view payment confirmation notifications, logs, status, bills, connect with merchant client application and reactive pushed bill and make payment and like.

FIG. 3 illustrates components of an electronic device implementing various embodiments related to registration, log in, view payment confirmation notifications, add or update products or services details, view logs, view received orders, settlements, reports and like, connect with user client application and send or push or present bill or invoice and or receipt.

FIGS. 4-5 illustrate a sequence-flow diagram illustrating interactions as part of a payment process between a user and a merchant in accordance with one or more embodiments;

FIGS. 6-10 illustrate example graphical user interfaces for initiating a payment transaction in accordance with one or more embodiments;

FIG. 11 illustrates connected user client application and merchant client application and enable both to communicate, view details of connected users, orders, status, payments, payment status, selected connected users and take one or more actions and like;

FIG. 12 illustrates a flow chart of a series of acts in a method of in-store and/or online directly making payment from user client device and identification of user and merchant identity for processing payment transactions in accordance with one or more embodiments;

FIGS. 13-29 illustrate example graphical user interfaces for various types or categories specific places of business for initiating a payment transaction in accordance with one or more embodiments;

FIG. 30 is a block diagram of a computer system suitable for implementing one or more embodiments of the present disclosure.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

Embodiments of the present disclosure provide a payment system that allows users to engage in payment transactions with merchants. In particular, one or more embodiments provide a payment system for users to purchase goods or services at in-store checkout locations using electronic payments. For example, the payment system identifies a user at an in-store checkout location based on selected place on map associated website or webpage uniform resource locator (URL) or web address or user inputted or selected uniform resource locator (URL) or web address of website or webpage.

In particular, one or more embodiments provide a payment system for users to purchase goods or services remotely or online using electronic payments. For example user selects place on map and select said selected place associated website or webpage uniform resource locator (URL) or input or select web address or uniform resource locator (URL) or web address of website or webpage and make advance order for consume at store or takeaway or instruct delivery to save time or make order over phone and make advance payment by entering amount, select payment method and make payment.

In one or more embodiments, for example, the payment system 100 receives payment request directly from user mobile device 130 at a checkout location and identifies merchant identity and associated merchant bank account or debit card details based on clicked place associated website or webpage or by manually inputted or selected said place associated website uniform resource locator (URL) from web browser at a checkout location and identifying the user based on received user identity or one or more types of unique identity of registered user or registered user's registered user device. In an embodiment the payment system requests further authorization from the user by sending a notification to the user's mobile device. By using said identify of user during checkout, sending notifications to the users' mobile devices to request further instruction or authorization, the payment system allows user to engage in easy, convenient, fast, and secure in-store (or online) payment transactions with merchants directly from mobile device of user.

As mentioned, the payment system allows users to initiate electronic payment transactions with merchants. Specifically, the payment system receives a payment request to initiate a payment transaction between a user and a merchant from a user client device.

Once the payment system identifies the user, the payment system identifies a payment account for the user. For example, the payment system accesses a user account for the user and identifies a payment account. To illustrate, the payment system can identify a payment account that the user previously registered and stored in the user account. Thus, the payment system can identify the pre-set or default payment account for the user without requiring the user to perform any additional actions.

As briefly mentioned above, in one or more embodiments, the payment system also sends a notification to a client device of the user to request further authorization for the payment transaction. Specifically, the payment system identifies a client device associated with the user account corresponding to the user. For example, the user associates one or more client devices with the user account that are authorized to initiate and approve payment transactions (e.g., a smart phone). To illustrate, the payment system can determine one or more client devices associated with the user account by identifying client devices from which the user has logged into the user account via an authorized application. The payment system can then send a notification to request confirmation and authorization of the payment transaction between the user and the merchant. For example, the payment system can send a push notification to the client device of the user to notify the user of the payment transaction. To confirm and authorize the payment transaction, one or more embodiments allow the user to interact with the notification on a lock screen or in a notification tray without requiring the user to open a specific application. When the payment system receives a confirmation response from the user's client device, the payment system initiates the payment transaction. Specifically, the payment system initiates the payment transaction by sending a payment token representing the user's payment account information to the merchant server or server 110. The merchant server or server 110 can then send the payment token to a payment network to process the payment transaction between the user and the merchant. Alternatively, the payment system initiates the payment transaction by sending the payment token directly to the payment network, bypassing the merchant server or server 110 or 3^{rd} parties service provider server. By using a tokenized version of the payment account information, the payment system can allow the user to engage in payment transactions with the merchant without sending the user's actual payment account information to the merchant.

Because the payment system uses authorization via the user's client device, the payment system can provide a fast and secure payment transaction process. In another embodiment additionally, the authentication step allows the payment system to require that the user provide explicit approval prior to processing a payment transaction. Specifically, the authentication step prevents other users from entering into payment transactions even if the other users were able to fool the payment into identifying the user when the user is not present.

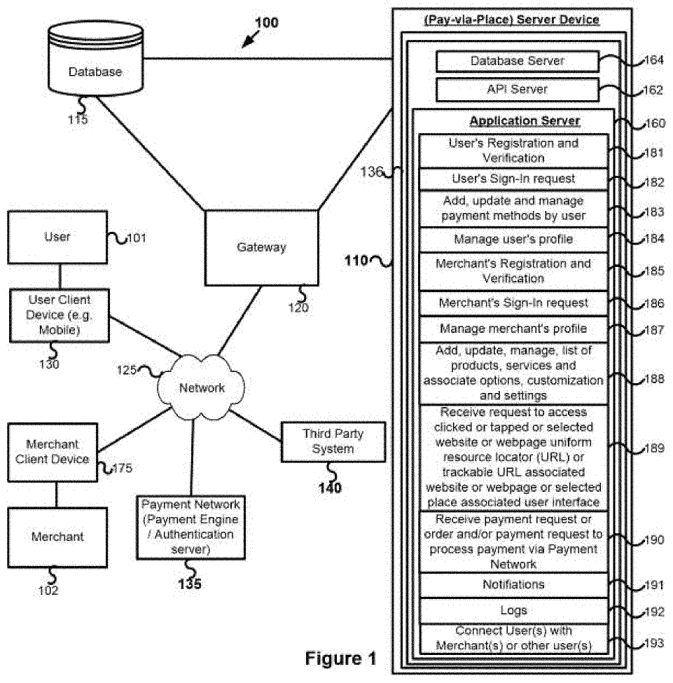

FIG. 1 is a schematic diagram illustrating an environment that includes a payment system 100 in accordance with one or more embodiments. An overview of the environment is described in relation to FIG. 1. Thereafter, a more detailed description of the components and processes of the payment system 100 and other components within the environment are provided in relation to the remaining figures.

FIG. 1 illustrates a schematic diagram illustrating additional details of the environment including the components of the payment system 100 and the payment network 135. As shown, the payment system 100 includes a user client device 130, a merchant client device 175 (collectively “client devices”), and server device(s) 110. In general, the payment system 100 allows a user associated with the user client device 130 to engage in in-store electronic payment transactions with a merchant directly from user client device 130 via server 110 or one or more 3^{rd} parties payment service providers based on APIs and SDKs provided by payment system 100. Additionally, the payment system 100 can allow users to exchange messages with merchants or other users via the respective client devices.

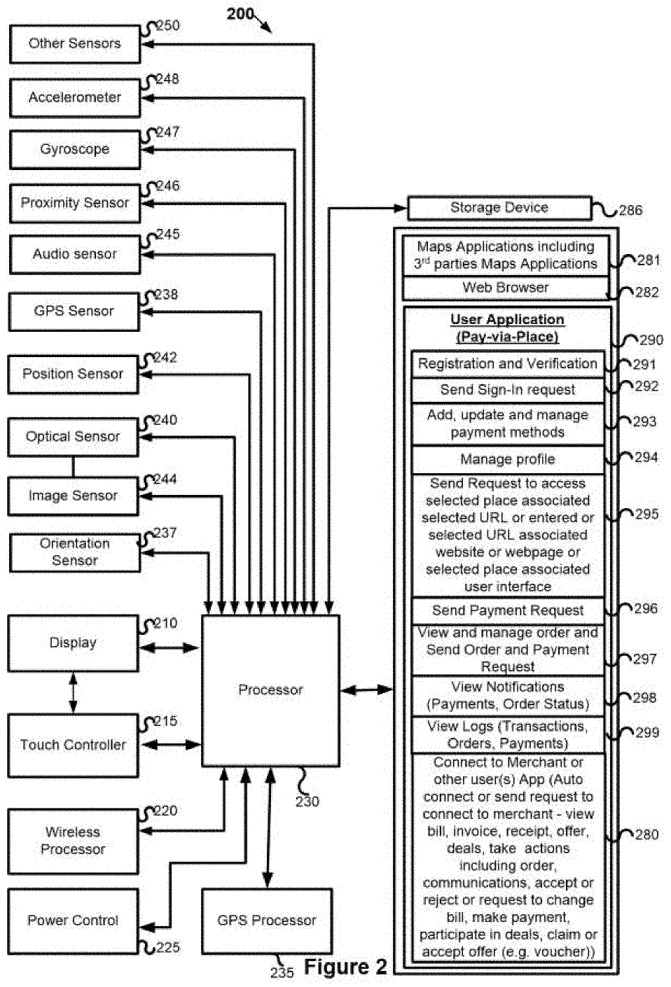

As shown, the payment system 100 includes various components on the user client device 130, the merchant client device 175, and the server device(s) 110. For example, FIG. 2 illustrates that the client devices 130 (200) and 170 (300) each include a client application (e.g., a web browser, a messaging application, a payment application or an e-commerce application) with various components, and the server device(s) 110 include a network application 160 and a payment engine 190 with various components 164/162. The merchant client device 175 (300) also includes one or more features 390. The payment network 135 is illustrated as a component or system separate from the payment system 100, though other embodiments of the payment system 100 may include some or all of the components/functionality of the payment network 135. The components of the client applications 130, 175, the network application 160, and the payment engine 190 work together to allow a user to send payments to a merchant, as described in greater detail below.

As illustrated by FIG. 1, the payment system 100 allows a user 101 to engage in electronic payment transactions with merchants. Specifically, the payment system 100 allows a user to engage in an in-store electronic payment transaction with a merchant using a user client device 130 and a merchant client device 175, respectively. As further illustrated in FIG. 1, and as described in more detail in additional figures, the payment system 100 allows the merchant client device 175 associated with the merchant to communicate with server device(s) 110 via a network 125. The server device(s) 110 are also able to communicate with the user client device 130 associated with the user via the network. In addition, the payment system 100 can include a payment network 135 communicatively coupled with the server device(s) 110 via the network 125. Although FIG. 1 illustrates a particular arrangement of the user client device 130, the merchant client device 175, the server device(s) 110, the network 125, and the payment network 135, various additional arrangements are possible. For example, the user client device 130 and/or the merchant client device 175 may directly communicate with the server device(s) 110, bypassing the network 125. In another example, the server device(s) 110 may include the payment network 135, such that the payment system 100 processes payment transactions at the server device(s) 110.

The payment system 100 coordinates the sending and receiving of payments between the user 101 and the merchant 102 in connection with a payment transaction. For example, the user 130 can begin a checkout process by selecting one or more goods or services to purchase at an in-store checkout location. The in-store checkout location can include a checkout terminal or other checkout location (e.g., a POS terminal/device) that allows the user to purchase goods or services in a physical store. According to various embodiments, the checkout location can allow the user to interact with the merchant to purchase goods or services or can allow the user 101 to perform a self-checkout process to purchase goods or services.

As briefly mentioned above, FIG. 1 shows that the user and the merchant can use a user client device 130 and a merchant client device 175, respectively, to engage in electronic payment transactions with one another via the server device(s) 110 and the payment network 135.

The server device(s) 110 identifies the user based on the sign in and associated user name or one or more types of user identity and identifies the merchant based on selected place on maps associated website or webpage uniform resource locator (URL) or web address associated merchant identity or merchant's account information including bank account or debit card details or inputted or entered or selected website or webpage uniform resource locator (URL) or web address associated merchant identity or merchant's account information including bank account or debit card details. For example, the user, using the user client device 130 can exchange payment transaction information (e.g., user/merchant identifiers, payment amounts, selected or default or pre-set payment account information) with the server device(s) 110 in one or more electronic communications. The server device(s) identifies the user 130 and merchant 175 based on the received identities and determines a payment account for the user and determines a merchant account or merchant's bank account to use in processing the payment transaction.

Additionally, the user 101, using the user client device 130, can exchange one or more electronic communications with the server device(s) 110 to confirm and authorize one or more payment transactions. For example, the server device(s) 110 can receive said payment transaction data from the user client device 130 after identifying the user 101 and merchant 102 and identifying the selected or default or pre-set payment account or automatically determined account based on charges, country, currency, offer including redeemable points and like. The user 101 can authorize the payment transaction by interacting with the user client device 130 to cause the user client device 130 to send an instruction authorization to the server device(s) 110. The server device(s) 110 can then process the payment transaction between the user 101 and the merchant 102 based on the user's authorization. Specifically, the server device(s) 110 communicate with the payment network 125 to transfer funds from a payment account of the user to a payment receivable account of the merchant 175.

Based on a various embodiments of the payment system 100, the server device(s) 110 store various types of information associated with users and merchants. Specifically, the server device(s) 110 store identifier information for use in identifying the user 101 and the merchant 102 in a payment transaction. For example, in one or more embodiments, the server device(s) 106 can include or communicate with a server 110 that stores 115 user information for users registered with the server 110. To illustrate, the social networking system can maintain user accounts including user identification information and payment account information. The server device(s) 110 can use any of the user information to identify the user 101 and to initiate a payment transaction between the user 101 and a merchant 102.

In addition to allowing the user 101 and the merchant 102 to engage in electronic payment transactions, the payment system 100 can allow users and/or merchants to exchange messages with other users. For example, client applications on the user client device 130 and the merchant client device 175 allow the user 101 and merchant 102 to exchange communications with each other. To illustrate, the user client device 130 and merchant client device 175 sends and receives communication messages (e.g., text messages, instant messages) via the server device(s) 110.

As mentioned previously, and as FIG. 1 illustrates, the user 101 and merchant 102 can interact with the user client device 120 and the merchant client device 175, respectively. Examples of client devices include computing devices such as mobile devices (e.g., smartphones, tablets, smartwatches), laptops, desktops, or any other type of computing device. Moreover, and as mentioned above, the user client device 130 and the merchant client device 175 can communicate with the server device(s) 110 and/or with each other through the network 125. In one or more embodiments, the network 125 includes the Internet or World Wide Web. The network 125, however, can include one or more private and/or public networks that use various communication technologies and protocols, as further described below.

FIG. 1 illustrates an example platform, under an embodiment. According to some embodiments, system 100 can be implemented through software that operates on a portable computing device, such as a mobile computing device. System 100 can be configured to communicate with one or more network services, databases, objects that coordinate, orchestrate or otherwise provide advertised contents of each user to other users of network. Additionally, the mobile computing device can integrate third-party services which enable further functionality through system 100.

While FIG. 1 illustrates a gateway 120, a database 115 and a server 110 as separate entities, the illustration is provided for example purposes only and is not meant to limit the configuration of the system. In some embodiments, gateway 120, database 115 and server 110 may be implemented in the system as separate systems, a single system, or any combination of systems.

As illustrated in FIG. 1, the system may include a user client device 130 and merchant client device 175. Devices or Mobile devices 130/175 may be particular set number of or an arbitrary number of devices or mobile devices which may be capable of accessing maps application(s), accessing web browser(s), registration, sending and receiving SMS or push notifications, send and receive user data, profile, notifications, status, messages, contents, sign in via employing one or more methods. Each device or mobile device in the set of user and merchant) 130/175 and mobile devices 130/175 may be configured to communicate, via a wireless connection. Each one of the mobile devices 130/175 may also be configured to communicate, via a wireless connection, to a network 125, as illustrated in FIG. 1. The wireless connections of mobile devices 130/175 may be implemented within a wireless network such as a Bluetooth network or a wireless LAN.

As illustrated in FIG. 1, the system may include gateway 120. Gateway 120 may be a web gateway which may be configured to communicate with other entities of the system via wired and/or wireless network connections. As illustrated in FIG. 1, gateway 120 may communicate with mobile devices 130/175 via network 125. In various embodiments, gateway 120 may be connected to network 125 via a wired and/or wireless network connection. As illustrated in FIG. 1, gateway 120 may be connected to database 115 and server 110 of system. In various embodiments, gateway 120 may be connected to database 115 and/or server 110 via a wired or a wireless network connection.

Gateway 120 may be configured to send and receive user data including registration and profile information, payment methods, payment account and merchant account details, payment request, notifications, status, orders, payment transactions and orders logs, user shared data or contents, logs of user's activities, actions, events, senses, transactions, status, updates, presence information, locations, check-in places and like) to/from mobile devices 130/175. For example, gateway 120 may be configured to receive registration information provided by user or merchant to database 115 for storage.

Database 115 may also be configured to receive and service requests from gateway 120. For example, database 115 may receive, via gateway 120, a request from a mobile device and may service the request by providing, to gateway 120, various types of user profile, user data, added payment methods data, logs, status which meet the criteria specified in the request. Database 115 may be configured to communicate with server 110.

As illustrated in FIG. 1, the system may include a server, such as server 110. Server may be connected to database 115 and gateway 120 via wired and/or wireless connections. As described above, server 110 may be notified, by gateway 120, of new or updated profile, payment methods, accessing of profile, user data, user payment methods, logs and status stored in database 115.

FIG. 1 illustrates a block diagram of a system configured to implement the various embodiments related to platform. While FIG. 1 illustrates a gateway 120, a database 115 and a server 110 as separate entities, the illustration is provided for example purposes only and is not meant to limit the configuration of the system. In some embodiments, gateway 120, database 115 and server 110 may be implemented in the system as separate systems, a single system, or any combination of systems.

FIG. 2 illustrates an electronic device 200 implementing operations of the invention. In one embodiment, the electronic device 200 is a smartphone with a processor 230 in communication with a memory 290. The processor 230 may be a central processing unit and/or a graphics processing unit. The memory 290 is a combination of flash memory and random-access memory. The memory 290 stores a Registration and Verification module 291 to implement operations of one of the embodiments of the invention. Module 291 may include executable instructions to access a server which coordinates operations disclosed herein. Alternately, the module 291 may include executable instructions to coordinate some of the operations disclosed herein, while the server module 181 implements other operations.

The memory 290 stores a Send Sign-In request 292 may include executable instructions to access a server which coordinates operations disclosed herein. Alternately, the module 292 may include executable instructions to coordinate some of the operations disclosed herein, while the server module 182 implements other operations.

The memory 290 stores a Add, update and manage payment methods module 293 to implement operations of one of the embodiments of the invention. The module 293 may include executable instructions to access a server which coordinates operations disclosed herein. Alternately, the module 293 may include executable instructions to coordinate some of the operations disclosed herein, while the server module 183 implements other operations.

The memory 290 stores a Manage profile 294 to implement operations of one of the embodiments of the invention. The Manage profile 294 module may include executable instructions to access a server which coordinates operations disclosed herein. Alternately, the Manage profile module 294 may include executable instructions to coordinate some of the operations disclosed herein, while the server module 184 implements other operations.

The memory 290 stores a Send Request to access selected place associated or entered or selected URL associated website or webpage 295 to implement operations of one of the embodiments of the invention. The module 295 may include executable instructions to access a server which coordinates operations disclosed herein. Alternately, the module 295 may include executable instructions to coordinate some of the operations disclosed herein, while the server module 189 implements other operations.

The memory 290 stores a Send Payment Request 296 to implement operations of one of the embodiments of the invention. The Send Payment Request module 296 may include executable instructions to access a server which coordinates operations disclosed herein. Alternately, the Send Payment Request module 296 may include executable instructions to coordinate some of the operations disclosed herein, while the server module 190 implements other operations.

The memory 290 stores a View and manage order and Send Order and Payment Request 297 to implement operations of one of the embodiments of the invention. The module 297 may include executable instructions to access a server which coordinates operations disclosed herein. Alternately, the module 297 may include executable instructions to coordinate some of the operations disclosed herein, while the server module 188 and 190 implements other operations.

The memory 290 stores a View Notifications (Payments, Order Status) 298 to implement operations of one of the embodiments of the invention. The module 298 may include executable instructions to access a server which coordinates operations disclosed herein. Alternately, the module 298 may include executable instructions to coordinate some of the operations disclosed herein, while the server module 191 implements other operations.

The memory 290 stores a View Logs (Transactions, Orders, Payments) 299 to implement operations of one of the embodiments of the invention. The module 299 may include executable instructions to access a server which coordinates operations disclosed herein. Alternately, the module 299 may include executable instructions to coordinate some of the operations disclosed herein, while the server module 192 implements other operations.

The memory 290 stores a connect to merchant application 280 to implement operations of one of the embodiments of the invention. The module 280 may include executable instructions to access a server which coordinates operations disclosed herein. Alternately, the module 280 may include executable instructions to coordinate some of the operations disclosed herein, while the server module 193 implements other operations.

The processor 230 is also coupled to image sensors 238. The image sensors 238 may be known digital image sensors, such as charge coupled devices. The image sensors capture visual media, which is presented on display 210. The image sensors 238 capture visual media and present the visual media on the display 210 so that a user can observe the captured visual media.

A touch controller 215 is connected to the display 210 and the processor 230. The touch controller 215 is responsive to haptic signals applied to the display 210.

The electronic device 200 may also include other components commonly associated with a smartphone, such as a wireless signal processor 220 to provide connectivity to a wireless network. A power control circuit 225 and a global positioning system (GPS) processor 235 may also be utilized.

The Global Positioning System (GPS) sensor 244 determines the geolocation of the mobile device 200 and generates geolocation information (e.g., coordinates including latitude, longitude, aptitude). In another embodiment, other sensors may be used to detect a geolocation of the mobile device 200. For example, a Wi-Fi sensor or Bluetooth sensor or Beacons including iBeacons or other accurate indoor or outdoor location determination and identification technologies can be used to determine the geolocation of the mobile device 200.

FIG. 2 shows a block diagram illustrating one example embodiment of a mobile device 200. The mobile device 200 includes an optical sensor 244 or image sensor 238, a Global Positioning System (GPS) sensor 235, a position sensor 242, a processor 230, a storage device 286, and a display 210.

The optical sensor 244 includes an image sensor 238, such as, a charge-coupled device. The optical sensor 244 captures visual media. The optical sensor 244 can be used to media items such as pictures and videos.

The GPS sensor 238 determines the geolocation of the mobile device 200 and generates geolocation information (e.g., coordinates including latitude, longitude, aptitude). In another embodiment, other sensors may be used to detect a geolocation of the mobile device 200. For example, a WiFi sensor or Bluetooth sensor or Beacons including iBeacons or other accurate indoor or outdoor location determination and identification technologies can be used to determine the geolocation of the mobile device 200.

The position sensor 242 measures a physical position of the mobile device relative to a frame of reference. For example, the position sensor 242 may include a geomagnetic field sensor to determine the direction in which the optical sensor 240 or the image sensor 244 of the mobile device is pointed and an orientation sensor 237 to determine the orientation of the mobile device (e.g., horizontal, vertical etc.).

The processor 230 may be a central processing unit that includes a media capture application 273, a media display application, and a media sharing application.

The media capture application 273 (not shown in figure) includes executable instructions to generate media items such as pictures and videos using the optical sensor 240 or image sensor 244. The media capture application 273 also associates a media item with the geolocation and the position of the mobile device 200 at the time the media item is generated using the GPS sensor 238 and the position sensor 242.

The media sharing application includes executable instructions to enable the user to share one or more types of contents with controls to one or more selected or auto identified destinations or users of network.

The storage device 286 includes a memory that may be or include flash memory, random access memory, any other type of memory accessible by the processor 230, or any suitable combination thereof. The storage device 286 stores required data revived by/from application 290. The storage device 286 also stores executable instructions corresponding to Registration and Verification 291, Send Sign-In request 292, Add, update and manage payment methods 293, Manage profile 294, Send Request to access selected place associated or entered or selected URL associated website or webpage 295, Send Payment Request 296, View and manage order and Send Order and Payment Request 297, View Notifications (Payments, Order Status) 298, View Logs (Transactions, Orders, Payments) 299.

The display 210 includes, for example, a touch screen display. The display 210 displays the media items generated by the media capture application. A user captures record and selects media items by touching the corresponding media items on the display 210. A touch controller monitors signals applied to the display 210 to coordinate the capturing, recording, and selection of the media items.

The mobile device 200 also includes a transceiver that interfaces with an antenna. The transceiver may be configured to both transmit and receive cellular network signals, wireless data signals, or other types of signals via the antenna, depending on the nature of the mobile device 200. Further, in some configurations, the GPS sensor 238 may also make use of the antenna to receive GPS signals.

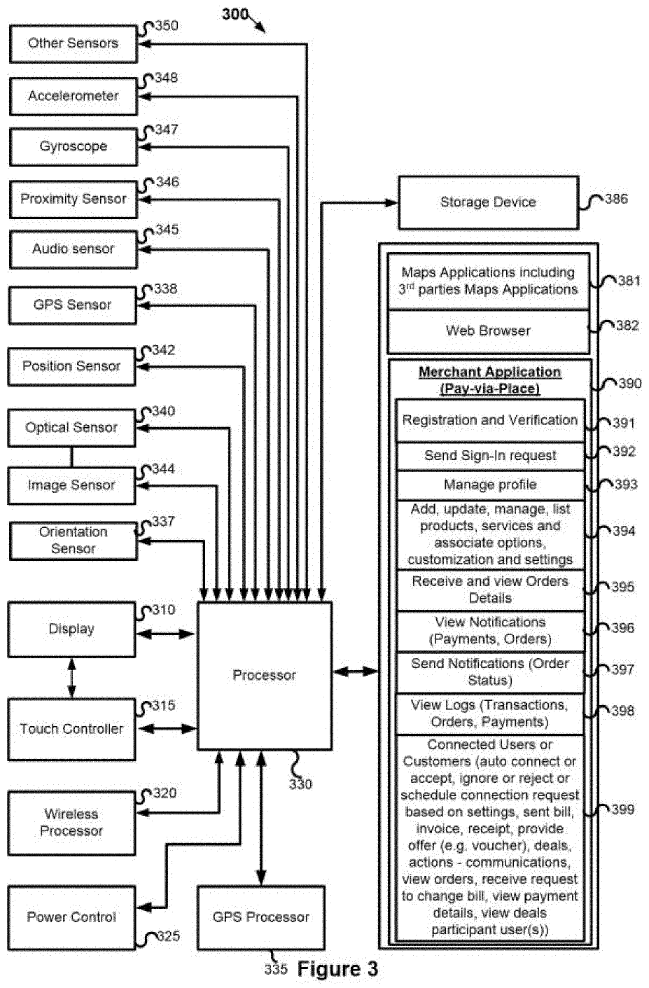

FIG. 3 illustrates an electronic device 300 implementing operations of the invention. In one embodiment, the electronic device 300 is a smartphone with a processor 230 in communication with a memory 390. The processor 330 may be a central processing unit and/or a graphics processing unit. The memory 390 is a combination of flash memory and random-access memory. The memory 390 stores a Registration and Verification module 391 to implement operations of one of the embodiments of the invention. Module 391 may include executable instructions to access a server which coordinates operations disclosed herein. Alternately, the module 391 may include executable instructions to coordinate some of the operations disclosed herein, while the server module 185 implements other operations.

The memory 390 stores a Send Sign-In request 392 may include executable instructions to access a server which coordinates operations disclosed herein. Alternately, the Send Sign-In request module 392 may include executable instructions to coordinate some of the operations disclosed herein, while the server module 183 implements other operations.

The memory 390 stores a Manage profile 393 to implement operations of one of the embodiments of the invention. The Manage profile 393 module may include executable instructions to access a server which coordinates operations disclosed herein. Alternately, the Manage profile 393 may include executable instructions to coordinate some of the operations disclosed herein, while the server module 187 implements other operations.

The memory 390 stores a Add, update, manage, list products, services and associate options, customization and settings 394 to implement operations of one of the embodiments of the invention. The module 394 may include executable instructions to access a server which coordinates operations disclosed herein. Alternately, the module 394 may include executable instructions to coordinate some of the operations disclosed herein, while the server module 188 implements other operations.

The memory 390 stores a Receive and view Orders Details 395 to implement operations of one of the embodiments of the invention. The module 395 may include executable instructions to access a server which coordinates operations disclosed herein. Alternately, the module 395 may include executable instructions to coordinate some of the operations disclosed herein, while the server module 190 implements other operations.

The memory 390 stores a View Notifications (Payments, Orders) 396 to implement operations of one of the embodiments of the invention. The module 396 may include executable instructions to access a server which coordinates operations disclosed herein. Alternately, the module 396 may include executable instructions to coordinate some of the operations disclosed herein, while the server module 191 implements other operations.

The memory 390 stores a Send Notifications (Order Status) 397 to implement operations of one of the embodiments of the invention. The module 397 may include executable instructions to access a server which coordinates operations disclosed herein. Alternately, the module 397 may include executable instructions to coordinate some of the operations disclosed herein, while the server module 191 implements other operations.

The memory 390 stores a View Logs (Transactions, Orders, Payments) 398 to implement operations of one of the embodiments of the invention. The module 398 may include executable instructions to access a server which coordinates operations disclosed herein. Alternately, the module 398 may include executable instructions to coordinate some of the operations disclosed herein, while the server module 192 implements other operations.

The memory 390 stores an in-store or online user connections or connected user's management 399 to implement operations of one of the embodiments of the invention. The module 399 may include executable instructions to access a server which coordinates operations disclosed herein. Alternately, the module 399 may include executable instructions to coordinate some of the operations disclosed herein, while the server module 192 implements other operations.

The processor 330 is also coupled to image sensors 338. The image sensors 338 may be known digital image sensors, such as charge coupled devices. The image sensors capture visual media, which is presented on display 310. The image sensors 338 capture visual media and present the visual media on the display 310 so that a user can observe the captured visual media.

A touch controller 315 is connected to the display 310 and the processor 330. The touch controller 315 is responsive to haptic signals applied to the display 310.

The electronic device 300 may also include other components commonly associated with a smartphone, such as a wireless signal processor 320 to provide connectivity to a wireless network. A power control circuit 325 and a global positioning system (GPS) processor 335 may also be utilized.

The Global Positioning System (GPS) sensor 344 determines the geolocation of the mobile device 300 and generates geolocation information (e.g., coordinates including latitude, longitude, aptitude). In another embodiment, other sensors may be used to detect a geolocation of the mobile device 300. For example, a Wi-Fi sensor or Bluetooth sensor or Beacons including iBeacons or other accurate indoor or outdoor location determination and identification technologies can be used to determine the geolocation of the mobile device 300.

FIG. 3 shows a block diagram illustrating one example embodiment of a mobile device 300. The mobile device 300 includes an optical sensor 344 or image sensor 338, a Global Positioning System (GPS) sensor 335, a position sensor 342, a processor 330, a storage device 386, and a display 310.

The optical sensor 344 includes an image sensor 338, such as, a charge-coupled device. The optical sensor 344 captures visual media. The optical sensor 344 can be used to media items such as pictures and videos.

The GPS sensor 338 determines the geolocation of the mobile device 300 and generates geolocation information (e.g., coordinates including latitude, longitude, aptitude). In another embodiment, other sensors may be used to detect a geolocation of the mobile device 300. For example, a WiFi sensor or Bluetooth sensor or Beacons including iBeacons or other accurate indoor or outdoor location determination and identification technologies can be used to determine the geolocation of the mobile device 300.

The position sensor 342 measures a physical position of the mobile device relative to a frame of reference. For example, the position sensor 342 may include a geomagnetic field sensor to determine the direction in which the optical sensor 340 or the image sensor 344 of the mobile device is pointed and an orientation sensor 337 to determine the orientation of the mobile device (e.g., horizontal, vertical etc.).

The processor 330 may be a central processing unit that includes a media capture application 373, a media display application, and a media sharing application.

The media capture application 373 (not shown in figure) includes executable instructions to generate media items such as pictures and videos using the optical sensor 340 or image sensor 344. The media capture application 373 also associates a media item with the geolocation and the position of the mobile device 300 at the time the media item is generated using the GPS sensor 338 and the position sensor 342.

The media sharing application includes executable instructions to enable the user to share one or more types of contents with controls to one or more selected or auto identified destinations or users of network.

The storage device 386 includes a memory that may be or include flash memory, random access memory, any other type of memory accessible by the processor 330, or any suitable combination thereof. The storage device 386 stores required data revived by/from application 390. The storage device 386 also stores executable instructions corresponding to Registration and Verification 391, Send Sign-In request 392, Manage profile 29, Add, update, manage, list products, services and associate options, customization and settings 394, Receive and view Orders Details 395, View Notifications (Payments, Orders) 396, Send Notifications (Order Status) 397, View Logs (Transactions, Orders, Payments) 398.

The display 310 includes, for example, a touch screen display. The display 310 displays the media items generated by the media capture application. A user captures record and selects media items by touching the corresponding media items on the display 310. A touch controller monitors signals applied to the display 310 to coordinate the capturing, recording, and selection of the media items.

The mobile device 300 also includes a transceiver that interfaces with an antenna. The transceiver may be configured to both transmit and receive cellular network signals, wireless data signals, or other types of signals via the antenna, depending on the nature of the mobile device 300. Further, in some configurations, the GPS sensor 338 may also make use of the antenna to receive GPS signals.

In an embodiment merchant can create new account or send registration and verification request 391 from merchant client device 300 to server 110 module 185 by providing name, mobile, email and password. Server verifies email or mobile by sending one-time password (OTP). Merchant can register with the server 110 by using online website provided by server 110 or via downloading, installing merchant's application. Server 110 displaying country specific merchant registration form based on automatically identified country or selected country. In an embodiment merchant need to enter unique place identity or unique place link or web address or uniform resource locator (URL) provided by maps including 3rd parties maps (e.g. Google Maps or Bing Maps) where said place or business is listed to identify place exists on maps including 3rd parties maps (e.g. Google Maps or Bing Maps), retrieve place associated details from listed place on maps including 3rd parties maps application (e.g. Google Maps or Bing Maps) via APIs provided by said maps including 3rd parties maps (e.g. Google Maps or Bing Maps) and check whether said place is verified or not verified on said maps including 3rd parties maps (e.g. Google Maps or Bing Maps) by using web scrapping or APIs provided by said maps including 3rd parties maps (e.g. Google Maps or Bing Maps). In an embodiment if said place is verified then automatically retrieve, import and fill maximum possible merchant's place details from maps where said place or business is listed on maps including 3rd parties maps application (e.g. Google Maps or Bing Maps) via APIs provided by said maps including 3rd parties maps (e.g. Google Maps or Bing Maps) or in another embodiment enabling merchant to manually enter or input or select details, wherein merchant's place of business details including place or business or store name, category (e.g. Restaurants, Bars, Coffee, Brunch, Dessert, Delivery and Takeaway, Parks, Gyms, Art, Attractions, Nightlife, Live Music, Films and Theatres, Museums, Libraries, Groceries, Beauty Supplies, Car dealers, Home & gardens, Clothing, Shopping centers, Electronics, Sporting goods, Convenience, Hotels, ATMs, Beauty salons, Car hire, Car repair, Car wash, Dry cleaning, Electric vehicle, Petrol, Hospitals & clinics, Post, Parking, Chemists), business details, address including shop/office number, street name, area/sector/village, pin code, city/town, state, tax identities (e.g. GST number), phone number, website, email address, position or geo-coordinates on map, photos, videos, logos, business hours, monthly turnover, country specific government identities, current payment methods used by merchant for accepting payments from customers, list and details of products and services offered including name, photo, video, description, price, quantity, offer including discount, deals. After providing place of business associated details merchant need to provide country specific merchant's bank details or provide the bank details including bank account details (e.g. Account No., IFSC Code) where merchant want to receive your money. In an embodiment verify merchant provided mobile number via one-time password (OTP). In an embodiment automatically verify said merchant's bank details, mobile number linked bank accounts or bank account linked mobile number via relevant bank APIs or one or more types of required APIs provided by authorized 3^{rd} parties. After verification merchant agree with terms and conditions and link bank account. In another embodiment server 110 match address and/or phone number linked with bank account with said provided place of business associated address and/or mobile phone number. In another embodiment server 110 generates unique payment webpage link or unique uniform resource locator (URL) or trackable unique uniform resource locator (URL) for said registered merchant based on website uniform resource locator (URL), options selected by merchant including merchant want's customer redirect to Pay-via-place payment webpage or merchant wants to integrate Pay-via-place via APIs or merchant wants to integrate link of Pay-via-place payment webpage with merchant's website or webpage to enable user to click or tap on said integrated or linked or embedded Pay-via-place link or uniform resource locator (URL) to redirect to Pay-via-place payment webpage wherein said Pay-via-place payment webpage comprise link or uniform resource locator (URL) of merchant's website's home page, so user can click on said link or uniform resource locator (URL) of merchant's website's home page to access features and contents of merchant's website. After generating said link or uniform resource locator (URL) instructing merchant to copy and paste said generated and displayed link or unique uniform resource locator (URL) or trackable unique uniform resource locator (URL) in website or URL details of listed place of business on one or more maps applications including 3rd parties maps application (e.g. Google Maps or Bing Maps), so user can click or tap on said pasted or updated or inputted or added link or uniform resource locator (URL). In an embodiment merchant can integrate Pay-via-place UI flows or pre-made UI components via Web (API) or payments APIs. Merchants can integrate with Pay-via-place as a trusted payment channel for both online and offline businesses. For Online as well as innovative offline businesses, Pay-via-place can be integrated through Web, or through mobile SDKs Android and iOS to collect payments from customers. Pay-via-place is a multi-instrument payment container and allows customers to pay through UPI, Debit Card, Credit Card, Wallet, Pay via Pay Later or Pay via Installments, Pay via store provided custom credits, Points, Crypto currencies and other payment methods and options. In another embodiment based on merchant's preferences when user click or tapped on website or URL associated or pasted in details of place of business of merchant, user is redirected to unique payment webpage of Pay-via-place, so merchant does not need to develop, maintain and host website. In another embodiment merchant can integrate said generated Pay-via-place payment webpage link or URL at the time of registration of merchant with website or webpage of merchant, so user can click or tap on said link to make payment via Pay-via-place.

In an embodiment generate QRcode for merchant for enabling their customer to pay also via scanning QR code. In an embodiment assigning a unique merchant identification number (MID) to a registered merchant account to identify it throughout the course of processing activities. In an embodiment provide API keys for integration with pay via place.

In an embodiment in API type integration a merchant submits credit card information to their own server through a form. The server then forwards the information to a pay-via-place server 110 or own payment gateways or integrated external payment service provider (PSP) through their API. PSPs usually provide a server-side SDK to help implement these integrations.

In link type integration when a user is about to make a payment, the merchant forwards the user to a PSP-hosted page with a form to accept credit card information. The payment info the user submits through the form will be directly passed to and processed by the PSP. The user will then be brought back to the merchant webpage to (hopefully) find the payment is complete.

In tokenization type integration a form is shown in a merchant hosted page, but it's actually served from a PSP's domain through an iframe. User's submission of card info will be directly passed to the PSP's server, and the merchant will receive a token as a result. The merchant can then verify it through their server and ask the PSP to process the payment. The point here is that most of these operations are handled by PSP's client-side SDK, which allows the merchant to process payments without touching a single digit of a user's credit card number.

Web Payments is the name of the working group at W3C trying to standardize a set of open standards payments in the browser. It is also used generally to mean the overall effort to make payments better on the web. Payment Request API is one of specifications the Web Payments Working Group has written. The API governs how a user agent (browser) can communicate with an implementation (website) to exchange payment credentials.

In an embodiment instruct merchant to download, install and register merchant application to finish registration. Merchant's mobile phone number is verified via sending or autofill one-time password (OTP).

In an embodiment registered merchant can send sign-in request 392 to server 1110 module 186, server 1110 module 186 authentic merchant based on login information including merchant user identity and password and in the event of successful login enable logged-in merchant view transaction logs including transaction identity, customer or user identity, reference number, date and time, amount, source details, invoice and like, view payment receipt notification and in the event of tapping on notification display payment receipt with details in web interface after each successful payments, conduct or manage settlements including transfer fund from merchant account to merchant's regular bank account, settlement reconciliation, fraud reporting, and dispute management and view reports and analytics. In an embodiment logged-in merchant can send request to view and access merchant's detail profile 393 including place of business details (business or store or brand name, categories, logo, description, photos, videos, business hours, posts, answers of customers' queries, contact information including phone number, email address, website, URLs and like) and merchant account details (bank account or debit card details) to server 110 module 187, server 110 module 187 enables logged-in merchant to view, manage, add, update said details. In an embodiment logged-in merchant can send request to access user interface 394 for adding, updating, viewing and managing products or goods and services offered by merchant to server 110 module 188. Server 110 module 188 displaying user interface e.g. 1010 to logged-in merchant to enable said logged-in merchant to add, update, view and manage products or goods and services. In an embodiment logged-in merchant can send request to access transaction logs 398 to server 110 module 192, server 110 module 192 enables logged-in merchant to view transaction logs.

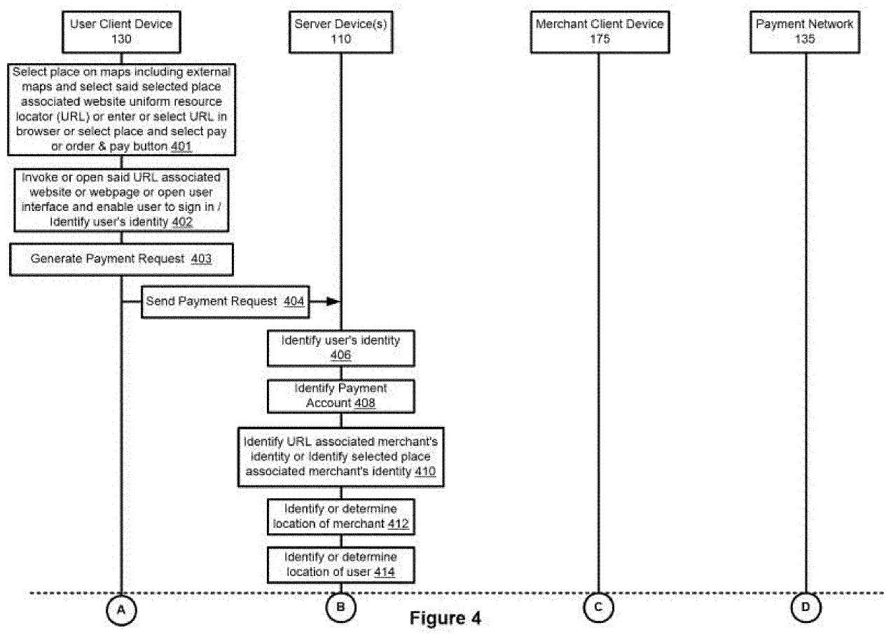

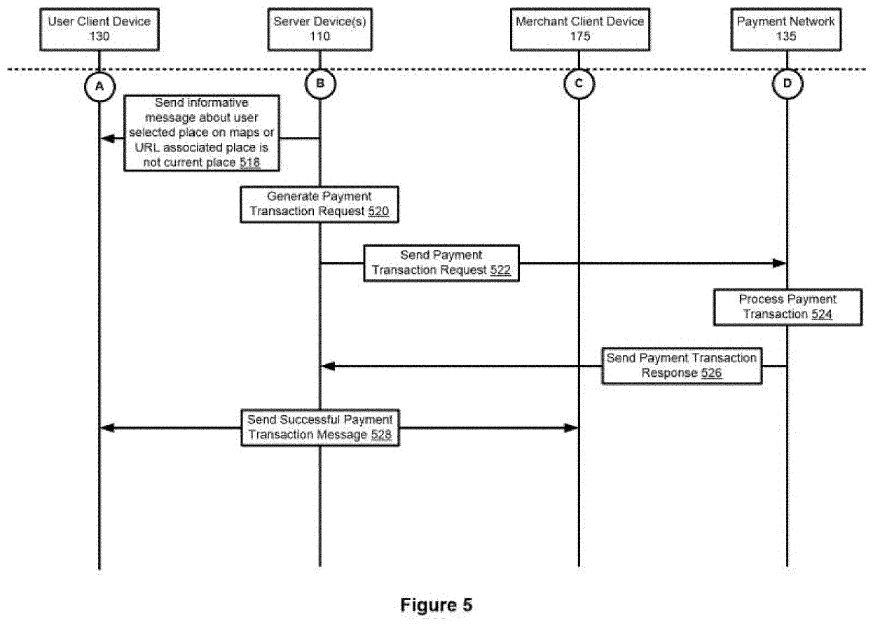

As discussed, the systems and components explained above with reference to FIG. 1 allow users (e.g., consumers) to easily, efficiently, and securely engage in in-store electronic payment transactions with merchants via a payment system 100. FIGS. 4-5 illustrate example process diagrams of one or more example embodiments of processes implemented by the payment system 100 discussed above. Consistent with payment system 100 illustrated in FIG. 1, FIGS. 4-5 illustrate (according to a sequence flow of operations) a user client device 130, a merchant client device 175, server device(s) 110, and a payment network 135.

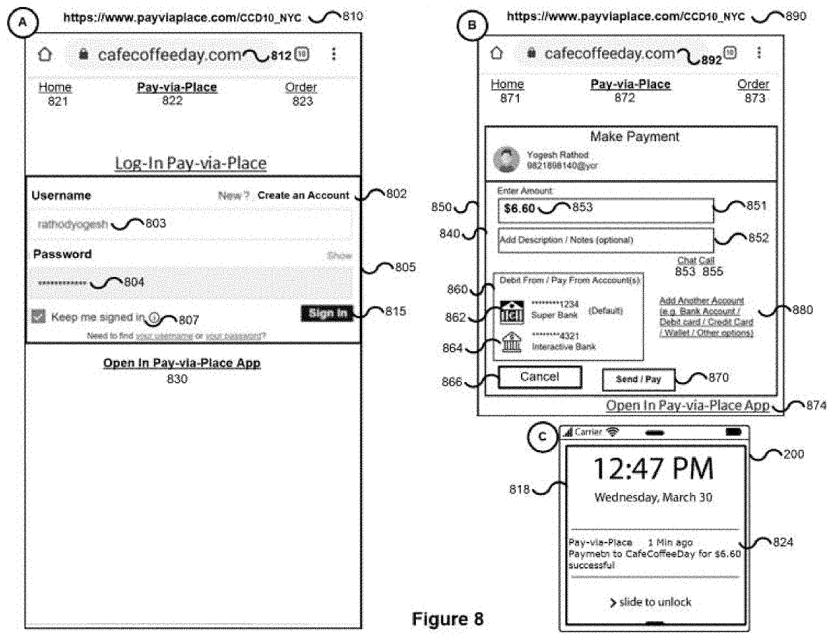

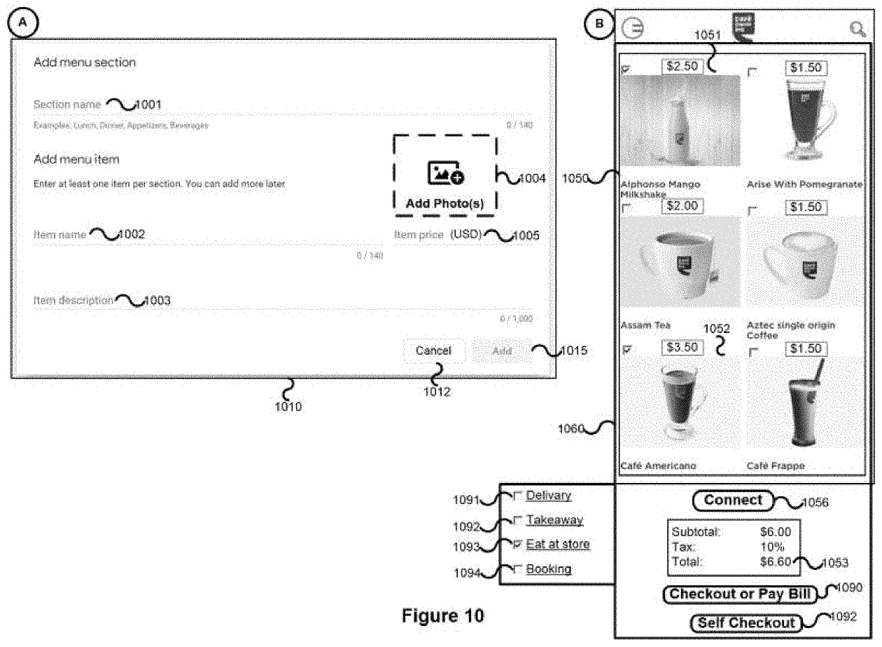

In one or more embodiments, a process 401 for a user engaging in a payment transaction with a merchant begins with the user device 175 selecting place on maps including external maps and select said selected place associated website uniform resource locator (URL) or entering or selecting uniform resource locator (URL) in browser 200. In another embodiment user can search and select place or select current place or select current location associated place or select place from nearby place or select category and select place from displayed places or select place on maps 601/602/661 and tap or click on integrated payment button or control 780 for viewing payment user interface (FIG. 8) or tap or click on integrated order and payment button or control 785 (e.g. FIG. 10 (B)).

In process 402 Invoking or opening said uniform resource locator (URL) associated website or webpage or open said clicked or tapped payment button or con 780/785 associated use interface and enable user to sign in or identify user's identity 402, wherein displaying login graphical user interface for enabling user to input user identity and password for sign in or enable user to keep user sign in or enable user to login via recognizing user's biometrics (fingerprint), recognizing user's voice, recognizing user's face, recognizing one or more types of pre-defined expressions or senses or phone screen lock pattern or PIN or password. After successful login, identifying logged-in user's unique identity and displaying payment graphical user interface comprising input box for entering amount or selection box including combo box or list box for selecting amount or display pushed amount, display user's one or more accounts including default or pre-set or selected account and display or enable make payment control including button, link, image, icon or voice command or one or more types of user senses for making or instructing to make payment of said amount from said identified logged in user's selected account to said uniform resource locator (URL) or web address or namespace associated identified merchant's account.

The user client device 130 generates 403 a payment request for initiating a payment transaction between the user and the merchant in connection with the user purchasing goods or services from the merchant (in-store or online). In particular, the user client device 104b generates a payment request that includes the user's identity, amount, payment account, and uniform resource locator (URL). In one or more embodiments, the user client device 130 generates the payment request after determining a total payment amount related to the purchase of goods or services. In another embodiment if user clicked or tapped integrated payment button or control 780 the payment request can also include payment transaction information for initiating the payment transaction, such as selected place associated merchant identifier, user's identifier, a payment account and a payment amount.

In at least some instances, the user client device 130 can generate the payment request prior to determining a total amount of the payment transaction. For example, the user client device 130 can make order or purchase by selecting products and services (in-store or online for advance order (collect or consume from/in store), delivery or takeaway) goods or services from the merchant. For instance, the user client device 130 first approaches the checkout location to being purchasing goods or services. Thus, the user client device 104b may generate an initial payment request that does not include the payment amount for the payment transaction because a total payment amount may not be available at that time. After generating the payment request, the user client device 130 sends 404 the payment request to the server device(s) 110.

In one or more embodiments, the server device(s) 110 receive the payment request from the user client device 130 and use the payment request to identify users identity 406, identify payment account 408, Identify or determine location of merchant 412 based on selected place associated selected website or webpage uniform resource locator (URL) associated merchant place of business location information including address, point on maps, geo-coordinates, location code or in another embodiment based on selected place associated merchant place of business location information including address, point on maps, geo-coordinates, location code, Identify or determine location of user 414, Identify URL associated merchant's identity 410 or in another embodiment identify merchant based on selected place on maps associated merchant identity. Specifically, the server device(s) 110 determine the location of the merchant based on merchant location information or a merchant identifier in the payment request. For example, the payment request can include location data that the user client device inserts into the payment request to indicate a physical location of the user. Alternatively, the payment request can include a merchant identifier that allows the server device(s) 110 to identify a particular merchant store (e.g., identify a specific store from a plurality of stores associated with the merchant) and a physical location of the particular merchant store.

The server device(s) 110 can use the location of the merchant to identify user that are located within a defined proximity of the location of the merchant store. In particular, the server device(s) 110 use the location of the merchant to identify users who are at or near the location of the merchant. For example, the server device(s) 110 can obtain location data from user devices of users registered with a server 110 (or other server or system that stores user accounts) by monitoring and tracking user device's current location. The server device(s) 110 use the obtained location data from client devices of users who have previously registered with the server 110. The server device(s) 110 then compare the obtained location data to the location of the merchant to determine that one or more users are at or near the location of the merchant. Alternatively, the server device(s) use device connection information from a plurality of wireless device (e.g. Bluetooth devices or wireless network devices) to accurately determine that user 110 is at or near the location of the merchant or merchant's place of business. Further server device 110 sufficiently matches identified location of merchant client device(s) 175 (300) based on monitored and track merchant client device(s) 175 (300) via merchant client application 390 with identified user client device 130 (200) via user client application 130 (200). If server 110 found user is sufficiently near or inside said place of business or entered in pre-defined geofence associated with the said place of business then server 110 sends informative notification or message to user 101 about user is currently inside or near said merchant's place of business or in the event of identification of sufficiently far from said merchant's place of business or merchant client device 175 (300) or not entered or exited from said pre-defined geofence associated with the said place of business then server 110 sends informative notification or message that user selects wrong place or place is not situated at current location of user device or select or check right place 518.

In one or more additional embodiments, the server device(s) 110 can use other narrowing factors or degrees of narrowing. For example, if location data from user client devices is unreliable for determining exact locations of users at the location of the merchant (e.g., in a merchant store), the server device(s) 110 can establish predefined geo-fences for identifying users who are approximately at the location of the merchant. To illustrate, the server device(s) 110 can establish a particular pre-set (e.g. ¼-mile) radius centered at the location of the merchant to identify users who are at or near the location of the merchant. Alternatively, the server device(s) 110 can establish geo-fences based on pre-defined geofence associated with said merchant's place of business listed on maps or zip codes, cities, counties, or any other predefined geographical region.

To initiate a payment transaction between the user and the merchant, the server device(s) 110 identifies 408 a payment account for the user. As mentioned previously, a user may have a payment account associated with a user account within a payment system 100. If the user has a single payment account associated with the user account, the server device(s) 110 identify the payment account as the payment account associated with the user account without any additional input from the user or the merchant. Alternatively, if the user has a plurality of payment accounts associated with the user account (e.g., more than one credit/debit cards and/or bank accounts and/or wallet accounts and/or crypto currencies accounts and/or offer including points, vouchers & coupons accounts and/or credit accounts including pay later, pay via installments, and pay via store's credits and/or gift cards), the user may select one of the plurality of payment accounts.

For instance, in the event that a user account is associated with a plurality of payment accounts, and a preferred payment account is not specified, the payment system identifies the payment account by requesting additional input from the user. For example, the server device(s) 110 can optionally send a plurality of payment tokens associated with payment accounts for the user to the merchant server. The payment tokens can be numerical values that do not expose payment credentials to the merchant. For example, the payment tokens can be numerical values that the payment network assigns to the user to represent the corresponding payment accounts and only allow access to the user's funds when authorized with the payment network. The payment tokens can have similar characteristics as the payment accounts so that the merchant associates the payment tokens with specific card networks or payment account issuers.

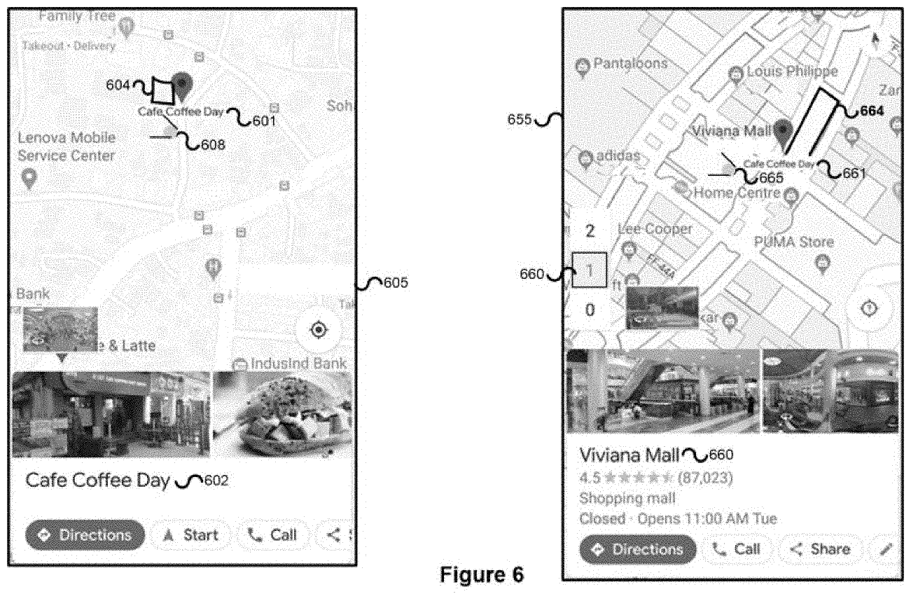

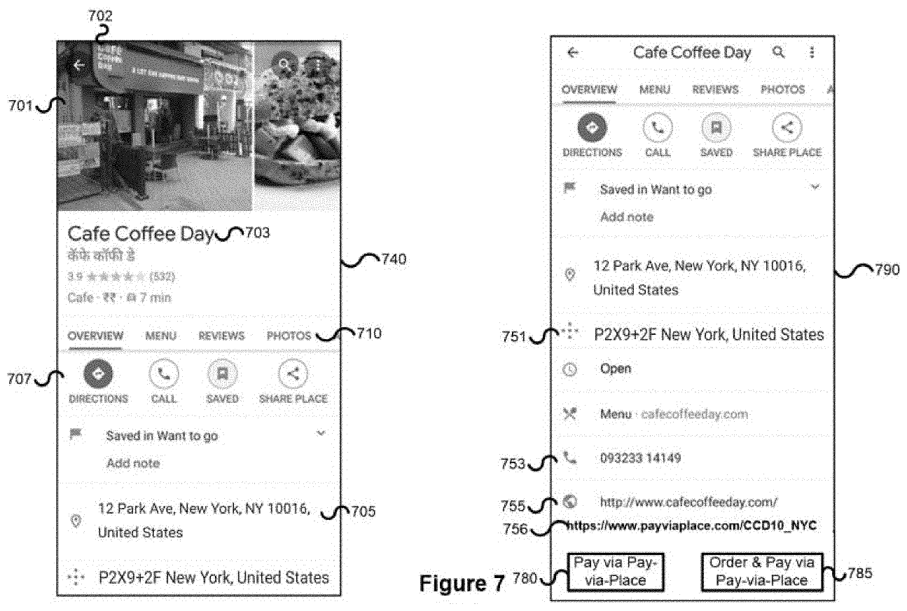

As described in more detail below, based on receiving the plurality of payment tokens, for example, the merchant server displays options in website or payment webpage to select a payment account from a plurality of payment accounts for the user. The user can select the corresponding payment account to use in the payment transaction from said merchant's associated website or payment webpage FIG. 6-7 directly from user client device 130. After selecting a payment account, the user client device 130 sends the payment token to the server device(s) 110 to use the corresponding payment account to process the payment transaction. Although the above embodiment describes using payment tokens, the payment system 100 can use other types of payment account identifiers, such as encrypted payment credentials, account names, account types, and/or other payment account information.

In one or more alternative embodiments, the server device(s) 110 identify the account after or in conjunction with receiving authorization from the user to process a payment transaction. For example, the server device(s) 110 can identify the payment account in response to the user selecting the payment account at the time of authorization. To illustrate, the server device(s) 110 sends a payment authorization notification to a mobile device associated with the user, where the payment authorization notification includes selectable options to allow the user to not only authorize the transaction, but also indicate the particular payment account to use for the transaction. For instance, the user can interact with a notification, described in more detail below, to open a digital wallet or application to select the payment account.

Once the server device(s) 110 have identified a payment account for the user, optimally the server device(s) 110 generate a payment confirmation request. Specifically, the server device(s) 110 request authorization from the user to initiate the payment transaction to prevent fraudulent payment transactions using the user's payment account. For example, the server device(s) 110 request authorization by generating the payment confirmation request to include a notification to the user that indicates payment transaction information such as the merchant and the payment amount. The server device(s) 110 then send the payment confirmation request to the user client device 130. As previously mentioned, the user client device 104b can send the payment request to the server device(s) 110 prior to obtaining a total payment amount. If the initial payment request does not include a payment amount for the payment transaction, the server device(s) 110 may wait for and/or request a payment amount and/or other payment transaction information from the user client device 130 before generating the payment confirmation request. After receiving the payment amount or other payment transaction information from the merchant client device 130, the server device(s) 110 generate the payment confirmation request and sends the payment confirmation request to the user client device 130. Alternatively, the payment confirmation request may include payment transaction information that describes the payment transaction without including the payment amount. Specifically, the payment confirmation request can include sufficient information to allow the user to identify the specific payment transaction and verify that the payment transaction is not fraudulent without providing every detail of the payment transaction up front. For example, the server device(s) 110 can send a payment confirmation request to the user client device 110 that includes a merchant identifier, a time, and a location of the payment transaction. The user can view the payment confirmation request on the user client device 104a and provide authorization to initiate the payment transaction before the checkout process is complete. Thus, the user can pre-authorize the payment transaction and then complete the checkout process to obtain the final payment amount. In one or more embodiments, the payment confirmation request is a push notification that the server device(s) 110 send to the user client device 130. For example, the payment confirmation request can be a notification that appears in a notification tray on the user client device 130. The user can interact with the notification in the notification tray to view the payment transaction information and to provide authorization for the payment transaction. Additionally, the payment confirmation request can appear on a lock screen of the user client device 110 to allow the user to interact with the payment confirmation request without unlocking the user client device or opening a specific application. The user client device 110 generates a payment confirmation response based on the user interaction (e.g., based on the user authorizing the payment transaction) and sends the payment confirmation response to the server device(s) 110.

In an embodiment based on receiving the authorization from the user client device 130, the server device(s) 110 then initiate the payment transaction between the merchant and the user. In another embodiment based on receiving the payment instruction from the user client device 130, the server device(s) 110 then initiate the payment transaction between the merchant and the user without further sending the payment confirmation request for user authorization from the user client device 130. Specifically, the server device(s) 110 initiate the payment transaction by generating 520 a payment transaction request. In one or more embodiments, the payment transaction request includes payment transaction information that allows the payment network to process the payment transaction between the user and the merchant. For example, the payment transaction request can include a merchant identifier, a user identifier, a payment account for the user, a payment receipt account for the merchant, and a payment amount.

The server device(s) 110 then send 522 the generated payment transaction request to the payment network 135. The payment network 135 processes 524 the payment transaction based on the payment transaction information in the payment transaction request. For example, the payment network 110 processes the payment transaction by transferring funds equal to the payment amount from the payment account for the user to the payment receipt account for the merchant. Transferring funds may involve communicating with one or more gateway systems, card networks or bank systems. After the payment network 110 processes the payment transaction, the payment network 135 sends 526 a payment transaction response to the server device(s) 110 indicating that the payment transaction was successful. In an embodiment alternatively, the server device(s) 110 can send payment authorization to the merchant server, with a payment token, to allow the merchant server to initiate the payment transaction with the payment network 135.

Based on receiving the payment transaction response from the payment network 110, the server device(s) 110 send 528 successful payment transaction messages to the merchant client device 175 and the user client device 130. Specifically, the successful payment transaction messages indicate to the merchant and the user that the payment transaction was successful. The merchant can then complete a checkout process for the goods or services.

Although FIGS. 4-5 illustrate a process that requests authorization from the user before initiating a payment transaction between a user and a merchant, the payment system may allow a user to authorize payment transactions asynchronously with a purchase of goods or services. In particular, one or more embodiments of the payment system allow a merchant to initiate a payment transaction with a user without receiving explicit authorization from the user at the time the user purchases goods or services. For example, the payment system directly receives instruction or authorization from user device to make payment for selected place on maps associated selected website or webpage uniform resource locator (URL) or inputted or selected website or webpage uniform resource locator (URL) in browser associated merchant.

To illustrate, a user that regularly visits a merchant store to purchase goods can provide the payment system with pre-authorization to initiate payment transactions between the user and the merchant. Providing pre-authorization to the payment system can allow the user to enter the merchant store, pick up an item, and leave without needing to go through the checkout process. For example, the payment system can authorize the payment transaction for the item based on receiving instruction directly from user device, wherein user selects place of business of said merchant on maps and select associated website or webpage to open said website or webpage and enter amount or select amount or use default or pushed amount or billed amount (based on self-scanning or adding of products to add purchased items to cart). A user client device can send payment request which includes user identity, merchant identity, amount, user payment account identity (or identify user payment account by server 110 from server connected database 115 based on said received user identity) or details and merchant account (or identify merchant account by server 110 from server connected database 115 based on said received merchant identity) to the server device(s) 110, which determine the identity of the user, identify a payment account for the user, and initiate the payment transaction based on the user's pre-authorization. Additionally, the merchant can verify the identity of the user prior to processing the transaction, for example, by selecting the user from a list of candidate users as described above.

As will be described in more detail below, the components of the payment system 100 as described with regard to FIG. 1, can provide, along and/or in combination with the other components, one or more graphical user interfaces. In particular, the components can allow a user to interact with a collection of display elements for a variety of purposes. In particular, FIGS. 6-9 and the description that follows illustrate various example embodiments of the user interfaces and features of a client application that allows a user to initiate a payment transaction with a merchant, and a user interface that allows the user to sign in, sign up, change password, enter amount, ad, select or update payment accounts, provide payment instruction by clicking or tapping payment button or uniform resource locator (URL) or link or control or provide authorization to initiate the payment transaction.

For example, FIGS. 6-9 illustrate various views of GUIs provided by a client application at a user client device to facilitate initiating a payment transaction between a user and a merchant for purchasing goods or services. For example, FIGS. 6-9 illustrate GUIs on a user client device 200 that allow a user to view and perform actions relative to a purchase for goods or services. In another embodiment additionally, views of GUIs (not shown in figure) on a user client device that allow a user (e.g., a customer) to view and authorize a payment transaction associated with a purchase for goods or services.

As stated, FIGS. 6-9 illustrate the user client device 200 a touchscreen computing device. The touchscreen computing device may be a computing device that a user holds in his or her hands or a computing device that is affixed near a checkout location for use by the merchant or the user (by enter or select URL from browser to open webpage or website of merchant and log in user account or sign in from already open website or webpage of merchant or server 110 provided payment webpage uniquely provided or associated with said merchant). FIG. 2 illustrate the user client device 200 as a handheld device. As used herein the term “handheld device” refers to a device sized and configured to be held/operated in a single hand of a user. In additional or alternative example, however, the merchant client device and/or the user client device can be any suitable computing device, such as, but not limited to, a smart phone, a smart watch, a wearable device, a tablet device, a handheld device, larger wireless devices, laptop or desktop computer, a personal-digital assistant device, and/or any other suitable computing device or smart device can perform one or more of the processes and/or operations described herein.

FIG. 6 illustrates graphical user interface 605 of maps application including 3^{rd} parties or external maps application (e.g. Google Maps, Bing Maps and like) wherein user is displayed with current location 608 of user or user device based on one or more types of location technology including GPS, Wi-Fi, Mobile Networks, Sensors, Bluetooth and use improve location accuracy techniques including Wi-Fi and Bluetooth scanning. User can view current location 608 associated place 601 or nearby places and can select place 601 on map. In an embodiment directly determining, highlighting and presenting current place 601 on map based on monitored and tracked user device's 200 current location. User need to turn “ON” location services or high accurate location service to identify user devices current location. In another embodiment in multi-stories building or mall with indoor maps 655 including 3rd parties' maps like Google Maps, user can simply zoom in and out of a building (e.g. mall 660) and go floor to floor with indoor maps and can switch floors or select particular floor 660 with a tap. User can use the level switcher in the bottom right-hand corner to move from floor to floor in the building. User can zoom in to see the indoor floor plan of a building and can also search within the building once fully zoomed in and can select automatically identified or determined current place 661 or view nearby places and select desired place 661 by viewing name, address, logo, brand, interior or exterior photos and like. User can view selected floor associated current location 665 associated place 661 or nearby places and can select place 661 on maps 655. In an embodiment directly determining, highlighting and presenting current place 661 on maps 655 based on monitored and tracked user device's 200 current location. In an embodiment user just turn on the Location and type “Nearby Places” in the search bar in the Maps including 3^{rd} parties or external maps e.g. Google Maps app. Alternatively, you can also use voice search while using Maps including 3^{rd} parties or external maps e.g. Google Maps app and say, “Nearby Places.” User need to keep the Location tracking ON to get the results. In another embodiment user can select category and find and select place from nearby category specific places. In another embodiment user can select place from one or more types of lists including saved, bookmarked, liked, rated, transacted, labeled, visited, shared, followed, want to go, starred, suggested, features, nearby, logged (history) places. User can search specific businesses (e.g. Starbucks), types of places (e.g. coffee near central park), narrow search results by using the city and state (e.g. groceries in Atlanta, Ga.), narrow search results by using a zip code (e.g. gas in 94131), find an intersection (e.g. 23rd and mission), address, city, state, country, or airport (e.g. 1600 amphitheater parkway mountain view ca, LAX, Los Angeles Airport, or Mount Everest, Nepal), latitude and longitude coordinates (e.g. 41.40338, 2.17403). User can search locally based on search query or one or more keywords e.g. search for “Italian restaurant”, displaying relevant nearby restaurant. Local results are influenced by a number of factors, primarily on relevance, distance, and prominence. These factors are combined to help find the best match for searching user's search. For example, algorithms might decide that a business that's farther away from your location is more likely to have what searching user're looking for than a business that's closer, and therefore rank it higher in local results. User can look for a place or type of places, find recent searches, or get directions. User'll find search results as red mini-pins and red dots, where mini-pins show the top results. To find more information or find inside a business, user can click or tap any result. To search for places around user more quickly, user can center the map on user's current location. User can use voice commands to search place or actively navigating maps (e.g. “Find restaurants”, “Take me to McDonald's”, “Restaurants near here”, “Pharmacies near Figueroa and 1st Street”, “Vegetarian restaurants near me”, “Book stores near UCLA”, “Gas stations near the airport”). User can select particular place on map and can tap on place name, place area, place icon or place details, place photo 601/602/661 to view associated structured and un-structured details provided by place owner, visitors or users of maps and 3rd parties, and call-to-actions.

FIG. 7 illustrates graphical user interface wherein user can view said selected place 601/602/661 on maps 605/655 associated structured and un-structured details including address 705, unique place identity or code 751, one or more types of uniform resource locator (URL) or web addresses, or tracking uniform resource locator (URL), website or webpage address or link 752/755/756, name 703, logo 702, photos & videos 710, menu or offered lists of products and services and one or more types of call-to-actions including unique phone number, unique website uniform resource locator (URL) 755 or 756, email address.

In an embodiment in the event of clicking or tapping or inputting or selecting merchant's website URL or web address 755/812, server 110 module 189 receives request to access said clicked or tapped or selected website URL or web address associated website or webpage from maps application 281 or browser application 282 of user client device 200. Server 110 module 189 invoking or opening said clicked or tapped or selected website URL or web address associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162).

In another embodiment in the event of clicking or tapping on said selected place 601/602/661 on maps 605/655 associated integrated button or control 780/785, server 110 module 189 receives request to access said clicked or tapped or selected integrated button or control 780/785 associated payment user interface or payment flow or order and payment user interface or order and payment flow (FIG. 8).

In an embodiment in the event of clicking or tapping or inputting or selecting merchant's website URL or web address 755/812, invoking or opening said clicked or tapped or selected website URL or web address associated website or webpage of merchant, wherein said invoked or opened website or webpage is integrated or embedded with pay-via-place payments webpage link or URL, so user can click or tap on said integrated or embedded link or URL 822/812 to redirect to pay-via-place payments webpage for making payment.

In an embodiment in the event of clicking or tapping or inputting or selecting pay-via-place payments webpage or website URL or web address or tracking URL 756/810 specific to particular merchant which is generated at the time of registration of merchant and assigned to registered merchant, invoking or opening said clicked or tapped or selected pay-via-place payments webpage URL or web address or tracking URL 756/810 associated pay-via-place payments webpage for enabling user to make payments.

FIG. 8 illustrates said invoked or opened website or webpage or user interface or application, wherein new unregistered user can send registration request 291 to server 110 module 181. Server 110 module 181, displaying user registration graphical user interface (GUI) to enable user to register or create new account 802 with the pay-via-place server 110. User can provide registration details for creating account including Mobile Number, Create Password and Email ID (Optional) to server 110 module 181, server 110 module 181 sends verification one-time password (OTP) to user for completing registration. Server 110 store's user registration and profile information in database 115. After registration user can send sign in request 292 to server 110 module 182, server 110 module 182 displaying graphical user interface (GUI) FIG. 8 (B) to enable user to sign in. After successful sign in, enabling user to send request to view or add or update payment methods 293 to server 110 module 183, server 110 module 183 displaying graphical user interface (GUI) 860 to enable user to view and added payment methods and enable user to add one or more types of payment methods 880 including add, update and verify one or more debit cards, credit cards, wallets, and bank accounts including provide bank account code and account number. In an embodiment server 110 module 183 stores said added payment methods details in PCI complaint or secure database through PCI compliant server 110 or one or more 3^{rd} parties hosted PCI compliance or secure data vault service provider's databases via their server(s) (e.g. Spreedly). In an embodiment server 110 module 181 generates one or more types of code and unique identity and unique URL or link including QR code, virtual private address (VPA) for enabling making or sending and receiving payments including making payments in-store or particular selected place or place of business or store from user's account to said location associated place associated merchant's account.

Registered user can enter user name or user identity 803, password 804 and select keep user signed in option 807 to quickly one tap or ne click login and click or tap on “Sign In” button or control 815.

In an embodiment user can download and install user application and register by providing registration details for creating account including Mobile Number, Create Password and Email ID (Optional) to server 110 module 181, server 110 module 181 sends verification one-time password (OTP) to user for completing registration. Registered user can add, update and verify one or more types of payment methods 880.

In an embodiment based on said clicked or tapped or entered uniform resource locator (URL) or web address 755/756/810 or integrated button or control 780/785 identify place associated details including merchant identity, place identity and if user logged-in then user identity and in the event of click or tap on uniform resource locator (URL) or web address or link or button or control 830/874, open application (logged in or enable user to login) and enable user to make payment from identified logged-in user's pre-set or default or selected account to said identified merchant's account and in an embodiment automatically connect user client application 290 to merchant client application 390 or in another embodiment enable user to send request to connect from user client application 290 to merchant client application 390 and based on settings set by merchant via merchant client application 390 automatically connect user client application 290 with merchant client application 390 or enable authorized user of merchant client application 390 to accept request to connect with user client application 290 or reject or ignore or cancel request. In another embodiment opening of uniform resource locator (URL) or web address or link 755/756/810 associated website 805 or clicking or tapping on integrated button or control 780/785 or in the event of click or tap on uniform resource locator (URL) or web address or link or button or control 830/874, automatically open user client application 290 and pass said clicked or tapped or entered uniform resource locator (URL) or web address 755/756/810 or pass said clicked or tapped integrated button or control 780/785 associated identified place details including merchant identity, place identity and if user logged-in then user identity and enabling user to make payment from identified logged-in user's pre-set or default or selected account to said identified merchant's account.

In an embodiment user can log-in and can send request to add, update and a mange user's detail profile 294 to server 110 module 184, server 110 module 184 displaying graphical user interface (GUI) and enables said logged-in user to view and updates detail profile.

In an embodiment store secure payment data including customers' credit card, debit card, and other payment methods in PCI compliance database via PCI compliance server or store user's secure payment data in a 3rd parties' cloud-based vault service for connect with virtually any payment gateway, partner merchant, or service in any countries and currencies. e.g. Spreedly's platform which lets enables to capture, store, and tokenize online payment details and said vault may also portable, so easily move said secure payment data of users between multiple gateways and services as needed. Server 110 can securely tokenized payment details in a flexible, portable vault. That gives the power to transact with any payment service via a single API. With the vault service, pay-via-place can cut PCI scope and reduce the possibility of a costly security assessment and can capture card data via a flexible iFrame for infinitely customizable and flexible approach to card capture—all while keeping card data off of pay-via-place servers 110 or capture card data via a simple drop-in form for a quick launch. With the “universal token”, server 110 can secure payment details in card vault. Then, whenever server 110 ready to transact, server 110 can use tokens to transact with any payment service via a single API. All while minimizing your PCI scope.

In an embodiment after entering or providing user name 803 and password 804 or based on selected option keep user signed in 807 and clicking or tapping on “Sing-In” 815 button or control 815, redirecting or invoking or opening pay-via-place payment webpage 850 and displaying pay-via-place payment user interface 840 of pay-via-place unique webpage 850 of registered merchant or redirecting or invoking or opening integrated payment user interface 840 of pay-via-place within webpage or interface 850 of merchant's website 850. After opening or said webpage 850, user can enter or select amount 853 in inbox or textbox 851 or use or edit default amount or pushed amount 853. User can add and edit notes, transaction details or description in textbox 852. In an embodiment user can make call 855 or converse via chat 853 to said selected place of business or associated website associated authorized staff or admin. User can view, add, edit, remove one or more types of payments methods 860/880 and associated details including bank account details including bank code and account number as per country, debit cards, credit cards, wallets, virtual cards, redeemable points and one or more types of payments. User can scan one or more types of cards including debit cards, credit cards to add details of said scanned debit cards, credit cards. User can select payment method from list of added payment methods added by user or pre-set selected payment as default payment method from list of added payment methods added by user or use pre-set or default payments method and account (e.g. Bank account 862) for making payments. After entering amount 853 or selecting payment method and mode 862/864 or use default 862 or pushed amount 853 and default method and account 862, user can send payment request 296 directly from user client device 200 to server 110 module 190 by tapping or clicking on send/pay control or button 870 for making payments of said amount 853 from said pre-set or selected user's account 862 to said selected place associated merchant's account or said user selected place associated clicked or tapped website or website URL associated merchant's account. Server module 190 receives said payment request including user identity, uniform resource locator (URL), selected user account, amount and identifies merchant identity and associated merchant's bank account or debit card details based on uniform resource locator (URL), identifies details of selected user account, identifies user payment account details from server 110 PCI complaint or secure database 115 or 3^{rd} parties PIC complaint database or vault service and submit said request to payment network 135 which processes payment or to payment gateways own by or connected with server 110 or integrated 3^{rd} parties payment gateways or payment service providers (via their APIs) for processing said payments. In an embodiment user can cancel making of payment by clicking or tapping on cancel control or cancel button 866. After successful of said payment transaction, sever module 191 sends said payment confirmation notification 824 to user client device 200 on user interface 298/818 and sends said payment confirmation notification 824 to merchant client device 300 on merchant's user interface 396/818 to enable them to view notification. After successful of said payment transaction, sever module 192 stores or logs said payment transaction details to sever 110 PCI complaint or secure database 115 or 3^{rd} party's database(s) and enable related registered and logged-in user and merchant to access their logs.

In an embodiment user can split a payment among friends by making decided amount (equal share or mutually agreed) of payments from each user devices. Each user enter user imputed or created PIN, so merchant can easily view and identify same PIN associated payments from said different users entered same or different amount from different selected payment accounts or methods but related to same bill or invoice or payment.

In an embodiment split a payment between more than one payment method and make payment. User can select the first payment method (e.g., Account) and select the second payment method (e.g., Credit Card) and adjust the price in both fields. User can use multiple credit cards for large purchases or for applying account credit to part of a sale. User can split purchases between a credit card and a non-credit card or a non-direct debit payment method.

In an embodiment coupons or gift card or voucher or points are used to discount the full a new amount of payment—which is later paid in full by a single payment method in a single transaction. A coupon is implemented before the payment process.

The payment gateway is a server-side piece of middleware that facilitates communication between a merchant and a credit card association such as Visa or MasterCard. Generally speaking, when an on-line purchase is made, a payment transaction needs to be passed to the card issuer to be processed. Payment gateway is the piece of software that makes this transmission process possible. Any merchant sending transactions to payment gateway can reach different processing end-points (processors, card issuers or banks) in a unified, seamless way. Online payment gateway, credit card payment gateway, ecommerce payment gateway, internet payment gateway—these terms are commonly used in the payment processing industry to describe system involved in processing of electronic payments. Online payment gateway (or internet payment gateway) is a payment gateway that is available through on-line access, usually over HTTPs protocol. In an embodiment pay-via-place payment gateway is a web-based solution and it is an online payment gateway. Credit card payment gateway is a payment gateway that processes credit cards. An alternative to the credit card payment gateway can be ACH/EFT payment gateway, which would deal with bank transfers as opposed to credit card transactions. Payment gateway can handle both credit (and debit) card transactions as well as ACH/EFT transfers in a unified way. Generally, a payment service is a combination of a payment gateway and a merchant services offering. In order to process a transaction (to charge a card), a merchant needs a merchant account (through which payments are processed and deposits are executed) and a payment gateway (to submit transactions for processing). Payment service companies will normally provide a way for a merchant to get a merchant account, and will also supply a hosted payment gateway that a merchant could use to process transactions.

Payment aggregation is a concept used to process payments (credit card and ACH) belonging to different unrelated merchants under a single merchant account. In the sub-merchant funding, the transactions from unrelated merchants are still processed together, but unlike aggregation, sub-merchant funding requires each participant of the aggregation process to have its own merchant account. To simplify underwriting, however, the merchants are not set up as individual entities, but rather as sub-merchants of a larger payment facilitator, who is legally and financially responsible for all of the sub-accounts. A small-size merchant might not even have a MID. In this case merchant funding will be performed by a payment aggregator—a business, which has a lot of small sub-merchants in its portfolio and uses a single merchant ID for all of them. Another important type of an intermediary entity is a payment service provider or PSP. A PSP does not fund the merchants. Funding of sub-merchants of a PSP is, generally, done by the acquirer. Payment service providers help merchants get their merchant accounts, facilitate merchant underwriting and transaction processing.

Sub-merchant is a term used to describe merchants that process under a payment service provider (PSP) or payment facilitator (PF), also known as a merchant aggregator or third-party payments provider. These services use one merchant account to process the transactions of many sub-merchants, thereby eliminating the need for each sub-merchant to open and maintain a full-fledged merchant account.

Payment gateway performs the important role in processing and authorizing the payment or transactions between customer and merchants. Payment gateways encrypt sensitive information and details of payment such as credit cards number. It is to guarantee that the information is passed securely between customer and merchant. Here are the basic steps on how it works:

Step 1: A customer will enter or select amount or use default or pushed amount and tap on pay button to send payment instruction or place an order on the selected place on maps associated merchants' website that they visit by submitting the order, checkout from the cart or any equivalent button. Step 2: Merchant securely transfers order information to the payment gateway. Customer will pay with their preferred payment method. The transaction is then routed to the issuing bank or the 3D secure page to request transaction authentication. Step 3: After the authentication process is successful, the transaction is then authorized or declined (depending on funds available in the customer's account) by the issuing bank or card (VISA, MASTER, MAESTRO, American Express). Step 4: Payment gateway sends a message to the merchant accordingly. Step 5: The bank settles the money with the payment gateway and then the payment gateway settles the money to the merchant. When using payment gateways, there are three important things that they do when customer wants to make payment or make purchase from the selected place on maps associated merchants' website. It is either by using credit card, debit card, online banking, cash etc. The three important things are including authorization, settlement and reporting.

A payment gateway ensures the security of the information user put in. Here is a list of things that a PG does to keep your data safe: First things first, the entire transaction is carried out through an HTTPS web address. This is different from the HTTP as the S in the HTTPS stands for Secure. The transaction takes place through this same tunnel. As a result of the hash function, the system often uses a signed request from the merchant to validate the request of the transaction. This signed request is a secret word, which only the merchant and the payment gateway know. To secure the payment page result of the process, the IP of the requesting server is verified to detect any malicious activity. Virtual Payer Authentication (VPA) is something that the acquirers, issuers and the payment gateways are backing to secure the process even more. VPA, implemented under the 3-D secure protocol, adds an additional layer of security and helps the online buyers and sellers to authenticate each other easily. The PCI compliance makes it secure enough to allow the user to store their personal data in the portal or gateway for recurring payments.

In an embodiment for small to mid-size business that doesn't process transactions in the millions, then an aggregator merchant account will offer the efficiency, convenience, and savings. An aggregator account gives access to almost all of the services expect from a merchant account. Except, seller's merchant account nests under a payments provider's master merchant account. This means that the payment provider Pay-via-Place, is the main merchant and listed business or registered merchant is as a sub-merchant.

In an embodiment PlacePe may also act as a payment facilitator typically has a contract with the acquiring bank and onboards merchants on a sub-merchant platform. For the uninitiated, a sub-merchant platform involves a payment facilitator who already has a master MID account with the acquiring bank. So if registered merchant wanted to start offering merchant services, they could sign up as a sub-merchant under a PlacePe's (PayFac's) master account and have your own MID set up in no time.

In an embodiment 3rd parties applications, websites, platforms, marketplace can integrate pay-via-place via APIS and SDKs.

Becoming a payment facilitator (payfac) requires building multiple systems for payment processing, sub-merchant onboarding, compliance, risk management, payouts, and more. Payfacs also have ongoing requirements to maintain their good standing and credit requirements with acquiring banks and card networks. The Electronic Transactions Association (an advisory organization with members from banks, card networks, and payment processors, also referred to as ETA) strongly recommends engaging industry experts and legal counsel to ensure adherence to laws and guidance that span card networks, acquiring banks, state and federal governments, and global regulatory organizations (e.g., OFAC).

Set up payment systems requires finding an acquiring bank and establishing a partnership and get sponsored to facilitate payments for sub-merchants, integrating payment gateways provide functionality for sub-merchants to process online payments, obtain Level 1 PCI DSS certification to ensure the security of sensitive data, the payfac is required to be Payment Card Industry Data Security Standard (known as PCI DSS) certified, which may also include Europay, Mastercard, and Visa (EMV or chip) certification if the payfac supports in-person transactions and build merchant management, this includes merchant dashboards, payout systems, and dispute management systems to handle chargebacks.

To become PayFac, PayFac require to set up merchant onboarding and compliance systems including verify identities of sub-merchants, including KYC, ownership structure, and business details, check OFAC and MATCH lists for sub-merchants before onboarding (Mastercard manages the Member Alert to Control High-Risk Merchants (MATCH) list), assess sub-merchant's financial health and risk, including fraud, credit, financial, compliance, regulatory, or reputational risk, register as a payfac with each card network, apply for money transmitter licenses (MTLs) in each state the payfac operates in, if required to support certain fund flows, apply for regional licenses if required, manage ongoing processes and systems including onboard and underwrite each sub-merchant (verify the identity, business model, and owner information for each sub-merchant and set up payment processing for sub-merchants), monitor risk and update risk systems (perform due diligence, monitor sub-merchant activity on an ongoing basis, and mitigate risk as needed (e.g., apply processing caps, delayed funding, or reserves)), prevent and block fraud (proactively prevent fraud on the platform and block or review suspicious transactions), pay out funds to sub-merchants to ensure sub-merchants are paid their earnings on time, reporting and reconciliation, maintain PCI DSS compliance, renew payfac registration and licenses. If the platform needs to operate internationally and support sub-merchants in other regions, partnerships with local acquirers, gateways, and other service providers may be necessary. In general, platforms build local systems from scratch in order to adapt to local requirements or support multiple regions. In an embodiment Pay-via-Place Marketplaces or platforms that aggregate a set of sub-merchants, generally serve as the merchant of record, and control the flow of funds and payouts to sub-merchants.

Payfacs open a merchant bank account and receive a merchant ID (MID) to acquire and aggregate payments for a group of smaller merchants, typically called sub-merchants. Payfacs have embedded payment systems and register their master MID with an acquiring bank. Sub-merchants, on the other hand, are not required to register their unique MIDs—instead, transactions are aggregated under the payfac's master MID. This is meant to reduce the complexity that sub-merchants would face setting up online payments on their own by eliminating the need for them to establish and maintain relationships with an acquiring bank, payment gateway, and other service providers. Marketplace payments aren't considered traditional e-commerce. In traditional e-commerce there is one seller with a product or service to sell to many buyers. However, with marketplace payments, there are three parties involved. With marketplaces, a marketplace owner allows sellers with a product or service to sell to many buyers.

The best example of a marketplace is the Apple App Store. Apple is the marketplace owner and allows app developers to sell apps to their users. In return, Apple receives a 30% commission on each sale.

PlacePe may use 3rd party's payment APIs e.g. Stripe connect for marketplace payments. Stripe Connect works by allowing other Stripe accounts to connect to Stripe marketplace account (PlacePe). Once a partner's Stripe account is connected, the API can process payments from buyers and automatically transfer proceeds to sellers. The seller becomes the merchant of record and the marketplace owner is able to set an application fee on each transaction. This fee is registered as a payment from the seller to the marketplace owner and is, in essence, the commission fee from the sale.

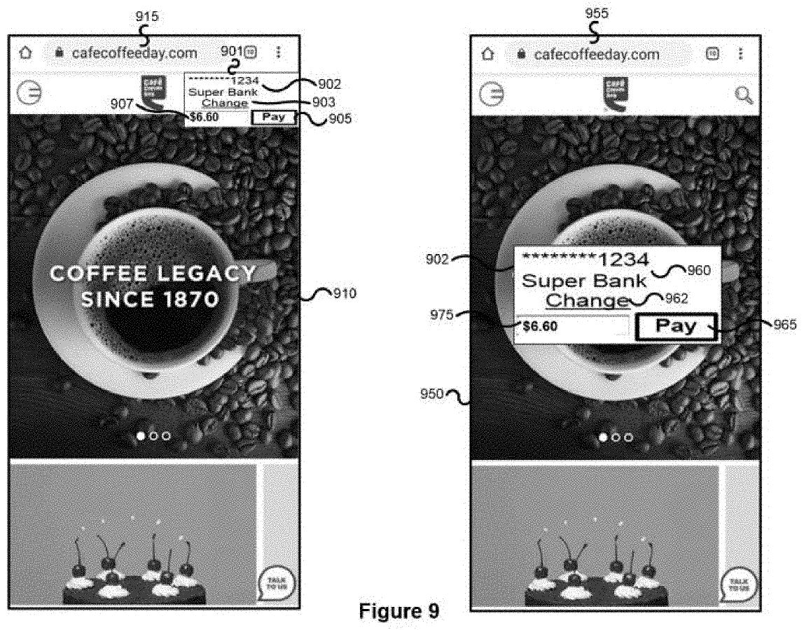

FIG. 9 illustrates example graphical user interface of website or webpage which shows integrated or embedded payment user interface(s) or user interface(s) flows within merchant's website or webpage via APIs/SDKs provided by server 110. User can view default or pre-account 902/960, which user can change via clicking on change control or button or link 903/962, wherein user can select or make default another account from list added accounts. User can add new accounts or update existing accounts. User can enter or select amount or use default or pushed amount 907/995 for making payment and then tap or click on payment button or link or control 905/965. So user can access, browse, view merchant's website or webpage 910/950 as well as integrated webpage or payment or order and payment user interfaces or user interface flow 901/902 provided by server 110 or platform 100 and integrate via application programming interface (APIs) and software development kit (SDKs) provided by server 110 (API sever 162).

With reference to FIG. 10, the merchant client device 175/300 includes a client application 390 (394) that allows a merchant 102 to view, add, remove, update and manage list of products and services associated details 1010, wherein details may comprises section name 1001, item name 1002, item description 1003, one or more photos or videos or images 1004, item price 1005. In an embodiment merchant can save and store said items details in merchant's website server database, 3rd parties cloud storage or server 110 database 115. In an embodiment allow a merchant to import or import in standardized format or synchronize including push, pull, snapshot, merge synchronization and link said details from linked inventory management system and inventory database.

With reference to FIG. 10, the user client device 130/200 includes a client application 290 that allows a user 101 to view and interact with information related to with payment transaction information and purchase order information for use in view a list of goods for a purchase order by a user. Specifically, the client application 290 includes a purchase order interface 296 (1060) that displays information corresponding to the purchase order and a payment transaction associated with the purchase order. For example, the purchase order interface 1060 can include an item list 1051/1052 that shows the items that the user has scanned or added to the purchase order.

Additionally, the purchase order interface 1060 can indicate the payment amounts associated with each item in the item list 1051/1052. The purchase order interface 1060 also includes a total payment amount 1053 (based on a subtotal of the cost of all items and tax, etc.) associated with the item list. The total payment amount 1053 can change as the number and type of items in the item list 1050 change. For example, if the user adds items to or removes items from the item list, the total payment amount 1053 changes accordingly.

In one or more embodiments, the purchase order interface 1060 includes a checkout element 1090 that allows the user to initiate a checkout process for a purchase order. Specifically, the checkout process can begin a process to initiate a payment transaction for the purchase order. For example, if the user selects the checkout element 1090, the client application can generate a payment request with the payment transaction information. Alternatively, as previously mentioned, the user client device 300 can generate an initial payment request prior to obtaining a total payment amount for the purchase order.

The server device(s) then determine the identity of the user. Specifically, the server device(s) can determine the identity of the user based only sign in information (803/804). Based on the identity of the user, the server device(s) identify a payment account for the user for use in processing the payment transaction between the user and the merchant. For example, the server device(s) can access the user account for the user and identify the payment account based on an association of the payment account with the user account. To illustrate, the user can authorize the payment system to use one or more payment accounts for payment transactions between the user and other users and/or merchants. The user account can store any number and types of compatible payment accounts that the user authorizes for use in payment transactions.

In one or more embodiments, the payment system uses a payment account for the payment transaction based on input from the user client device 200. In particular, the server device(s) select a plurality of payment accounts from the user account for the user. The server device(s) can send payment tokens representing the selected payment accounts to the server device(s), as previously mentioned. Alternatively, the server device(s) can send simple identifiers for the payment accounts (e.g., account name or nickname, account type, card issuer) to the merchant server.

The client application displays the payment accounts available for the user based on the received payment tokens or identifiers that represent the payment accounts. As FIG. 8 (860) illustrates, the user client device 200 displays the payment accounts for the user in the purchase order interface 873 (1060). The purchase order interface 1060 includes the payment accounts for the user in a list or grouping.

In one or more embodiments, the purchase order interface 1060 display selectable elements for the payment accounts in the list 860 of payment accounts so that the user can select one of the payment accounts to use for the payment transaction. The user can select one of the payment accounts to use for the payment transaction by tapping on the corresponding element via the touchscreen interface, though the user client device 200 may accept any suitable input. Selecting a payment account from the list 860 causes the user client device 200 to send an indication of the selection to the server device(s). For example, the user client device 200 can send the payment token or other identifier associated with the selected payment account to the server device(s).

In an embodiment when the server device(s) receive the selection of the payment account or otherwise identify the payment account, they server devices(s) request authorization for the payment transaction. In particular, the server device(s) send a notification to a user client device associated with the user with a request to authorize the payment transaction with the merchant. In an embodiment in which the payment system requires the user to provide authorization prior to initiating payment transactions between the merchant and the user, other embodiments may not require further authorization from the user. User can just tap or click on checkout or payment button or control or link or URL to make payment 1090 as described in detail in FIG. 8.

The user client device 200 can include a client application 290 (297) allows the user client device 200 to communicate with the server device(s) 110 and/or other devices or systems associated with the payment system. For example, the client application can be a platform application that communicates with a platform system at the server device(s) to send and receive information associated with the user and other users, applications, services, 3^{rd} parties service providers and their services registered with the platform system. The client application can also allow the user client device 200 to send and receive payment information associated with payment transactions involving the user.

In at least some embodiments, the server device(s) 110 identify a user client device 130/200 associated with the user 110 based on the user account. Specifically, the server device(s) identify a user client device 130/200 that by which the user has communicated with the server device(s) 110 using the client application 290. For example, the server device(s) 110 can identify the user client device 130/200 based on the user installing the client application 290 onto the user client device 200 and logging (FIG. 8 (A)/392) into a service associated with the client application (FIG. 8 (B) & 10/290).

In one or more embodiments, after the server device(s) 110 determine an identity of a user 101 associated with a payment transaction and a payment account for the payment transaction, the server device(s) 110 can communicate with the user client device 200 using the client application 290. For example, the client application 290 (297) can receive a payment confirmation request including a push notification (not shown in figure) from the server device(s) 110 indicating the payment transaction between the merchant and the user. The push notification can appear in a notification tray and/or in a notification area of a lock screen of the user client device 200. The notification includes the details of the payment transaction so that the user can identify the payment transaction and verify that the transaction is valid and not fraudulent. For example, the notification can include the merchant, the payment amount, the time/date, identification of the client application, and or other information that allows the user to verify the payment transaction.

In an embodiment additionally, the notification can include a request for the user to authorize the payment transaction. The notification can include a plurality of elements that allow the user to interact with the notification to respond to the request without unlocking the phone and without opening the client application 297. In particular, the notification includes a yes control and a no control that allow the user to choose to authorize the payment transaction or deny authorization of the payment transaction. Selecting the yes control to authorize the payment transaction causes the user client device 200 to send authorization to the server device(s). Alternatively, the user can interact with the notification by performing a swipe right or swipe left action to authorize or reject the payment transaction. In another alternative example, the user can select different payment options. The server device(s) then contact the payment network to process the payment transaction and transfer funds from the payment account for the user to a payment receipt account for the merchant.

As previously mentioned, if the payment system has not already identified a payment account for using with the payment transaction, the user can select the payment account by interacting with the notification. For example, the user can tap or swipe the notification to open a separate application (e.g., a payment application 297) to select a payment account. The user can select a payment account to use in the payment transaction and provide authorization for the payment transaction.

In response to a successful payment transaction, the user client device 200 receives a response from the server client device(s) indicating that the payment transaction was successful. Specifically, the client application can receive a second push notification that appears on the lock screen of the user client device 200. The second push notification can be a successful payment transaction message that indicates that the payment transaction with the merchant and for the payment amount was successful. FIG. 8 (C) illustrates the push notification 824 appearing on a lock screen 818 of the user client device 200 indicating that the payment transaction was successful. Thus, the user can verify that the payment transaction was successful by looking at the notification 824 on the lock screen 818 or in the notification area of the operating system of the user client device 200.

Sending and displaying a successful payment transaction message 824 in the client application of the merchant client device 300 in response to the payment network successfully processing the payment transaction. After the merchant verifies that the payment transaction was successful, the merchant can provide the user with the items in the purchase order interface 1060 to finish the purchase order or merchant come to know that user paid for the consumption of products (e.g. food) or services (e.g. games).

In an embodiment user can search and select or select place from list including bookmarked or liked or transacted or visited or select place 601/602/661 on maps 605/660 or list or list item 602 related to searched or nearby or displayed places linked with maps 605/660 and can select or tap or click said selected place associated or displayed website or webpage uniform resource locator (URL) 755 or 756 or can select or tap or click on order and payment button or control 785 and can view order webpage or user interface 1060 and can select one or more products 1051/1052 and can select delivery option and make payment 1090 of total billed amount 1053 and instruct to deliver said product at user provided or selected shipping or delivery address or select option to collect from store or collection center as per schedule date and time and address provided by said selected place associated seller or merchant or make payment after collecting of said ordered products and services from store or collection center as per schedule date and time and address provided by said selected place associated seller or merchant.

In another embodiment in the event of selecting of current location associated place on maps or search nearby places or search category specific nearby places and select place or select current place 601/602/661 on maps 605/660 and selecting or tapping or clicking said selected place associated or displayed website or webpage uniform resource locator (URL) 755 or 756 or selecting or tapping or clicking on order and payment button or control 785 by user 101 from client device 130 (200), invoking or opening or displaying order webpage or user interface 1060 and in an embodiment automatically connect said user 101 user client application 290 of user client device 130 (200) with said place associated merchant application 390 of merchant client device 175 (300) based on sufficiently matching location of said user's monitored and tracked user client device 130 (200) with said selected place 601/602/661 on maps 605/655 associated identified location or selected place 601/602/661 on maps 605/655 associated URL associated location, wherein location of place of business comprises geo-coordinates, pointer on map, address, geocodes and pre-defined geofence on maps associated with said selected place on map associated identified merchant. So automatically connect user application 290 with merchant application 390 only when user 101 or user client device 130 (200) enters and dwell into said selected place on map associated merchant's offline store or location of place of business of said selected place on map associated merchant. In the event of exiting from location or geofence of said selected place on map associated place or place of business (e.g. store, shop, hotel, patrol pump, parking, toll, and like), automatically disconnect said user client application 290 from said merchant client application 390. In other embodiment user 101 can select connect button or control 1056 from displayed selected place associated user interface 1060 of user client device 130 (200) to send request to connect said selected place associated identified merchant client application 390 to server device(s) 100 module 193. Server device(s) 100 module 193, send said request to merchant client application 399 (390) on merchant client device 175 (300). In an embodiment based on settings provided by merchant 102 though merchant client application 390, automatically connect received request to connect from user client application 290 of user client device 130 (200). In another embodiment merchant can view received request or view received request with associated purpose to connect, requirement, task, required action detail and accept or reject request by selecting accept or reject button or ignore request or schedule connection. In another embodiment in the event of selecting of place 601/602/661 on maps 605/655 and selecting associated webpage or website uniform resource locator (URL) 755 or 756 or selecting place 601/602/661 on maps 605/655 and select order and payment button or control 785 and ordering of selected products or services 1051/1052 from user interface 1060 of user client application 290 of user client device 130 (200) then automatically connect said user or customer 101 with said selected place associated identified merchant 101 client application 390. In an embodiment after fulfillment of delivery or manually receiving of instruction from user or merchant to disconnect or exiting from pre-defined geofence of said place of business, automatically disconnect user from said connected merchant.

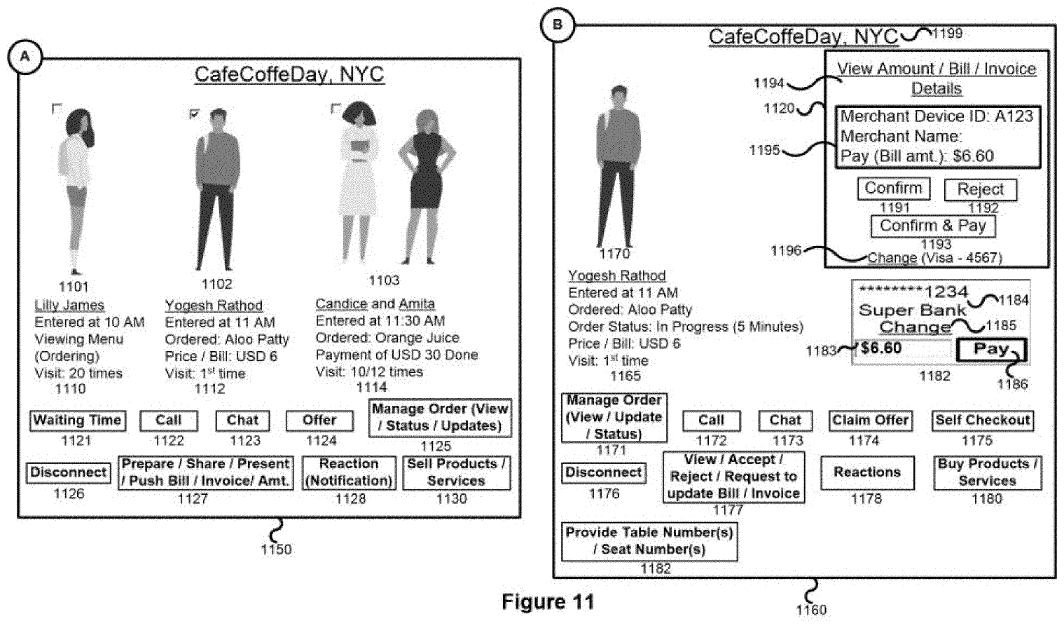

FIG. 11 illustrates a system and method for completing a transaction in a retail environment, wherein the system 100 comprises a merchant client application 390 of merchant client device 175 (300), a user client application 290 of a user client device 130 (200) and an authentication server 135 connected with or linked with or integrated with server device(s) 110. The merchant client application 390 of the merchant client device 175 at a merchant location associated with selected place on maps or automatically identified or determined current place or geofence (based on sufficiently matching monitored and tracked user client device 130 (200) with location or geofence associated with the merchant from server 110 database 115) 601/661 generates a payload for a transaction, wherein the payload for the transaction comprises encrypted payment information. The merchant client application of the merchant client device establishing connection with the user client application of the user client device or allowing to connect merchant client application of merchant client device with user client application of user client device by authorized user(s) of merchant client application of merchant client device or allowing to connect user client application of user client device with merchant client application of merchant client device by user client application of user client device may base on sufficiently matching location of said monitored and tracked user client device 130 (200) with said user selected place associated identified location or selected place on maps associated URL associated identified location, wherein location of place of business comprises geo-coordinates, pointer on map, address, geocodes and pre-defined geofence on maps associated with said selected place on map associated identified merchant or said selected place on map associated selected website or webpage uniform resource locator (URL) associated identified merchant. In another embodiment in the event of selecting place 601/661 on maps 605/655 or in the event of selecting place 601/661 on maps 605/655 and selecting said selected place 601/661 associated website uniform resource locator (URL) 755/756 and selecting connect button or control 1056 from said website or webpage URL associated opened or displayed website or webpage 1060, establishing a connection with the merchant client application 390 of merchant client device 175 (300), by a user client application 290 of a user client device 130 (200) or sending connection request from the merchant client application 390 of the merchant client device 175 (300) to the user client application 290 of the user client device 130 (200) or sending connection request from user client application 290 of the user client device 130 (200) to the merchant client application 390 of the merchant client device 175 (300) and in the event of accepting connection request by the user 101 of the user client application 290 or the authorized user 102 of the merchant client application 390.

Upon generating the payload for the transaction, the merchant client application 390 of the merchant client device 175 (300) establishes connection with the user client application 290 of the user client device 130 (200) and share or send or present said the payload or details 1194/1195 for the transaction or share or send or present said the payload or details 1194/1195 for the transaction to already connected or selected user 101 of user interface 1120 (1160) user client application 290 of the user client device 130 (200).

In a preferred embodiment of the present disclosure, the connection is established by the user client device. In some implementations, the connection may be established by the merchant client application of the merchant client device with the user client application of the user device. Upon successful connection, the user device fetches the payload for the transaction from the merchant client device and communicates the same to the authentication server 135. The authentication server 135 on the other hand, decrypts the payload for the transaction, authenticates the payload for the transaction (decrypted data) and communicates a result to the user client device thereby enabling the user client device to complete the transaction through any one of a payment mode such as but not limited to a payment wallet, credit card, debit card, cash card, online transfer, unified payments interface (UPI), and the like. In a preferred embodiment of the present disclosure, the user client device is configured to communicate a status of the transaction to the merchant client device and the merchant client device indicates the status of the transaction by means of one or more format.

FIG. 1 illustrates an exemplary representation of a system for completing a transaction in accordance with an embodiment of the present disclosure. As shown, the system 100 comprises a merchant client device 175, a user client device 130 and an authentication server 115, wherein the user device 110 and the payment network or the authentication server 135 are communicatively connected through a communication network 125. Further, the merchant client device 175 does not require internet connection or any data communication network to complete the transaction and hence operates as an independent device at the merchant location. In one embodiment of the present disclosure, the merchant client device 175 is assigned a unique ID (hereafter referred to as merchant client device ID) which uniquely identifies the merchant client device 105 among plurality of merchant client devices. Further, the merchant client device ID is associated with the merchant information such as but not limited to merchant name, merchant address and contact details, location of the merchant client device (pre-configured geofence or region within which the merchant client device is operational), type of business, information pertaining to financial entity associated with the merchant, etc. The merchant client device ID and associated merchant information is recorded in the authentication server 135.

In one embodiment of the present disclosure, the merchant client device is an internet enabled device and comprises a custom button (“Pay or Prepare or Push Bill or request billed amount” button) 1127, a custom transaction controller. During operation i.e., during a transaction, when the merchant calculates an amount owed by the customer and selects or click or taps the button 1127, the merchant client device generates a payload for the transaction. Further, the merchant client application 390 of the merchant client device 175 establishing connection or connected with the user client application 290 of the user client device 130 as discussed above.

The user client device 130 may be one of a smartphone, a laptop, a tablet, a wearable device including smart watch, a personal data assistant (PDA) and the like, capable of connecting to the internet and having other communication capabilities. The user client device 130 may communicate with the authentication server 135 through the communication network 125 in one or more ways such as wired, wireless connections or a combination thereof. It will be appreciated by those skilled in the art that the user client device 130 includes one or more functional elements capable of communicating through the communication network 125 to receive one or more services offered by the authentication server 135. In one embodiment of the present disclosure, the user client device 130 is an internet enabled device and communicates with the merchant client application 390, when the user device 110 is within pre-defined or determined geofence associated with the place of business of merchant in close proximity to the merchant client application 390, to exchange data and hence builds a temporary personal area network.

In another embodiment of the present disclosure, the user client device 130 comprises a payment application 290 which enables a user to register with the system 100 by providing necessary registration credentials. The registration credentials may include a user name, password, contact details, payment details, and the like. Upon successful one-time registration, the user may utilize the payment application to make payment to any of the merchant who uses the merchant client device 175. During operation, when the user launches and interacts with the application 290, for example, when the user selects an option “Pay” 1193, the payment application identifies user selected or current place of business associated merchant client application 390 of the merchant client device 170 or searches for merchant client application(s) 390 or the merchant client device(s) 170 nearby and enable user to select and connect with selected e.g. merchant client application 390 of the merchant client device 170 and establishes a connection with said selected merchant client application(s) 390 or the merchant client device(s) 170.

In some implementations, the merchant client application or the merchant client device is no longer visible or connectable to any other devices, once the merchant client device 175 establishes the connection with the use client device 130. Upon successful connection, the user client application 290 of the user client device 130 (payment application 290) fetches the payload 1195 for the transaction from the merchant client application 390 of the merchant client device 175 and communicates the payload 1195 for the transaction to the authentication server 135. Hence, only the connected user device is able to make the payment and complete the transaction. The merchant client device will does not accept payment from any other user devices until termination of the transaction or connection.

The communication network 125 may be a wireless network or a wired network or a combination thereof. Wireless network may include long range wireless radio, wireless personal area network (WPAN), wireless local area network (WLAN), mobile data communications such as 3G, 4G, 5G or any other similar technologies. The communication network 125 may be implemented as one of the different types of networks, such as intranet, local area network (LAN), wide area network (WAN), the internet, and the like. The communication network 120 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like. Further the communication network 120 may include a variety of network devices, including routers, bridges, servers, modems, computing devices, storage devices, and the like. In one implementation, the communication network 125 is internet which enables communication between the user device 130 and the authentication server 135 and enables communication between the user device 130 and the merchant device 175.

The authentication server 135 may include, for example, a computer server or a network of computers or a virtual server which provides functionalities or services for other programs or devices such as for the user device 130 and to merchant devices, if any, for example, mobile device. In one implementation, the authentication server 135 is a cloud server comprising one or more processors, associated processing modules, interfaces and storage devices communicatively interconnected to one another through one or more communication means for communicating information. The storage associated with the authentication server 135 may include volatile and nonvolatile memory devices for storing information and instructions to be executed by the one or more processors and for storing temporary variables or other intermediate information during processing.

In one embodiment of the present disclosure, the authentication server 135 comprises a database that comprises information pertaining to one or more merchant client devices, wherein the information may include but not limited to, merchant client device ID and merchant information associated with the merchant client devices. As described, the merchant information comprises, but not limited to, merchant name, merchant address and contact details, location of the merchant client device (i.e., pre-configured region within which the merchant client device is operational), type of business, information pertaining to financial entity associated with the merchant such as merchant account number, branch, account type, etc. Further, the database maintains a record of information pertaining to the one or more user devices, wherein the information may include, but not limited to, user device ID (or payment application ID), user login credentials, user contact information such as phone number, email IDs, etc. That is, when a merchant subscribes for the system, the information pertaining to the merchant client device is recorded in the authentication server 135. Similarly, when a user installs payment application 290 and registers with the system, the information pertaining to the user device is recorded in the authentication server 135. Hence, the system 100 provides a transaction platform for the subscribed merchants and the registered users to execute and complete the transactions.

As described, the user device 130 (200) (payment application 290) fetches the payload for the transaction from the merchant client device 175 and communicates the payload for the transaction to the authentication server 135. The authentication server 135 decrypts the payload for the transaction, authenticates the payload for the transaction (decrypted data) and communicates a result to the user device 130 (200) thereby enabling the user device 130 (200) to complete the transaction through any one of a payment mode such as but not limited to a payment wallet, credit card, debit card, cash card, online transfer, unified payments interface (UPI), and the like. As described, payload for the transaction comprises, encrypted payment information. In one embodiment of the present disclosure, the authentication server 135 decrypts the received payload for the transaction to determine the payment information, wherein the payment information comprises merchant client device information for example, merchant client device ID and at least an amount owed by the user.

Up on decrypting, the authentication server 135 locates the user device 130 to determine a location of the merchant client device 175. That is, the authentication server 135 locates the user device 130 and compares the location of the user device 130 (i.e., location of the merchant client device 175) with the recorded location of the merchant client device, i.e., the pre-configured geofence or region within which the merchant client device 175 is operational or may operate. If the location of the merchant client device 175 is within the pre-configured geofence or region within which the merchant client device 175 is operational, then the authentication server 135 communicates a result to the user device 130 thereby enabling the user device 130 to complete the transaction, wherein the result comprises, at least one of an amount owed (amount to be paid by the user), breakup amount, the merchant client device ID and merchant information. In some implementations, the merchant client device 175 comprises a GPS module and the payload for the transaction is authenticated by locating the merchant client device 105 and comparing the location with the pre-configured geofence or region within which the merchant client device 105 is operational or may operate.

Typically, in a merchant environment, there may be one or more of merchant client devices and one or more user devices. In such a scenario, a user who intends to pay selects merchant device id or counter number pasted at physical place on device or store counter with which the user is executing the transaction. Then a connection is established between the user device and the merchant client device via internet network. The manner in which a connection is established between the merchant client device 175 and the user device 130, and the transaction is completed is described in detail further below.

In another embodiment authorized user of merchant client application can select current customer in queue at particular counter number associated point of sale (POS) which the merchant is scan and add purchased products, prepare bill or totaled amount of said scanned or added products and executing the payment transaction. Then a connection is established between the said authorized user of merchant client application and user device via internet network. The manner in which a connection is established between the merchant client device 175 and the user device 130, and the transaction is completed is described in detail further below.

In some other implementations, the merchant client device 175 lists one or more nearby user devices thereby enabling the authorized user of merchant client application of the merchant client device to select one of the user devices for completing the transaction. That is, once the merchant client device 175 is connected with the user client device as discussed above and throughout the specification, further establishing second connection with the merchant client device 175 (300) which are in close proximity based on the broadcasted presence by merchant client device by means of a custom Bluetooth™ profile thereby enables a user client device 130 (200), which is in close proximity to the merchant client device, to establish a second connection with the merchant client device 175 (300), wherein Bluetooth signal strength is greater than threshold) to the merchant client device 175 write a handshake signal thereby enabling the merchant to order the nearby users in queue and select one of the user devices. Upon selection by the merchant, a connection is established between the merchant client device and the user device for completing the payment and hence the transaction. The user device 130 fetches the payload for the transaction from the merchant client device 175 or the merchant client device 175 sends or share or presents the payload for the transaction to the user client device and communicates the payload for the transaction to the authentication server 135 via the communication network 125, wherein the payload for the transaction comprises encrypted payment information. It has to be noted that, once the connection is established, the user device 130 may fetch the payload for the transaction from the connected and selected merchant client device in the pre-defined geofence associated with the place of business selected by user on the maps.

Further, the payment application displays “checkout or pay bill” option 1090/1120 enabling the user to accept reception of payload for the transaction. Once the user clicks on “checkout or pay bill” option 1090, the payment application fetches the payload for the transaction from the merchant client device 175 and communicates the same to the authentication server 135.

FIG. 11 illustrates an exemplary user interface 1160 of the user client application 290 (200) of the user client device 130 presenting result of authentication in accordance with an embodiment of the present disclosure. As described, upon successful authentication, the authentication server 135 communicates the result and the result is displayed on the user device 130 for further verification by the user. As shown, the user interface displays 1160 the merchant client device ID, merchant name 1199, bill or invoice 1194 and bill mount (amount owed by the user) 1195. Further, the user interface 1120 provides “confirm” option 1191 and “cancel” option 1192. Clicking on “confirm” option 1191, the payment application navigates the user to payment page 850 of user interface 1182 where the user may select one of the payment method 880/1184 such as wallet payment, credit card, debit card, online payment, UPI etc., for completing the transaction. On the other hand, the user may cancel or reject 1192 the transaction by clicking on the “reject” option 1192 or the user may payment of said amount from default account by clicking on “confirm and pay” option 1193 or send request to update or change bill or amount with details or notes.

FIG. 11 (A) illustrates after establishing of connection between user 101 via user client application 290 with merchant 102 via merchant client application 290, merchant or authorized user having rights to access merchant client application 101 can view said connected user's or customer's details including avatar or photo or image or video or animation or graphical representation of connected user (1101/1102/1103), name, activity details and status, date & time and triggered event, associated call-to-actions, and statistics (1110/1112/1114), wherein status comprises user 101 arriving or entering at said connected merchant's 102 place of business 601/661. Customer who made advance order remotely or online and wants to take away 1092 as per schedule date time or currently arriving at store or place of business to take away 1092 or have scheduled booking 1094 shows estimated time & distance to arrive, show customer's route from source to arriving at store on map, if said user or customer booked table 1094 then display booked table number and associated date and time, number of persons. Merchant application 390 displaying arrived or entered status, current status of table (if booked), estimated waiting time. Merchant application 390 shows order details including customer name, ordered products and/or services, quantity, amount or price, status, activity and status name a details statistic (1110/1112/1114). Merchant application 390 automatically sends welcome message on user client application 290 or merchant can send custom welcome message to said arrived user or customer. Merchant application 390 displays ordering status of said connected and arrived or entered user (user can manually order or select item(s) from menu or select products or services from catalogues and consume at store 1093). Merchant can establish communication session 1122/1123 with user or user establish communication session 1172/1173 with merchant to make order, ask queries, provide instruction and customization request. Merchant or authorized staff can view order details including name, quantity of ordered products and/or services, selected option including delivery 1091, takeway 1092 and eat at or booking details including date and time, number of persons, table number, and payment details including amount, payment method, date and time of payment, payment status including payment pending or done, updated order details and manually set ordered status 1125 or automatically set ordered status based on providing order by user from user client application 290. Merchant can provide approximate waiting time 1121 and order status 1125 including order accepted or rejected, order pending, order done or order ready, order updated, order served or delivered to customer of delivery person. Merchant can share or sent or push bill or updated bill or invoice 1127 for said user or customer's approval including accept bill and make total billed amount payment or reject bill or request to change bill. After making of payment by user, merchant's application 390 can displays payment done status. Merchant can view length of duration of dwelling in store or place of business by said customer. Merchant 101 can provide offers 1124 including coupon code, gift card, membership, redeemable points, discount or free items or samples on next visit, provide rule based offer e.g. if advance book or number of persons or amount or festival then provide offer), cross sell or up sell with customer, ask customer about customer's next visit, refer friends or contacts. Merchant can provide one or more types of reactions 1128 including like, rate, comment, get feedback or complaint or survey, take call-to-action from user including get contact information, request to follow or add to favorite. Merchant can view “Exit” status of user. Merchant can communicate with user if need e.g. remind for pending bill, forget phone and like. In an embodiment enable merchant 102 to disconnect 1126 with selected connected customer or user 101 or user client application 290.

In an embodiment FIG. 11 (B) illustrates after establishing of connection between user 101 via user client application 290 with merchant 102 via merchant client application 290, displaying user's avatar 1170 or profile photo or video or image or animation or graphical representation of user 1170, user name, activity and status details including type, name, date and time, ordered product details, and statistics 1165 associated with said ordered place or user visited place 1199, make order, view provided order, update order or view updated order details, view current order status. Connected user 101 can communicate 1172/1174 with connected merchant 102 via user client application 290, claim offer 1174, disconnect with connected merchant 1176, view pushed or received or presented bill or invoice 1177/1194 or total billed amount 1195 and can accept 1191 or reject 1192 or confirm and pay 1193 said billed amount 1194/1195 or cancel or ignore bill or request to change or update bill or invoice 1177 and in the event of accepting of said bill or invoice, automatically make payment of said billed amount from said user's 101 account to said connected merchant's 102 account, provide one or more types of reactions including like, dislike, rate, comment, feedback, complaint, suggestion, fill survey forms, buy merchant presented products and services 1180 and provide table and seat number 1182 by viewing table and seat number pasted or putted on the table.

In an embodiment identifying entering or arriving status of said user in said merchant's place of business or pre-defined geofence associated with said place of business based on sufficiently matching location of said user's monitored and tracked user client device 130 (200) with said selected place 601/602/661 on maps 605/655 associated identified location or selected place 601/602/661 on maps 605/655 associated uniform resource locator (URL) associated location, wherein location of place of business comprises geo-coordinates, pointer on map, address, geocodes and pre-defined geofence on maps associated with said selected place on map associated identified merchant.

In an embodiment user 101 can make manually order or collect items manually from store (e.g. via physical trolly) and scan and add said products (e.g. via point of sale (POS)) at counter of merchant 102 by merchant staff, wherein in the event of selecting “connect” 1056 by customer 101 from user client application 290 of user client device 130 (200), connecting said user client application 290 with said merchant client application 390 or in another embodiment based on settings including store specific settings automatically connect user client application 290 with said merchant client application 390 based on sufficiently matching location of said user's monitored and tracked user client device 130 (200) with said selected or entered and dwell for pre-set duration place 601/602/661 on maps 605/655 associated identified location or selected place 601/602/661 on maps 605/655 associated uniform resource locator (URL) associated location, wherein location of place of business comprises geo-coordinates, pointer on map, address, geocodes and pre-defined geofence on maps associated with said selected place or entered or dwell for pre-set duration in place on map associated identified merchant. In another embodiment total billed amount or entered amount or final payment amounts and payment data from the user client application of user device goes directly to the processor for payment authorization. The authorization response from the processor is sent directly to the point of sale (POS) terminal the point of sale (POS) terminal then forward the results to the point of sale (POS) software and confirmation of payment or payment request results can be transferred automatically to the merchants retail management system or the point of sale (POS) software to separates the point of sale (POS) from payment. Once the gateway authorizes the transaction, it issues a call to the POS system, informing it that the original sale request has been fulfilled and the payment has been successfully made.

After connecting with user client application 290, merchant can view name, photo(s)/video(s) of said user and identify current customer in queue (or automatically sort or order customers or identify user based on calculating nearby or nearest location of user devices in queue). After identifying current customer, merchant 102 can select customer from list of customers and can sent or present or push bill or invoice or total billed amount (after applying offer (e.g. discount), gift card, points, store credit, tax and like) from merchant client device 175 (300) to user client device 290 (200) via server 110 module 190. User client device 290 (200) can view said received bill or invoice and can accept or reject or cancel or ignore or request to update or change bill or invoice (provide reason to change bill or invoice). In the event of accepting (confirm and pay) 1193 said received bill or invoice, automatically make payment of said billed amount 1195 from said user's account 1196 to said connected merchant's account. In another embodiment merchant 102 directly tell amount to customer or user 101 to make payment of total billed amount. User can enter amount 1183 and use pre-set or default account 1184 or change or update 1185 and select account from list of added accounts 1185 or add new account and select account 1185 and click or tap on pay button control 1186 to make payment of said amount 1183 from said user's account to said connected merchant's account.

In an embodiment user can self-checkout 1175/1092 in-store collected and purchased items or products by scanning products via user client application 390 from user client device 130 (200) and make payment of total billed amount (apply offer (e.g. discount), gift card, points, voucher or coupon code, store credit, tax and like) from user selected payment method or payment account to said store associated connected merchant's account. Connected merchant client application 390 can view said added or purchased and scanned products and associated details including product or item name, price, quantity, applied redeemable points, coupon or voucher code, tax and like, total billed amount, user status including enter and dwell (shopping) in store, scanning and adding products, checkout and made payment, payment status including pending payment, requesting discount or negotiation or problem in applying discount or codes or making payment. At exit gate staff of merchant or authorized user of merchant client application 390 (300) can view and manually check added items or products and provide clearance indication to said user or tell user to add forgetter items or products and make pending payment. In another embodiment based on past purchases, number of times and/or total amount of purchase, current amount of purchases, types of items or products, user profile accessed from one or more linked or connected system, service, servers, databases and service providers including user profile from server 110 database 115, merchant can authorized said user to self-checkout or self-checkout and also exit from store without security check.

In an embodiment in the event of exiting from the location or geofence 604/664 of the place of business 601/661 by connected user client device 130 (200) and non-payment of billed amount, notifying said user client device 13 (200) about non-payment of billed amount with details 1195 and enable to make payment by clicking or tapping on payment button or control 1193. After notifying about said pending payment and non-payment of said pending billed amount within pre-defined duration, instruct user to make payment at the time of making payment to/in next place else disable application which disallow user to use application or make payment at/in/for/to next place associated merchant's account.

In another embodiments in the event of exiting from the location or geofence 604/664 of the place of business 601/661 by connected user client device 130 (200) and non-payment of billed amount, based on user 101 provided automatically make billed payment while exiting from any or selected or selected types specific place(s) settings via user client application 290 of user client device 130 (200), automatically make billed payment amount 1195 from said user selected or pre-set or default payment account 1196 to said place 601/661 or location or geofence 604/664 of the place of business 601/661 associated or said place 601/661 or said location or geofence 604/664 of the place of business 601/661 associated clicked or tapped or selected uniform resource locator (URL) 755/756 associated merchant's account.

In another embodiment in the event of making payment to wrong place or other place associated merchant, enabling said other place associated merchant to notify user and revert said payment to user's account and enable user to select right place and make payment to said right place or further selected place associated merchant's account.

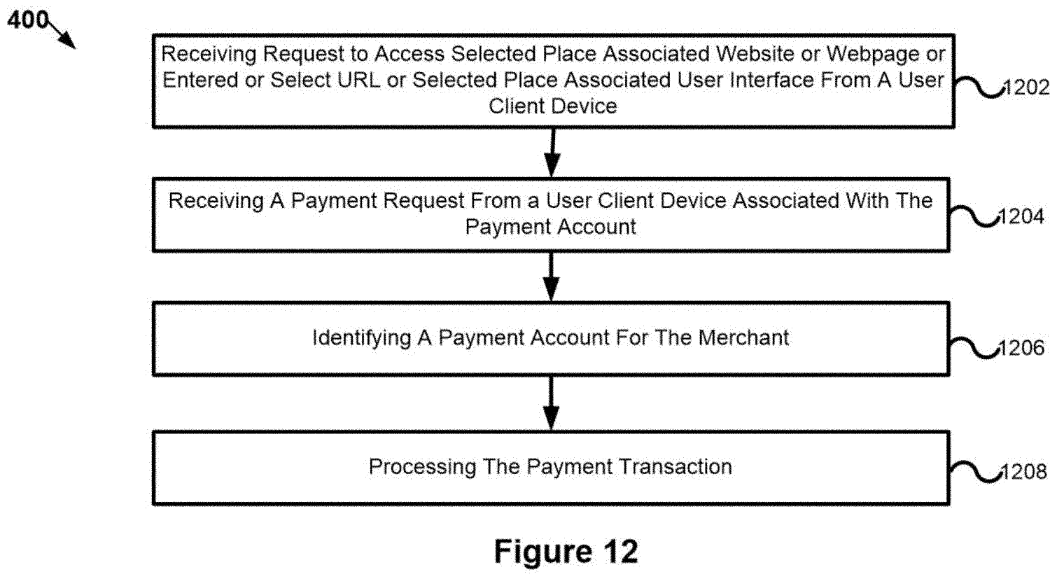

FIGS. 1-10, the corresponding text, and the examples, provide a number of different systems and devices for processing electronic payment transactions using a payment system. In addition to the foregoing, embodiments can be described in terms of flowcharts comprising acts and steps in a method for accomplishing a particular result. For example, FIG. 12 illustrates a flowchart of an exemplary method in accordance with one or more embodiments.

FIG. 1 further illustrates that the payment engine 135 includes a payment management, a payment transaction and order database, and an account module. Each of the components of the user client device 130 (200), the merchant client device 175 (300), and the server device(s) 110 can communicate with each other or with modules of the payment network 135 using any suitable communication technologies. It will be recognized that although the modules of the client devices FIG. 2-3 and the server device(s) are shown to be separate in FIG. 1, any of the modules may be combined into fewer modules, such as into a single facility or module, or divided into more modules as may serve a particular embodiment. While FIG. 1 describes certain modules as part of the client applications and other modules as part of the network application, the present disclosure is not so limited. In alternative embodiments, one or more of the modules shown as part of the client applications can be part of the network application or vice versa. Similarly, one or more modules shown as part of the network application can be part of the payment engine 135 or vice versa.

The modules can include software, hardware, or both. For example, the modules can include computer instructions stored on a non-transitory computer-readable storage medium and executable by at least one processor of the client devices 130, 175 or the server device(s) 110. When executed by the at least one processor, the computer-executable instructions can cause the client devices 130, 175 or the server device(s) 110 to perform the methods and processes described herein. Alternatively, the modules can include hardware, such as a special purpose processing device to perform a certain function or group of functions. Additionally, or alternatively, the modules can include a combination of computer-executable instructions and hardware.

In one or more embodiments, the client applications 290, 390 on both the user client device 130 and the merchant client device 175 are native applications installed on the client devices 130 (200), 175 (300). For example, the client applications 290, 390 on one or both client devices 130 (200), 175 (300) may be a mobile application that installs and runs on a mobile device, such as a smart phone or a tablet or wearable device like smart watch. Alternatively, the one or more both of the client applications 290, 390 may be a web application, a smart client application, a desktop application, widget, or other form of a native computer program that runs on a desktop device or laptop device. The client applications 290, 390 may be a remote application, such as a web application executed within a web browser or may be integrated application, integrated within website or webpage of merchant via application programming interface (APIs)/software development toolkit (SDKs) executed within a web browser, that the client devices 130 (200), 175 (300) access.

As mentioned, the client applications 290, 390 on the user client device 130 (200) and the merchant client device 175 (300) can include a user interface management. The user interface management allows the user to perform steps for initiating a payment transaction with the merchant in connection with a purchase order. For example, the user interface management can include a user interface that facilitates the entering or inputting or selecting amount or use pre-set or default amount, select payment accounts for processing payment transactions in connection with purchase orders, or sending messages to merchant.

The user interface management of the user client device 130 (200) provides, manages and controls a user interface that allows a user to search, browse, view, select and order or purchase products or services, make in-store or online or advance order, instruct in-store consumption or takeaway or delivery order, book table, get appointment, claim offer including vouchers or coupons, participate in group deals, connect with merchant for communication, receiving billed amount, invoice, receipt, offer including discount, free items, and redeemable points or list and details of added products or services by merchant at point of sale (POS) of retail counter, view payment transactions, view logs, transaction details, and status, interact with other users by sending/receiving messages, and/or interacting with merchants. For example, the user interface that facilitates the preparing instant messages, social networking posts, or other content.

The user interface management of the merchant client device 175 (300) provides, manages and controls a user interface that allows a merchant to view products or services associated with a purchase order by a user. The user interface management facilitates the display of a user interface. For example, the user interface may be composed of a plurality of graphical controls, modules, components, objects and elements that allow a user to sign up, sign in, update profile, enter amount, select account & make payments, add or update payment methods, view logs including transaction logs, notifications and status, search, browse, select products and services related to selected place on map associated website uniform resource locator (URL) associated merchant or entered or selected uniform resource locator (URL) associated merchant and compose, send and receive messages or payments. The user interface management may direct the corresponding client device to display a group of graphical controls, modules, components, objects, widgets and elements that enable a user to view a control panels, management interface, updated status, call-to-actions and controls for taking actions, view bills, and notifications or messages.

The client applications 290, 390 also includes a location monitor and track module to facilitate the monitoring and tracking location data associated with the respective client devices. For example, the location monitor and track module can access or identify or determine a location of the client device based on GPS information from the client device, cell tower triangulation, wireless communication beacons, WIFI received signal strength indication, WIFI wireless fingerprinting, radio-frequency identification, near-field communication, by analyzing messages, or based on data from other sources or linked systems and databases. The location monitor and track module can then provide the location of the corresponding client device to the network application.

Additionally, the monitor and track module of the merchant client device 175 (300) can use information with other devices or use information from a map of the merchant store to determine a location of the merchant client device. For example, the location monitor and track module can use information from a generated map (e.g., a 3D map) of the store to determine the location of the merchant client device 175 (300). The location monitor and track module can also use the positioning of the merchant device(s) to determine a location of the merchant client device 175 (300).

The client application 290 of the user client device 130 also includes a payment request generator to create payment requests corresponding to payment transactions. For example, the payment request generator can generate a data package or payload for the transaction that includes payment data such as a user identity, a payment amount, a user payment account attempting to purchase goods or services or making payment for billed amount, and a uniform resource locator (URL) identified based on user selected place on map associated clicked or tapped or selected website or webpage associated uniform resource locator (URL) or user entered or selected uniform resource locator (URL) in web browser. Additionally, the payment data can include based on said uniform resource locator (URL), identified merchant identifier and associated payment receipt account information for the merchant, authorization information, currency information, and other data that may be helpful to facilitate a payment from the user to the merchant. As described previously, the payment request may include only some of the payment transaction information, and the payment request generator may create one or more additional payment requests to provide more payment data.

The client application 390 of the merchant client device 175 also include a data including sent and receives messages or data between a merchant and users or the server device(s). For example, data can include message logs, contact lists, content, past communications, past payment transactions, visited places, bills, invoices, receipts, pending payments details, reactions, status, accounts and other similar types of data that the client application 390 can use in connection with providing the ability for the merchant to engage in payment transactions using the client application.

The merchant client device 104b may also include point of sale (POS) software including cloud based point of sale (POS) facilitates during in-store checkout processes scanning and adding of purchasing goods or services from the merchant, prepare bill and invoice and share to connected user (merchant identifies user based on photo, video, name of user or detecting nearby user) for enabling user to view received bill, accept or cancel or request to update or change bill, and make payment directly from user client device 130 (200).

As briefly mentioned above, in addition to the client devices, the payment system 100 can further include a network application 160 that is implemented in whole or in part on the server device(s) 110. In one or more embodiments of the present disclosure, the network application is part of a networking system (such as but not limited to PlacePe or Pay-via-place™), but in other embodiments the network application 160 may comprise another type of applications, including but not limited to an e-mail application, order application, deals application, offer application, financial platform, search engine application, banking application, or any number of other application types that utilizes user accounts.

The status manager can track the status of users (e.g., users, merchants) of the client applications and/or the client devices. For example the status manager can identify when a user is logged into the client application, when a user is active on the client application, or when a client device associated with a user or user account is online or active, when a user enter in, dwell at, and exit from particular place or geofence associated with the place of business, user status includes ordering, waiting, arriving, arrived, entered, dwelled, exited, connecting, connected, order status includes ordered, in-progress, done, payment status includes payment done, payment pending, authorized, confirmed, cancelled or rejected. The status manager can send indications (such as push notifications) to the client application to notify the client application of the status of users, device, messages, or payments. The status manager can also manage a location of users based on location data received from the client devices of the users. The status manager can communicate with the user interface 1150/1160 to present status notifications to users.

In one or more embodiments the server device(s) 110 module 193 can use or monitor and track the location of the user client devices (e.g. driver in vehicle, friends or contacts in restaurant, colleagues, workers, delivery boy, on demand service providers, employees, server, seller, merchant) and use e.g. the location of the user client device 130 (200) to identify client devices of other users that are located within a defined proximity of the location of the user client device 130 (200). Server device(s) 110 (193) identifying a plurality of users at or near the location based on location data from a plurality of client devices associated with the plurality of users. In particular, the server device(s) 110 use the location of the e.g. user client device 130 (200) to identify monitored and tracked client devices of other users who are at or near the location of the user client device 130 (200). For example, the server device(s) 110 (193) can obtain location data from user devices of users registered with a platform or server 100 or networking system 100 (or other system that stores user accounts). The server device(s) use the obtained location data from client devices of users who have previously registered with the platform 100 or sever 110 or system 100. The server device(s) 110 then compare the obtained location data to the location of the user client device 130 (200) to determine that one or more users are at or near the location of the user client device 130 (200). Alternatively, the server device(s) use device connection information from a plurality of wireless device (e.g. Bluetooth devices or wireless network devices) to determine that one or more users are at or near the location of the user client device 130 (200). Identifying registered users at or near the location of the particular user client device 130 (200) narrows the number of candidates from which the server device(s) 110 can identify the client devices of other users. In one or more additional embodiments, the server device(s) 110 can use other narrowing factors or degrees of narrowing. For example, if location data from user client devices is unreliable for determining exact locations of users nearby or surround or at the location of the user client device 130 (200), the server device(s) 110 can establish predefined geo-fences for identifying other users who are approximately at the location of the user client device 130 (200). To illustrate, the server device(s) 110 can establish a e.g. ¼-mile radius centered at the location of the user client device 130 (200) to identify client devices of other users who are at or near the location of the user client device 130 (200). Alternatively, the server device(s) 110 can establish geo-fences based on zip codes, cities, counties, or any other predefined geographical region. After identifying nearby user client applications of respective client devices of respective other users, server 110 (193), displaying shared profile or user details including name, photos, videos, images, same voice, address, gender, age and one or more types of identities and/or codes of said identified nearby users on user client application 290 of the user client device 130 (200) and enables the user 101 to select one or more users from said displayed list of nearby users and enable to connect to view shared profile and access payment account information or push or send amount for receiving payment or enter or select or use default amount or use received push amount from said selected user and select or use default or pre-set payment account and make payment of said particular amount from said payment account to said selected user's payment account. In an embodiment display said nearby identified users with details (name, icon, photo, image, relationship) on maps and enable user to select nearby person from said displayed users on maps and connect or communicate or enter or select amount or use pushed amount or make payment of particular amount from user selected or pre-set user payment account to said selected person's payment account.

The network application can also include a user profile database. The user profile database manages user profiles or user accounts for a plurality of users. Specifically, when a user registers with the network application via the client application, the network application creates a user account for the user. The user profile database can store information about the user for maintaining and displaying a user profile for the user. For example, the user profile database can maintain personal information, identification information, location information, payment information, user logs, interest, likes, posted contents, reactions, transactions, contacts, connections and other information that the user provides to the network application to invoke the user profile.

In additional embodiments, user can initiate payment or purchase a product (e.g., coffee) from a specific chain of restaurants and initiate or make payment even before the user arrives at the checkout location or at the store. To illustrate, the network application 160 can receive payment request (ordered products/services—consume at store or takeaway or delivery at provided shipping address request, book table as per schedule time or book table on arrival request, amount, user selected payment account, URL) from said user and identifies the user's identity based on login and identifies merchant's identity based on user selected place associated clicked or tapped or selected website or webpage uniform resource locator (URL) and identifies user location based on monitored and tracked user device current location and identifies merchant location based on user selected place associated merchant's place of business related location information including pre-stored address, selected point on map, geo-coordinates. Merchant can also track arrival of user at merchant's store or place of business to start preparing order (if user requested consume at store or takeaway). User can connect with merchant client application 390 via user's client application 290 to view current availability of seat, view order status (if takeaway then view whether order is ready or not status).

According to one or more embodiments, the payment system 100 can maintain the payment engine 135 separate from the network application 136. For example, the payment system 100 can implement payment processes associated with the payment engine 135 separately from at least some of the functionality of the network application 136. Implementing functionality of the payment engine 135 and the network application 136 on separate servers can allow the payment system 100 to ensure that at least some of the financial information associated with the users is maintained apart from the network application to comply with Payment Card Industry (PCI) standards. Alternative configurations of servers and/or software than those described herein may also allow the payment system 100 to comply with PCI standards.

As mentioned previously, the server device(s) 106 can include a payment engine 506 having a payment communication interface. The payment communication interface can integrate the sending and receiving of payment requests and initiate payment transactions, and may employ one or more application programming interfaces (APIs). For example, upon the receiving a payment request, send any payment details to the payment manager communication interface. The payment communication interface can then use the payment details retrieved from the payment request to initiate a payment transaction using the payment network 135.

The payment communication interface can coordinate a transaction corresponding to a payment defined in a payment request. As generally explained above, the payment communication interface can coordinate a transaction via the payment network that corresponds to a payment request, monitor the status of the transaction, and provide status information regarding the transaction. More specifically, the payment network 135 can authorize a transaction, fund a transaction, and/or settle an individual transaction or batch of transactions. In one or more embodiments, the payment communication interface can use one or more application programming interfaces (API) to communicate relevant information with the payment network 135.

To complete a transaction, the payment communication interface can access or obtain payment credentials for the consumer and the merchant. Specifically, the payment communication interface identifies a payment credential (e.g., a payment authorization number or a payment token) for the user in connection with a payment account for the user. For example, the payment communication interface can communicate with the user profile database to identify a payment account associated with a user account for the user. Additionally, the payment communication interface can send a plurality of possible payment accounts to the user client device for selecting one of the possible payment accounts to use in the payment transaction.

The transaction database can provide storage for a transaction history for users and merchants. For example, the transaction database can store each transaction, attempted or completed, transaction IDs, a date, an amount of the transaction, the payment method used, a user identifier, a merchant identifier, and any other information gathered on the transaction. With this information, the payment manager can provide, upon request, a log of one or more transactions to users as a history of payments requested, payments declined and payments completed.

Additionally, the payment engine includes an account management for managing payment credentials of users and merchants in connection with payment accounts of the users and merchants. A user or merchant can register a payment account with the server 110, which can store the details about the payment accounts of the users and merchants who have user accounts in the user profile database and also store linking information that links the payment accounts to the respective user accounts. In one or more embodiments, server 110 also stores additional information associated with the payment credentials, such as expiration dates, security codes, address information, and/or other information.

In an embodiment FIG. 1 illustrates an example network environment 100 of a platform or system. Network environment 100 includes a client system 200/300, and a third-party system (e.g. in another embodiments 3^{rd} party's payment network 135) connected to each other by a network 125. Although FIG. 1 illustrates a particular arrangement of client system, platform system 110, third-party system (e.g. 135), and network 125, this disclosure contemplates any suitable arrangement of client system 200/300, platform system 110, third-party system (e.g. 135), and network 125. As an example, and not by way of limitation, two or more of client system 130 (200), 175 (300), platform system 110, and third-party system (e.g. 135) may be connected to each other directly, bypassing network 125. As another example, two or more of client system 130 (200), 175 (300), platform system 110, and third-party system (e.g. 135) may be physically or logically co-located with each other in whole or in part. Moreover, although FIG. 1 illustrates a particular number of client systems 130 (200), 175 (300), platform systems 110, and third-party systems (e.g. 135), and networks 125, this disclosure contemplates any suitable number of client systems 130 (200), 175 (300), platform systems 110, and third-party systems (e.g. 135), and networks 125. As an example and not by way of limitation, network environment 100 may include multiple client systems 130 (200), 175 (300), platform systems 110, and third-party systems (e.g. 135), and networks 125.

In particular embodiments, client system 200/300 may be an electronic device including hardware, software, or embedded logic components or a combination of two or more such components and capable of carrying out the appropriate functionalities implemented or supported by client system 200/300. As an example, and not by way of limitation, a client system 200/300 may include any of the computing devices discussed above in relation to FIG. 1. A client system 200/300 may enable a network user at client system 200/300 to access network 125. A client system 200/300 may enable its user to communicate with other users at other client systems 200/300.

In particular embodiments, client system 290/390 may include a web browser 932, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 282/380 may enter a Uniform Resource Locator (URL) or other address directing the web browser to a particular server (such as server, or a server associated with a third-party system), and the web browser may generate a Hyper Text Transfer Protocol (HTTP) request and communicate the HTTP request to server. The server may accept the HTTP request and communicate to client system 282/380 one or more Hyper Text Markup Language (HTML) files responsive to the HTTP request. Client system 282/380 may render a webpage based on the HTML files from the server for presentation to the user. This disclosure contemplates any suitable webpage files. As an example, and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, platform system 100 may be a network-addressable computing system that can host an online network. Platform system 100 may generate, store, receive, and send networking data, such as, for example, user-profile data, or other suitable data related to the network. Platform system 100 may be accessed by the other components of network environment 100 either directly or via network 125. In particular embodiments, platform system 100 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, payment server or payment gateways or payment service provider server, data vault server, PCI complaint server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, platform system 100 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client system 290 (200)/390 (300), a platform system 100, or a third-party system to manage, retrieve, modify, add, or delete, the information stored in data store.

In particular embodiments, platform system 100 may be capable of linking a variety of entities. In particular embodiments, a third-party system may include one or more types of servers, one or more data stores, one or more interfaces, including but not limited to APIs, one or more web services, one or more content sources, one or more networks, or any other suitable components, e.g., that servers may communicate with. A third-party system may be operated by a different entity from an entity operating a platform system 100. In particular embodiments, however, platform system 100 and third-party systems may operate in conjunction with each other to provide services to users of platform system 100 or third-party systems. In this sense, platform system 100 may provide a platform, or backbone, which other systems, such as third-party systems, may use to provide services and functionality to users across the Internet.

FIG. 12 illustrates a flowchart of a method 400 of merchant identification for processing payment transactions. The method 400 includes an action 1202 of receiving a request from user 101 client device 130 (200) to access user selected place (601/602/661) associated website or webpage uniform resource locator (URL) 752 associated website or webpage or user interface (FIG. 8) from maps application (605/655) including 3^{rd} parties maps application (e.g. Google Maps, Bing Maps, Apple Maps, TomTom Maps, and other maps) or receiving a request to access user entered or user selected website or webpage uniform resource locator (URL) (810/812) associated website or webpage (FIG. 8) for enabling user to sign in by using one or more sign in method including user name or user identity and password or enabling server 110 to automatically identify user based on employing available one or more user device identification techniques. The method 400 includes an action 1204 of receiving a payment request to initiate an in-store (at offline store) or online (remotely select URL from selected place on maps or enter or select URL from web browser) payment transaction. For example, act 1204 involves receiving, from a user client device 130, 200, a payment request to initiate an in-store or (remote) online payment transaction between a user and a merchant, wherein the payment request comprises a user identifier, a user location, a user selected uniform resource locator (URL), a payment amount, a payment method. Alternatively, action 1204 can involve receiving a first payment request that includes, but does not include a payment amount for the in-store payment transaction. Act 1204 can then involve receiving a second payment request after determining an identity of the merchant, the second payment request including the payment amount for the in-store payment transaction.

For example, act 1206 can involve identifying a plurality of payment accounts associated with a platform account for the user, sending, to the user client device 130, 200, a plurality of indicators associated with the plurality of payment accounts, and receiving, from the user client device 130, 200, a selected indicator from the plurality of indicators associated with the plurality of payment accounts.

Additionally, the plurality of indicators can include a plurality of payment tokens, each token corresponding to a payment account from the plurality of payment accounts. For example, the plurality of payment tokens can include payment tokens generated by a payment network to represent the plurality of payment accounts. Alternatively, the plurality of indicators can include a plurality of nicknames that identify the plurality of accounts.

The method 400 also includes an act 1206 of identifying a payment account for the merchant. Server device(s) 110 identifies identity of user based on user sign in via one or more sign in methods or receiving one or more types of user device identities. Server device(s) 110 identifies a merchant identifier and identifies a merchant location based on received uniform resource locator (URL) in payment request. To illustrate, act 1206 can involve comparing the received uniform resource locator (URL) to store uniform resource locators (URLs) associated with merchants, and identifying a merchant identity or merchant account including bank account or debit card details associated with the received uniform resource locator (URL).

In another embodiment the method 400 further includes an action of sending a payment confirmation request to the user. For example, act 1204 involves sending a payment confirmation request to a client device 130, 200 associated with the payment account for the user, the payment confirmation request corresponding to the payment request to initiate the in-store payment transaction. Action 1204 can involve sending a push notification comprising payment data associated with the in-store payment transaction. To illustrate, action 1204 can involve sending the push notification to appear on a lock screen or in a notification tray of the client device 130, 200 associated with the payment account for the user.

Additionally, the method 400 includes an action of receiving a confirmation response from the user. For example, action involves receiving a confirmation response from the client device to process the in-store payment transaction. Action can involve receiving authorization to initiate the in-store payment transaction in the confirmation response from the client device 130, 200.

The method 400 also includes an action 1208 of processing the in-store payment transaction. For example, action 1208 involves processing, using the payment account for the user, the in-store payment transaction based on the received confirmation response. Action 1208 can involve sending payment data to a payment network to process the in-store payment transaction, the payment data comprising the payment account for the user, a payment receipt account for the merchant, and a payment amount for the in-store payment transaction.

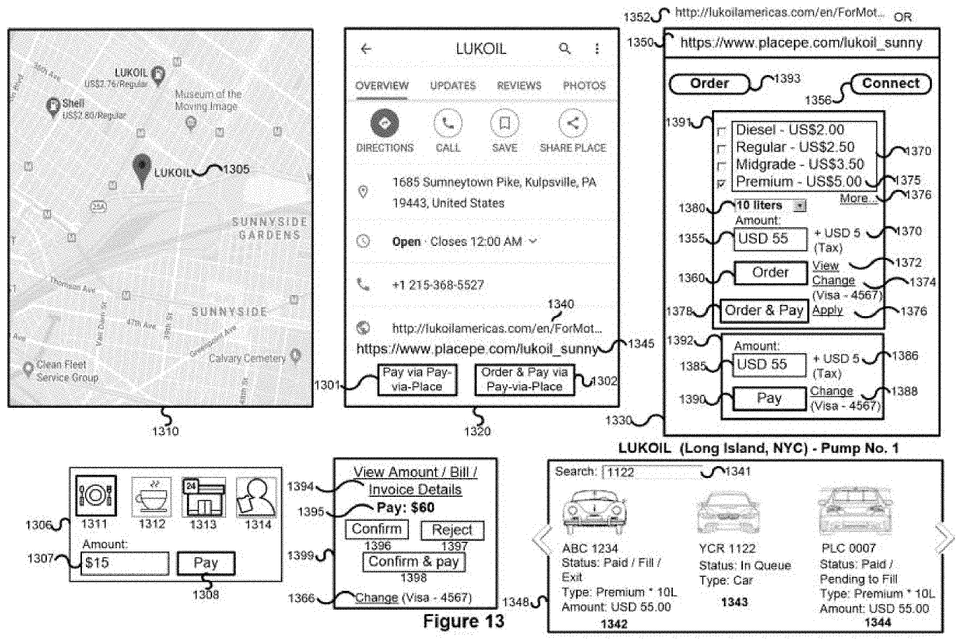

FIG. 13 illustrates graphical user interface of maps application including 3^{rd} parties maps (e.g. Google Maps), wherein user can select place, select current place, select current location of user client device 130 surround place, select place from nearby places, select “patrol pumps” category and select place from displayed nearby patrol pumps. For example in the event of selecting patrol pump 1305 on maps 1310 and in the event of clicking or tapping or inputting or selecting merchant's website uniform resource locator (URL) or web address 1340/1345 or in another embodiment directly inputting or selecting uniform resource locator (URL) 1350 in web browser 282, server 110 module 189 receives request to access said clicked or tapped or selected website uniform resource locator (URL) or web address 1340/1345 associated website or webpage from maps interface 1310 of maps application 281 or browser application 282 of user client device 130 (200). Server 110 module 189 invoking or opening said clicked or tapped or selected website URL or web address associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 1305 on maps 1310 associated integrated button or control 1301/1302, server 110 module 189 receives request to access said clicked or tapped or selected integrated button or control 1301/1302 associated payment user interface or payment flow 1392 or order and payment user interface or order and payment flow 1391.

After opening said website or webpage 1330 user can log-in and in the event of successful login, user can enter amount 1385 and additional charges 1386, select or change and select account 1388 and make payment of said inputted 1385 and additional charge amount 1386 from said logged in identified user's said selected or pre-set or default identified account to said selected place 1305 associated clicked or tapped or selected uniform resource locator (URL) 1340 associated identified merchant's account or said selected place 1305 associated identified merchant's account. After successful payment send payment confirmation message with details including date and time, transaction number, vehicle number, vehicle photo or video, vehicle type (e.g. Bentley car), vehicle color (e.g. white), user or customer name, photo or video or profile photo, profile details, amount, notes provided by user, type of account, applied promotion, coupon code, gift card, reward point or redeemable points, store credit, and used payment method to both user client application 290 and merchant client application 390. So merchant or authorized staff can view vehicle number and after filling or patrol or provided services or products, confirm whether payment received or not.

In another embodiment in the event of clicking or tapping or selecting said selected place 1305 integrated button or control 1302 or on said displayed webpage 1330 embedded or integrated order button or control 1393, displaying order and payment user interface 1391. User can select item 1375 from list 1370 of offered or available products (brands of patrols, diesels, oils, food products, car accessories and like) and services (car wash, car maintenance, car repair and like) and select quantity or volume 1380. User can order particular amount equivalent patrol or diesel or selected item. User can also select particular pump number. In the event of selecting item 1375 from list 1370 and quantity or volume 1380, displaying total amount 1355 and additional charges (e.g. tax) 1370 and enable to make order 1360 and pay after fill or make order and make payment of said inputted 1355 and additional charge amount 1370 from said logged in identified user's said selected or pre-set or default identified account to said selected place 1305 associated clicked or tapped or selected uniform resource locator (URL) 1340 associated identified merchant's account or said selected place 1305 associated identified merchant's account. After successful payment or order or order and payment, sending order details and associated reference number or sending order details including user vehicle number, vehicle photo and other vehicle identification information, user name, photo, identity, item name, quantity or volume and payment details including amount, type of account, tax & tips and associated reference number to user 101 on user client application 290 of user client device 130 (200) and to said merchant 102 on merchant client application 390 of merchant client device 175 (300). Merchant or authorized staff 102 can see car number and select from displayed list, user based on said car number and can fill patrol, provide services (car wash, maintenance, servicing as per contract, repair and like) and provide products (e.g. oil, car accessories, tea, coffee, snacks, water, and ordered products) as per order and after filling, providing services and products, manually set status including filling as per order done, particular service as per order provided, and product(s) as per order provided. If payment is not done then send request from merchant client application 290 to user client application 390 to first make payment and then fulfil order or first fulfil order and then send request from merchant client application 290 to user client application 390.

In an embodiment automatically connect said user 101 user client application 290 of user client device 130 (200) with said place associated merchant application 390 of merchant client device 175 (300) based on sufficiently matching location of said user's monitored and tracked user client device 130 (200) with said selected place 1305 on maps 1310 associated identified location or selected place 1305 on maps 1310 associated URL 1340 associated location or selected place 1305 on maps 1310 associated location, wherein location of place of business comprises geo-coordinates, pointer on map, address, geocodes and pre-defined geofence on maps associated with said selected place on map associated identified merchant. So automatically connect user application 290 with merchant application 390 only when user 101 or user client device 130 (200) enters and dwell into said selected place on map associated merchant's offline store or location of place of business or pre-defined or pre-drawn geofence of said selected place on map associated merchant. In an embodiment connected merchant 102 client application 390 associated merchant user interface (UI) 1348 displaying connected user and associated vehicle details 1342/1343/1344 including arriving or arrived or entered or dwell vehicles/user in merchant's place of business location or pre-defined geofence or identified or determined geofence or ranges of location (particular number of radius surround place of business location) and associated details including vehicle number, vehicle type (e.g. car), vehicle image or photo, user name, photo, identity, status including arriving or arrived or entered or waiting in queue for particular duration, ordered, paid, pending to fill, fill, exited, order details including item name, quantity or volume, payment details including amount, account type, tax, tip and payment status including payment pending or done or payment requested, or confirm or accept or reject) within geofence associated with place 1305.

In the event of exiting from location or geofence of said selected place on map associated place or place of business (e.g. store, shop, hotel, patrol pump, parking, toll, and like), automatically disconnect said user client application 290 from said merchant client application 390. In other embodiment user 101 can select connect button or control 1356 from displayed selected place associated user interface 1330 of user client device 130 (200) to send request to connect said selected place associated identified merchant client application 390 to server device(s) 100 module 193. Server device(s) 100 module 193, send said request to merchant client application 399 (390) on merchant client device 175 (300). In an embodiment based on settings provided by merchant 102 though merchant client application 390, automatically connect received request to connect from user client application 290 of user client device 130 (200). In another embodiment merchant can view received request or view received request with associated purpose to connect, requirement, task, required action detail and accept or reject request by selecting accept or reject button or ignore request or schedule connection. In another embodiment in the event of selecting of place 1305 on maps 1310 and selecting associated webpage or website uniform resource locator (URL) 1340 or 1345 or selecting place 1305 on maps 1310 and select order and payment button or control 1302 and ordering of selected products or services 1375 from list 1391 from user interface 1330 of user client application 290 of user client device 130 (200) then automatically connect said user or customer 101 with said selected place associated identified merchant 101 client application 390.

In an embodiment user can manually order at patrol pump (e.g. “Premium 10 liters”) and after filing of patrol as per order, merchant can prepare bill or invoice 1396 or total billed amount 1395 and send to said connected user's user client application 290 (200) on user interface 1399. User 101 can view received bill or invoice 1394 or total billed amount 1395 and can confirm 1396 or reject 1397 or confirm and pay 1398 or request to revise or update or change. After accepting, confirming and making payment, sending and/or displaying payment confirmation notification or message to user client device 130 (200) on user client application 290 and merchant client device 175 (300) on user client application 390.

In an embodiment after fulfillment of delivery or manually receiving of instruction from user or merchant to disconnect or exiting from pre-defined geofence of said place of business, automatically disconnect user from said connected merchant.

In another embodiment user can select sub-place (1311-1314) 1306 within location or pre-defined or determined geofence of said selected place 1305 on maps 1310 and can enter amount 1307 and make payment 1308 from user's account to said selected sub-place 1311 associated merchant's account or said selected place 1305 associated URL 1340/1345 associated or selected place 1305 associated merchant's account. In an another embodiment user can make order by selecting from said selected sub place associated menu or products catalogue 1370 and make order 1360 or order and payment 1378 as discussed above, so based on user name, photo, car number and photo merchant's staff or authorized person can identify person or person inside car from list of orders displayed in merchant client application 390 and provide ordered products and services and manually set status. In another embodiment user can manually make order and enable user to connect or automatically connect user with said selected sub-place 1311 within said selected place 1305 location or geofence, so sub-place associated authorized user or staff (pre-set rights to access merchant's application) can prepare bill as per manual order and send or push or present bill or invoice 1394 or total bill 1395 from merchant client application 390 to user interface 1399 of user's client application 290 and enable user to accept, confirm and make payment 1398 or reject 1397 or send request to update bill.

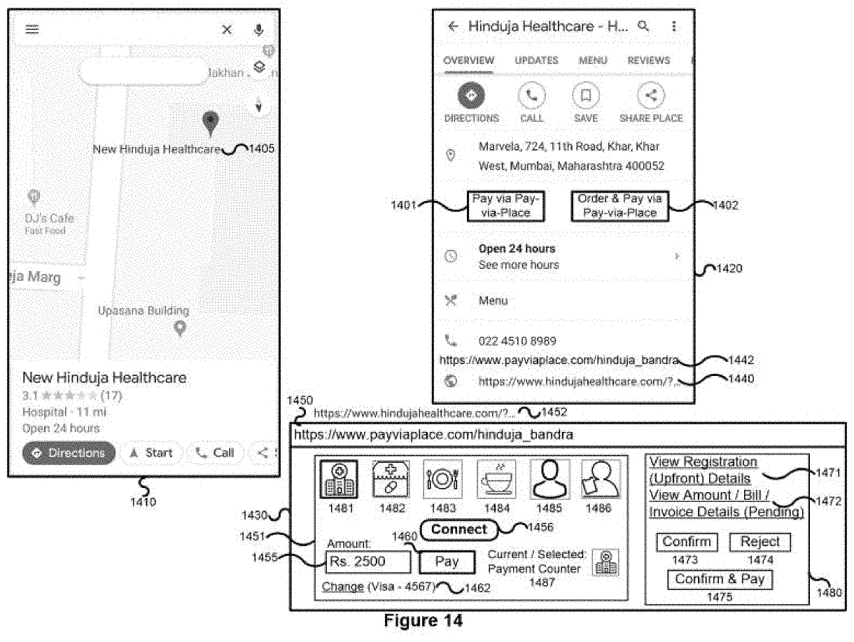

FIG. 14 illustrates graphical user interface of maps application including 3^{rd} parties maps (e.g. Google Maps), wherein user can select place, select current place, select current location of user client device 130 surround place, select place from nearby places, select “Hospitals and clinics” category and select place from displayed nearby hospitals or clinics. For example in the event of selecting hospital 1405 on maps 1410 and in the event of clicking or tapping or inputting or selecting merchant's website uniform resource locator (URL) or web address 1440 or 1442 or in another embodiment directly inputting or selecting uniform resource locator (URL) 1450 in web browser 282, server 110 module 189 receives request to access said clicked or tapped or selected website uniform resource locator (URL) or web address 1440 or 1442 associated website or webpage from maps 1410 or from selected place details interface 1420 of maps application 281 or from browser application 282 of user client device 130 (200). Server 110 module 189 invoking or opening said clicked or tapped or selected website uniform resource locator (URL) or web address 1442/1440 associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 1405 on maps 1410 associated integrated button or control 1401/1402, server 110 module 189 receives request to access said clicked or tapped or selected integrated button or control 1401/1402 associated payment user interface or payment flow 1430 (151) or pushed bill or invoice or amount for requesting payment user interface or payment flow 1480.

After opening said website or webpage 1430 user can log-in and in the event of successful login, user can enter amount 1455 and additional charges, select or change and select account 1462 and make payment of said inputted 1455 and additional charge amount from said logged in identified user's said selected or pre-set or default identified account to said selected place 1405 associated clicked or tapped or selected uniform resource locator (URL) 1440 or 1442 associated identified merchant's account or said selected place 1405 associated identified merchant's account. After successful payment send payment confirmation message with details including date and time, transaction number, patient identity number, photo or video, type or patient or account, profile details, amount, notes provided by user, type of account, applied promotion, coupon code, gift card, reward point or redeemable points, hospital credit, type, name & number of insurance policy or plan, and used payment method to both user client application 290 and merchant client application 390.

In an embodiment automatically connect said user 101 user client application 290 of user client device 130 (200) with said place associated merchant application 390 of merchant client device 175 (300) based on sufficiently matching location of said user's monitored and tracked user client device 130 (200) with said selected place 1405 on maps 1410 associated identified location or selected place 1405 on maps 1410 associated URL 1440/1442 associated location or selected place 1405 on maps 1410 associated location, wherein location of place of business comprises geo-coordinates, pointer on map, address, geocodes and pre-defined geofence on maps associated with said selected place on map associated identified merchant. So automatically connect user application 290 with merchant application 390 only when user 101 or user client device 130 (200) enters and dwell into said selected place on map associated merchant's offline location or place of business of said selected place on map associated merchant.

In other embodiment user 101 can select connect button or control 1456 from displayed selected place associated user interface 1430 of user client device 130 (200) to send request to connect said selected place associated identified merchant client application 390 to server device(s) 100 module 193. Server device(s) 100 module 193, send said request to merchant client application 399 (390) on merchant client device 175 (300). In an embodiment based on settings provided by merchant 102 though merchant client application 390, automatically connect received request to connect from user client application 290 of user client device 130 (200). In another embodiment merchant can view received request or view received request with associated purpose to connect, requirement, task, required action detail and accept or reject request by selecting accept or reject button or ignore request or schedule connection.

In an embodiment user needs to register with the hospital by filing displayed form, submit required documents and making payment of registration fees and up-front or deposit amount. In the event of filling form, submitting required documents and making payments of registration fees and required deposits 1455, authorized user(s) of connected merchant application can view received request including user name, photo(s) or video(s) and filled registration form and submitted required documents and can verify said received registration form and submitted required documents from said connected user client application 290 (200) and provide physical or virtual hospital card to said identified user by authorized staff of said hospital. In an embodiment logged in user od said website or webpage 1430 can view pending bills, invoice, dues, prescribed past present medicines or tests, past and present reports (verified or not verified by relevant hospital doctor(s), virtual card, virtual entry pass, notifications, messages and like. In an embodiment logged-in user view received bill(s) and click or tap on confirm 1473 or reject 1474 or request to update with details or confirm and make payment said billed amount 1475.

In an embodiment user from user client application 290 (200) or merchant or authorized staff of merchant client application 390 (300) can update and view said registered patient associated profile & information including floor and room number, associated doctor number, name and profile, associated prescribed medicines and tests, reports, pending dues, bills and invoices, logs, list of used supplies, nursing care, equipment, nutritional services and any services provided outside doctor(s), requests to pay the outstanding at appropriate time as suggested by the billing department, payments made by user. Upon complete treatment and doctor's advice to discharge the patient, a discharge activity sheet is received, rechecked and evaluated for the final billing and clearance from various departments will be taken and final bill is provided to the patient, so patient can pays the bill directly from user 101 client application 290 of user client device 130 (200). User can view daily schedule food prescribed by dietician and can update or add food or user can order food from displayed hospital restaurant menu and select options including delivery at said patient's room or take way as per schedule date & time or eat at restaurant.

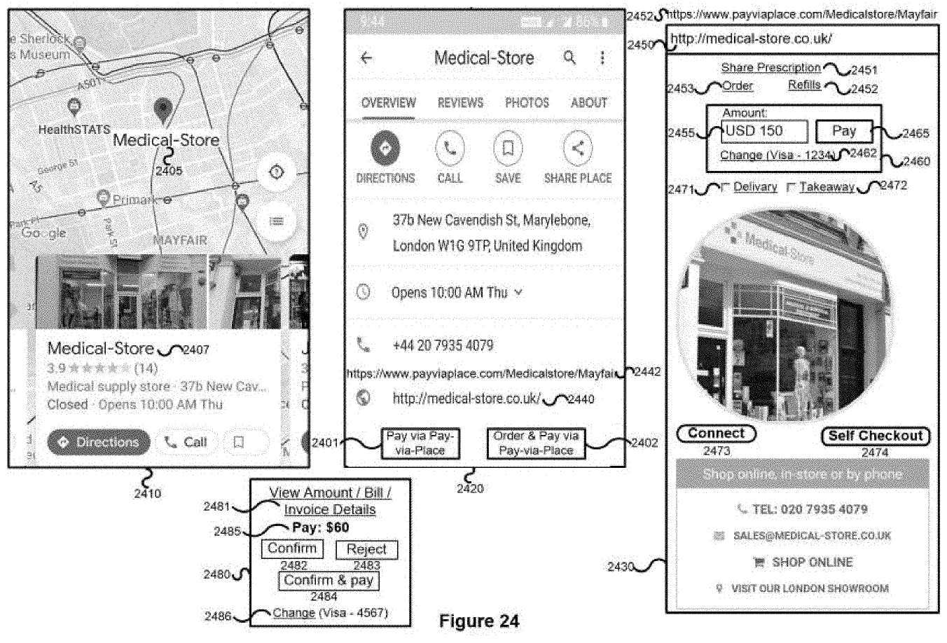

In an embodiment logged in user can view and select hospital account or payment counter (can select payment counter numbers (if more than one)) 1481 and also view pre-defined sub-places including medical store or pharmacy 1482, restaurant 1483, canteen 1484, nurses 1485, service providers (e.g. food, outside doctor) 1486, car parking, ambulance and like. In an embodiment in the event of selection of hospital account and payment counter icon 1481, user can view pending bills or payments due 1472 and can view bills 1472, confirm bills 1473, make payment of bills 1475 or make payment via insurance company based on valid insurance policy or plan of said patient via linked or integrated system of insurance company. In another embodiment user can select medical store icon 1482 and view prescribed and available medicines at medical store situated in hospital and can make order and make payment and request to deliver medicine at patient room or select takeaway option (as per schedule of user or schedule of medical store or request when medicine ready then inform user to collect). Merchant client application 390 receives and displays said order including prescribed medicine details comprises medicine name, quantity, prescribed doctor name, digital signature, doctor notes or instructions, amount, applied offer, points, store credit, associated and valid insurance policy or plan for making payment or reimbursing payment from said insurance policy associated insurance company, generated bill or invoice, payment details including payment amount, payment method, account type, patient details including patient current room or delivery address, delivery method and option. Authorized users of said merchant client application 390 (medical store staff) can view said details and fulfill order. In another embodiment user can select medical store outside hospital and make order (discussed in detail in FIG. 24). In an embodiment in the event of selection of medical store icon 1482 by said logged in user or reaching near to medical store situated within location or geofence of hospital 1405, automatically connect user client application 290 with said merchant client application 390 and display medical store nearby connected users in merchant client application 390, so authorized user of merchant client application 390 can view user name, photo, identity, prescribed and available medicines details and view order request and collect said prescribed and available medicines, check payment confirmation and fulfill order. In another embodiment user can manually order at medical store and merchant send or present push bill or payment request including bill, invoice or total billed amount 1472 and enable said user to make payment 1475 or enter amount 1455 and make payment 1460. Likewise, user can select restaurant icon 1483 or canteen icon 1484 and make order and make payment. In an embodiment user can select staff icon 1486 and select one or more staff persons and enter tip amount 1455 and make payment 1460 or instruct to distribute equally among said selected staff persons. In an embodiment user can select outside serve provider or select nearby outside serve provider and enter amount 1455 and make payment 1460 and add notes. In another embodiment, authorized outside server provider user of merchant client application 390, can select patient or user and push bill or send request to make billed amount payment 1472, so user can review bill, ask changes, confirm 1473 or reject 1474 or accept bill and make payment 1475.

In another embodiment in the event of non-availability of internet data network or point of sale terminal or payment terminal to accept debit or credit cards payment, user client application 290 of user client device 200 can identify nearby merchant client device 300 via Bluetooth or other communication interface and can transfer fund from selected mobile wallet account of said user to said selected nearby merchant client application associated pre-set mobile wallet or user can use pay later or use pay based on store credit or use redeemable points or vouchers or crypto currencies for making payment.

In an embodiment authorized user(s) of connected merchant client allocation 390 can view detail of nearby patient wherein details including patient and added or associated visitors or members name, photo, video, room number, and status, so security can view details and allow visitor to visit patient.

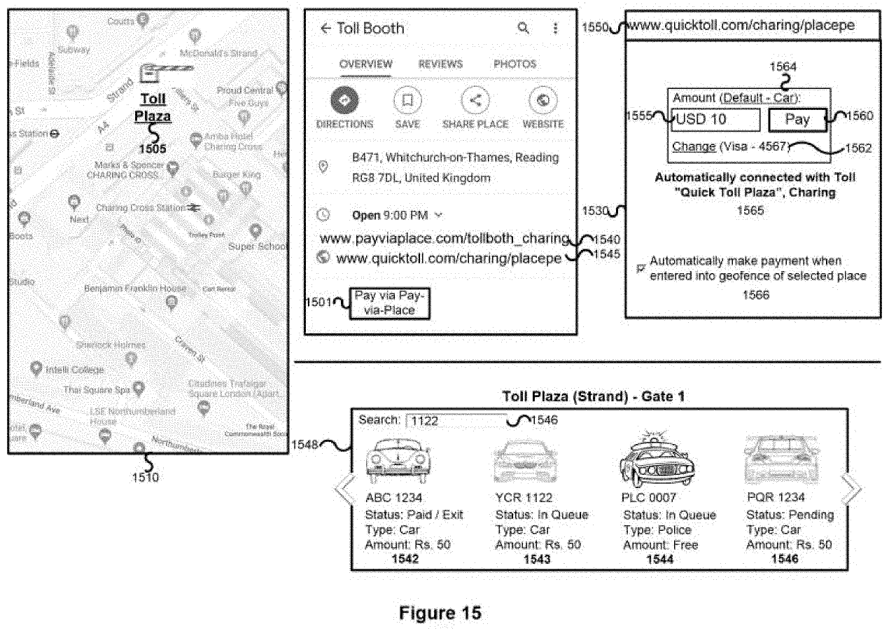

FIG. 15 illustrates graphical user interface of maps application 1510 including 3rd parties maps (e.g. Google Maps), wherein user can select place, select current place, select current location of user client device 130 associated nearby or surround nearest place, select place from displayed or searched nearby places, select “Toll” category and select place from displayed nearby tolls. For example in the event of selecting toll plaza 1505 on maps 1510 and in the event of clicking or tapping or inputting or selecting merchant's website uniform resource locator (URL) or web address 1540/1545 or in another embodiment directly inputting or selecting uniform resource locator (URL) 1550 in web browser 282, server 110 module 189 receives request to access said clicked or tapped or selected website uniform resource locator (URL) or web address 1540/1545 associated website or webpage from maps interface 1510 of maps application 281 or browser application 282 of user client device 130 (200). Server 110 module 189 invoking or opening said clicked or tapped or selected website URL or web address associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 1505 on maps 1510 associated integrated button or control 1501, server 110 module 189 receives request to access said clicked or tapped or selected integrated button or control 1501 associated payment user interface or payment flow.

After opening said website or webpage 1530 user can log-in and in the event of successful login, user can enter amount 1555 and select or change and select account 1562 and make payment of said inputted 1555 from said logged in identified user's said selected or pre-set or default identified account to said selected place 1505 associated clicked or tapped or selected uniform resource locator (URL) 1540/1545 associated identified merchant's account or said selected place 1505 associated identified merchant's account. After successful payment send payment confirmation message with details including date and time, transaction number, vehicle number, vehicle photo or video, vehicle type (e.g. Bentley car), vehicle color (e.g. white), user or customer name, photo or video or profile photo, profile details, amount, notes provided by user, type of account, applied promotion, coupon code, gift card, reward point or redeemable points, credit, and used payment method to both user client application 290 and merchant client application 390. So merchant or authorized staff can view vehicle number and after viewing payment confirmation or receiving payment from said user, allow user or vehicle to pass toll booth or tool plaza or toll. In another embodiment automatically identifying toll charges amount 1555 based on pre-set type of vehicle 1564 and accessing pre-stored and updated vehicle type 1564 specific charges or rate card related to said place 1505. In another embodiment based on settings 1566, in the event of opening website or webpage 1530 by selecting selected place associated uniform resource locator (URL) 1540/1545 or entering uniform resource locator (URL) 1550 in web browser, automatically identify said place associated geofence and automatically make payment of automatically identified amount (based on pre-set vehicle type and said place 15050 associated vehicle type specific charges) from said user's selected or pre-set account to said place 1505 associated merchant's account, wherein automatically identify said place associated geofence based on sufficiently matching location of said user's monitored and tracked user client device 130 (200) with said selected place 1505 on maps 1510 associated identified location or selected place 1505 on maps 1510 associated URL 1540/1545 associated location or selected place 1505 on maps 1510 associated location, wherein location of place of business comprises geo-coordinates, pointer on map, address, geocodes and pre-defined geofence on maps associated with said selected place on map associated identified merchant. In an embodiment camera at toll plaza take photo of vehicle number plate of each passing vehicle from toll plaza and based on object recognition identify vehicle number from said photo and

In an embodiment non-payment of toll tax or toll charges, enable said vehicle to make pending payment within pre-set duration or make pending payment at next at next toll plaza or at next at next toll plaza at next visit.

After successful payment, sending payment confirmation details including vehicle number, vehicle photo or video, other vehicle identification information, user name, photo, identity and payment details including transaction date and time, transaction number amount, type of account, tax and associated reference number to user 101 on user client application 290 of user client device 130 (200) and to said merchant 102 on merchant client application 390 of merchant client device 175 (300). Merchant or authorized staff 102 can see car number and select from displayed list and can allow user to pass toll booth. If payment is not done then send request from merchant client application 290 to user client application 390 to first make payment and then allow vehicle to pass toll booth 1505.

In an embodiment automatically connect said user 101 user client application 290 of user client device 130 (200) with said place associated merchant application 390 of merchant client device 175 (300) based on sufficiently matching location of said user's monitored and tracked user client device 130 (200) with said selected place 1505 on maps 1510 associated identified location or selected place 1505 on maps 110 associated URL 1540/1545 associated location or selected place 1505 on maps 1510 associated location, wherein location of place of business comprises geo-coordinates, pointer on map, address, geocodes and pre-defined geofence on maps associated with said selected place on map associated identified merchant. So automatically connect user application 290 with merchant application 390 only when user 101 or user client device 130 (200) enters and dwell into said selected place on map associated merchant's place (toll) 1505 or location of place of toll of said selected place on map associated merchant. In an embodiment connected merchant 102 client application 390 associated merchant user interface (UI) 1548 displaying connected user and associated vehicle details including arriving or arrived or entered or dwell vehicles/user in merchant's place of business location or pre-defined geofence or identified or determined geofence or ranges of location (particular number of radius surround place of business location i.e. toll 1505) and associated details including vehicle number, vehicle type (e.g. car), vehicle image or photo, user name, photo, identity, status including arriving or arrived or entered or waiting in queue for particular duration, paid, pending to pay, exited and payment status including payment pending or done or payment requested or confirmed or accepted or rejected) within geofence associated with place 1505. In the event of exiting from location or geofence of said selected place on map associated place or place of business (toll) 1505, automatically disconnect said user client application 290 from said merchant client application 390.

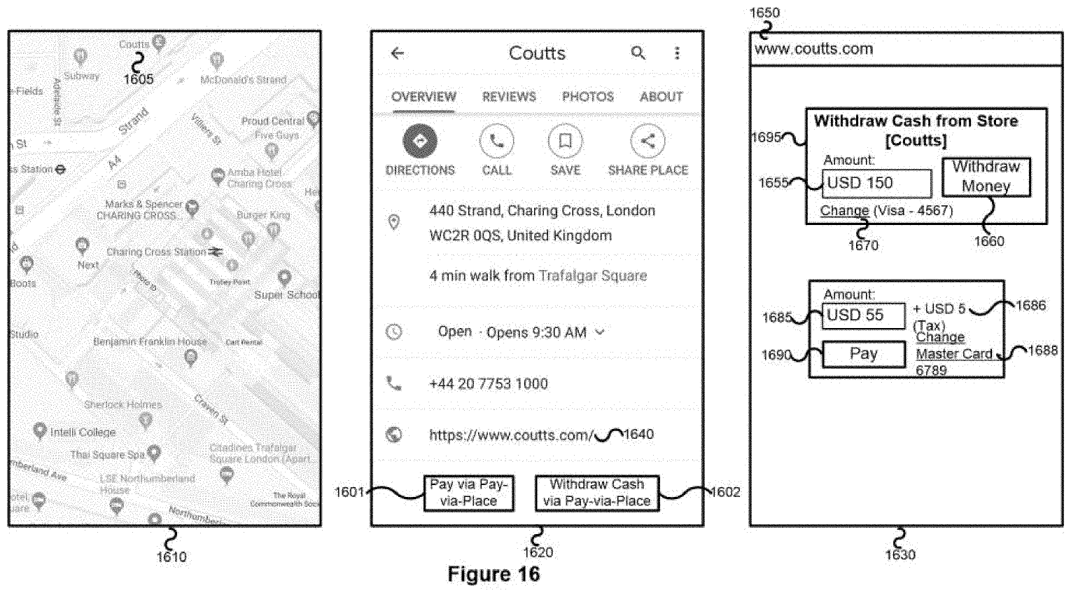

FIG. 16 illustrates graphical user interface of maps application including 3^{rd} parties maps (e.g. Google Maps), wherein user can select place, select current place, select current location of user client device 130 surround place, select place from nearby places, select “ATM or Withdraw Cash” category and select place from displayed nearby stores. For example in the event of selecting place 1605 on maps 1610 and in the event of clicking or tapping or inputting or selecting merchant's website uniform resource locator (URL) or web address 1640 or in another embodiment directly inputting or selecting uniform resource locator (URL) 1650 in web browser 282, server 110 module 189 receives request to access said clicked or tapped or selected website uniform resource locator (URL) or web address 1640 associated website or webpage from maps interface 1610 of maps application 281 or browser application 282 of user client device 130 (200). Server 110 module 189 invoking or opening said clicked or tapped or selected website URL or web address associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 1605 on maps 1610 associated integrated button or control 1601/1602, server 110 module 189 receives request to access said clicked or tapped or selected integrated button or control 1601/1602 associated payment user interface or payment flow 1695.

After opening said website or webpage 1630 user can log-in and in the event of successful login, user can enter amount 1655 and use pre-set or change account 1670 and make payment of said inputted 1655 amount from said logged in identified user's said selected or pre-set or default identified account to said selected place 1605 associated clicked or tapped or selected uniform resource locator (URL) 1640 associated identified merchant's account or said selected place 1605 associated identified merchant's account. After successful payment, sending payment confirmation message with details including date and time, transaction number, amount, user name, photo, request to need cash or cash in particular requested currency or currency related to particular country in exchange of said paid amount 1655, link of terms & conditions to enable to agree said terms & conditions to said place 1605 associated merchant, so merchant can verify details and provide said received amount equivalent cash money or cash money in said requested currency or currency related to particular country based on current rate of said currency in said received amount currency, charges and other fees.

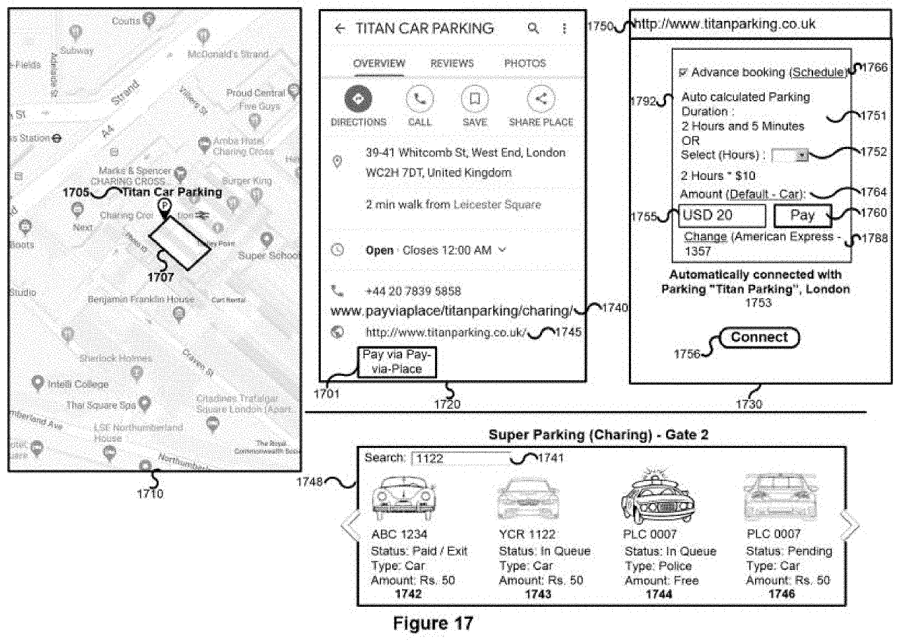

FIG. 17 illustrates graphical user interface of maps application including 3^{rd} parties' maps (e.g. Google Maps), wherein user can select place, select current place, select current location of user client device 130 surround place, select place from nearby places, select “Parking” category and select place from displayed nearby parking. For example in the event of selecting parking place 1705 on maps 1710 and in the event of clicking or tapping or inputting or selecting merchant's website uniform resource locator (URL) or web address 1740/1745 or in another embodiment directly inputting or selecting uniform resource locator (URL) 1750 in web browser 282, server 110 module 189 receives request to access said clicked or tapped or selected website uniform resource locator (URL) or web address 1740/1745 associated website or webpage from maps interface 1710 of maps application 281 or browser application 282 of user client device 130 (200). Server 110 module 189 invoking or opening said clicked or tapped or selected website URL or web address associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 1705 on maps 1710 associated integrated button or control 1701, server 110 module 189 receives request to access said clicked or tapped or selected integrated button or control 1701 associated payment user interface or payment flow 1792.

After opening said website or webpage 1730 user can log-in and in the event of successful login, user can enter amount 1755 and additional charges or tips, select or change and select account 1788 and make payment of said inputted 1755 and additional charge amount from said logged in identified user's said selected or pre-set or default identified account to said selected place 1705 associated clicked or tapped or selected uniform resource locator (URL) 1740 associated identified merchant's account or said selected place 1705 associated identified merchant's account. After successful payment send payment confirmation message with details including date and time, transaction number, vehicle number, vehicle photo or video, vehicle type (e.g. Bentley car), vehicle color (e.g. white), user or customer name, photo or video or profile photo, profile details, amount, notes provided by user, type of account, applied promotion, coupon code, gift card, reward point or redeemable points, parking credit, and used payment method to both user client application 290 and merchant client application 390. So merchant or authorized staff can view vehicle number and identify whether payment received or not and in the event of payment confirmation, allow vehicle to exit from parking.

In an embodiment automatically connect said user 101 user client application 290 of user client device 130 (200) with said place associated merchant application 390 of merchant client device 175 (300) based on sufficiently matching location of said user's monitored and tracked user client device 130 (200) with said selected place 1305 on maps 1310 associated identified location or selected place 1705 on maps 1710 associated URL 1740/1745 associated location or selected place 1705 on maps 1710 associated location, wherein location of place of business comprises geo-coordinates, pointer on map, address, geocodes and pre-defined geofence on maps associated with said selected place on map associated identified merchant. So automatically connect user application 290 with merchant application 390 only when user 101 or user client device 130 (200) enters and dwell into said selected place 1705 on map associated merchant's offline store or location of place of business or pre-defined or pre-drawn geofence 1707 of said selected place 1705 on maps 1710 associated merchant 102.

In other embodiment user 101 can select connect button or control 1756 from displayed selected place associated user interface 1730 of user client device 130 (200) to send request to connect said selected place associated identified merchant client application 390 to server device(s) 100 module 193. Server device(s) 100 module 193, send said request to merchant client application 399 (390) on merchant client device 175 (300). In an embodiment based on settings provided by merchant 102 though merchant client application 390, automatically connect received request to connect from user client application 290 of user client device 130 (200). In another embodiment merchant can view received request or view received request with associated purpose to connect, requirement, task, required action detail and accept or reject request by selecting accept or reject button or ignore request or schedule connection. In another embodiment in the event of selecting of place 1705 on maps 1710 and selecting associated webpage or website uniform resource locator (URL) 1740 or selecting place 1705 on maps 1710 and select advance booking and provide schedule date and time for booking 1766 and calculate parking charges based on number of hours booked, type of vehicle and type of vehicle associated per hour or type of duration specific charges and enable to make payment via clicking or tapping on pay button or control 1760 from user interface 1730 of user client application 290 of user client device 130 (200) then automatically connect said user or customer 101 with said selected place associated identified merchant 101 client application 390.

In an embodiment connected merchant 102 client application 390 associated merchant user interface (UI) 1748 displaying connected user and associated vehicle 1742/1743/1744/1746 details including arriving or arrived status and displaying on map (based on advance booking or advance scheduled booking) or entered or dwell vehicles/user in merchant's place of business location or pre-defined geofence 1707 or identified or determined geofence 1707 or ranges of location (particular number of radius surround place of business location) and associated details including vehicle number, vehicle type (e.g. car), vehicle image or photo, user name, photo, identity, status including arriving or arrived or entered or waiting in queue for particular duration, pre-booked, paid, pending to pay, exited, booking details including schedule date and time and number of hours, payment details including amount, account type, tax, tip and payment status including payment pending or done or payment requested or confirm or accept or reject) within geofence 1707 associated with place 1705.

In an embodiment after automatically or manually connecting user client application 290 with the merchant client application 390 and registering entered vehicle in the parking place 1705 by displaying said details on connected merchant client application 390 and in the event of detecting entered vehicle (e.g. 1742/1743/1744/1746) inside said parking place 1705 and dwelling for pre-set duration automatically start timer or start time as per scheduled or re-scheduled date and time 1751/1752.

In the event of exiting from location 1705 or geofence 1707 of said selected place on map associated place or place of business (e.g. parking 1707), at exit gate authorized staff or user of connected merchant client application 390 of parking place 1705 can identify and select exited vehicle based on vehicle number, vehicle photo or video or 3D graphics, vehicle type, vehicle color, person name, photo or video in displayed list of vehicles in connected merchant client application 390. User client application 290 and merchant client application 390 can view schedule start and end date & time, additional number of hours (if any) and enable to make payment for additional hours by selecting number of additional hours 1752, entering additional hours charges amount 1755 and selecting or clicking or tapping pay button or control 1760, view payment confirmation status (for scheduled booking as well as additional hours) or view calculated hours 1751 charges 1755 based on start time, end time or current time or manually stopped timer by authorized staff or user of merchant client application 390, type of vehicle and type of vehicle associated duration (e.g. hour) specific charges and based on settings automatically make payment as per calculated charges amount 1755 from user selected or pre-set or updated account 1788 to said selected place 1705 or selected place 1705 associated clicked URL 1740/1745 or associated merchants account or manually enabling user to make payment as per calculated charges amount 1755 by selecting or clicking or tapping pay button or control 1760 from user selected or pre-set or updated account 1788 to said selected place 1705 or selected place 1705 associated clicked URL 1740/1745 or associated merchants account. After successful payment, sending payment confirmation to both user client application 290 and merchant client application 390. In the event of exiting from location 1705 or geofence 1707 of said selected place on map associated place or place of business (e.g. parking 1707), automatically disconnect said user client application 290 from said merchant client application 390. In the event of non-making of payment and exiting parking send payment request from merchant client application 390 to said user client application 290 and enable user to make pending or requester o calculated payment. In the event of user mobile device 130 (200) is not working or OFF the enable user to manually make payment by manually viewing calculated charges in merchant's client application 390 or log in in another device and view calculated amount and make payment.

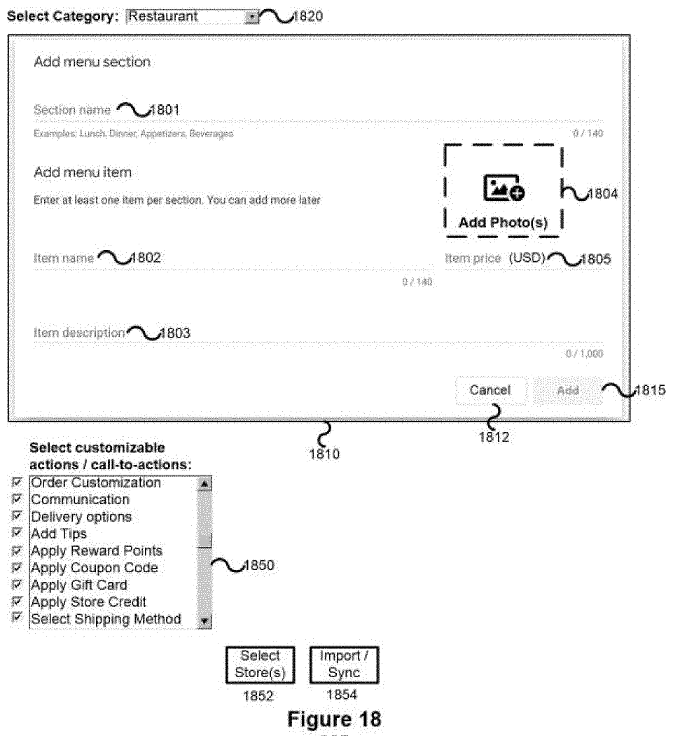

With reference to FIG. 18, the merchant client device 175/300 includes a client application 390 (394) that allows a merchant 102 to view, add, remove, update and manage list of products and services associated details 1810, wherein details may comprises section name 1801, item name 1802, item description 1803, one or more photos or videos or images 1804, item price 1805. In an embodiment merchant can save and store said items details in merchant's website server database, 3rd parties cloud storage or server 110 database 115. In an embodiment allow a merchant to import or import in standardized format or synchronize including push, pull, snapshot, merge synchronization and link said details from linked inventory management system and inventory database.

Some embodiments described herein include the ability to present a consistent user experience across all category's places at all locations or multi branch or multi store businesses. Accordingly, a consistent set of product data can be created and managed. This is especially challenging since locations and/or individual store can be managed by different merchants or companies using different product naming conventions and different product ID numbers within their system. In an embodiment a master product table can be created that associates a uniform set of product data to individual store product tables, which use different naming conventions and other different fields for product data. The master product table associates a master product ID to a saved product image, information, a product category, description, name, etc. for use and/or display. The server module 188 saves and updates said master product details and tables. Merchant can create, upload, and/or change (e.g., via a web app) a merchant product table for use. A merchant can select a master product ID from a pick list for each product in the merchant product table. This, in turn, associates the products in the merchant table with the products in the master product table. Merchant table, in turn, provides product data such as price, current quantity, etc. to a table.

In the event of selection of category 1820 by authorized user of merchant client application 390, serer module 188 displays said category specific form or user interface 1810 or enabling to add or update products, menu items, services and associated details. A method for creating a master product table and relating it to individual operator product tables comprises enable merchant to select category and sub-category 1820 and in the event of adding section name or item name or item description or item photo or item price automatically fill or show auto fill list by server module 188 from server 110 database 115 for enabling merchant to easily select or add or update or suggest product and product details and save said added products or menu item details 1815 and create catalogue of products, menu items and services from said selected category 1820 specific provided templates or auto fills provided by server module 188. In an embodiment multi store merchant can select one or more or all stores 1852 and associate said selected store(s) with said added product 1810. In another embodiment merchant can import or synchronize product details from inventory management software or linked database(s) or from one or more sources 1854 and map with master tables provided by server module 188 from server database 115 to quickly create standardized product catalogue. In the event of non-availability of added product or service or menu item in master table, merchant from merchant client application 390 can suggest products or services or menu items and associated details to server module 188, wherein server admin can verify details and make them available for all other stores related to said newly suggested, verified and added product or service or menu item related category.

In another embodiment after creating products or menu items and/or services catalogue(s), merchant can create or customize and generate webpage or web application or user interface 1930 for enabling customers to search, browse, view and select one or more products or menu items or services, add to cart, select order customization options, select delivery options, make order, use deferent types of payment methods and make payment, view payment confirmation, order status, access communication applications and call-to-actions. Merchant can create customize product catalogue and user interface for enabling customer to view, search, browse products, menu items and services, provide customized order features, options and user interface, provide customized communication, ordering, payment, billing, notification services, user interfaces, call-to-actions and options. Merchant can select and customize one or more parts of products, menu items and services catalogue, communication, ordering, payment, billing, notification, user actions or call-to-actions 1850 including select and customize communication options, notification options and services, one or more types of user interfaces, applications, forms, widgets, web parts, payment methods and options, order methods and options, billing and invoice options, reports and analytics options, catalogue presentation options, and other features including Order Customization, Communication, Delivery options, Add Tips, Apply Reward Points, Apply Coupon Code, Apply Gift Card, Apply Store Credit, Select Shipping Method and like.

In an embodiment Server 110 facilitates domain or category specific merchant to directly accept order and payments from existing and new customers without any middlemen including 3^{rd} parties search engine and 3^{rd} parties order, booking, payment and reservation service providers. There is no need to develop, host, manage and market web or smart applications. User can get standardized products & services catalogues or menu, payment user interface and payment flow and order interface and order flow. User can bookmark purchased products, menu items and services and can use in any other store related to particular category. User can view standardized logs and reports including payment transactions, orders and purchases, price, price, date and time, accompanied contacts and like for enable user to remember liked products or services, compare prices, negotiate, participate in deal, view associated reactions and notes, share with other stores for order again and like.

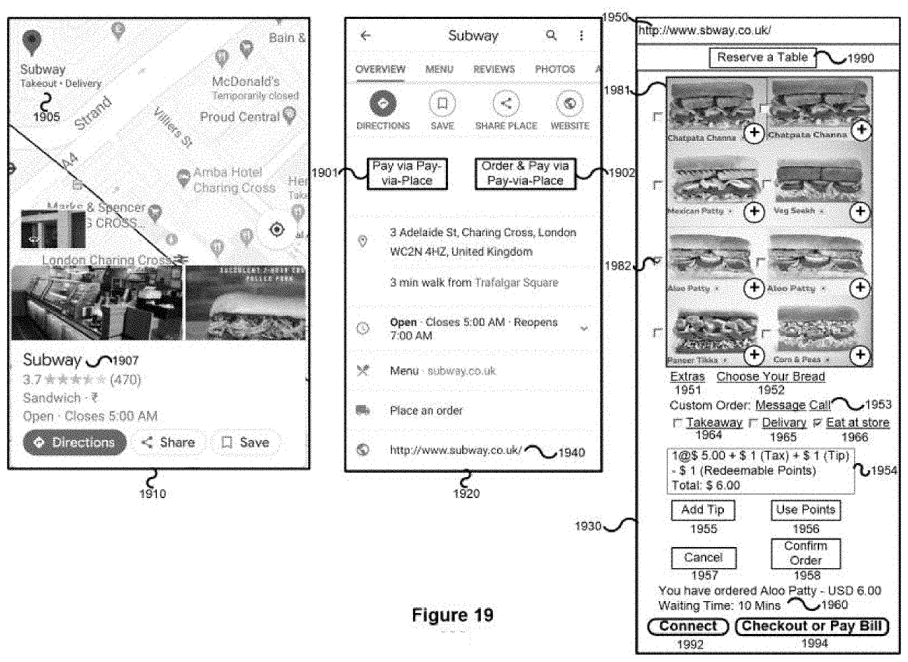

After creating and updating products catalogue, menu or service catalogue, merchant can make available said products catalogue, menu or service catalogue to customers of merchant's one or more stores or places or places of business. FIG. 19 illustrates maps application graphical user interface 1910 wherein in the event of selecting place (e.g. 1905) on maps 1910 and selecting or clicking or tapping on uniform resource locator (URL) 1940 or place 1905 integrated or place 1905 associated place detail user interface 1920 integrated button 1901/1902, invoking or opening said clicked uniform resource locator (URL) 1940 associated webpage or website or user interface 1930 and enable said user or customer to search, browse and view said catalogue added and updated by merchant, select one or more products or services or menu items 1982, customize order 1951/1952, ask queries via communication applications 1953 added by said merchant, select order option including takeaway (schedule or wait at store —order from said catalogue 1930 and make payment or order manually and make payment by confirming pushed bill or by selecting selected place associated URL and entering amount, selecting payment account and making payment from opened payment webpage) 1964, delivery (online order and instruct to deliver at particular selected address or order remotely via phone or message and make payment by confirming pushed bill or by selecting selected place associated URL and entering amount, selecting payment account and making payment from opened payment webpage) and eat at store (advance order from said catalogue 1930 or order manually at store and make payment by confirming pushed bill or by selecting selected place associated URL and entering amount, selecting payment account and making payment from opened payment webpage) 1966, view bill or invoice or totaled bill amount 1954, add tips 1955, use points 1956 for payments, view order details 1960, reserve table 1990 and make payment or confirm and pay billed amount 1994. To get bill directly from merchant client application, first user needs to connect 1992 user client application with the merchant client application and get or receive bill or total billed amount from the merchant client application to pay bill 1994.

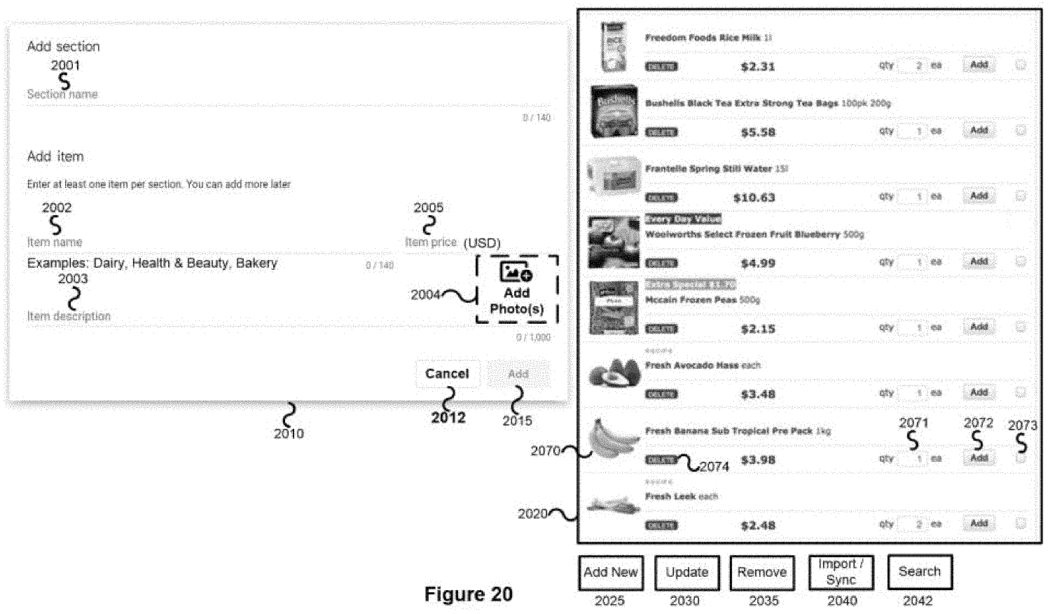

With reference to FIG. 20, the merchant client device 175/300 includes a client application 390 (394) that allows a merchant 102 to view, add, remove, update and manage list of products and services associated details 2010 from server device(s) 110 provided category specific or type of store specific standardized user interface, wherein details may comprises section name 2001, item name 2002, item description 2003, one or more photos or videos or images 2004, item price 2005. In an embodiment merchant can save 2015 and store said items details in merchant's website server database, 3rd parties cloud storage or server 110 database 115. In an embodiment allow a merchant to import or synchronize including push, pull, snapshot, merge synchronization and link 2040 said details from linked inventory management system and inventory database. Merchant can view 2020, search 2042, browse 2020 and select 2073 one or more said added products details and can take one or more actions or group actions including add new 2025 products, update 2030 selected product details, remove 2035 selected product(s) from list. In another embodiment merchant can link, integrate and import or import in standardized format and synchronize 2040 added products details from/to inventory management system and database. Merchant can select from tap or click on list item 2070 and update details, add or update offer including discount, view inventory and sales statistics. Merchant can add available quantity 2071/2072.

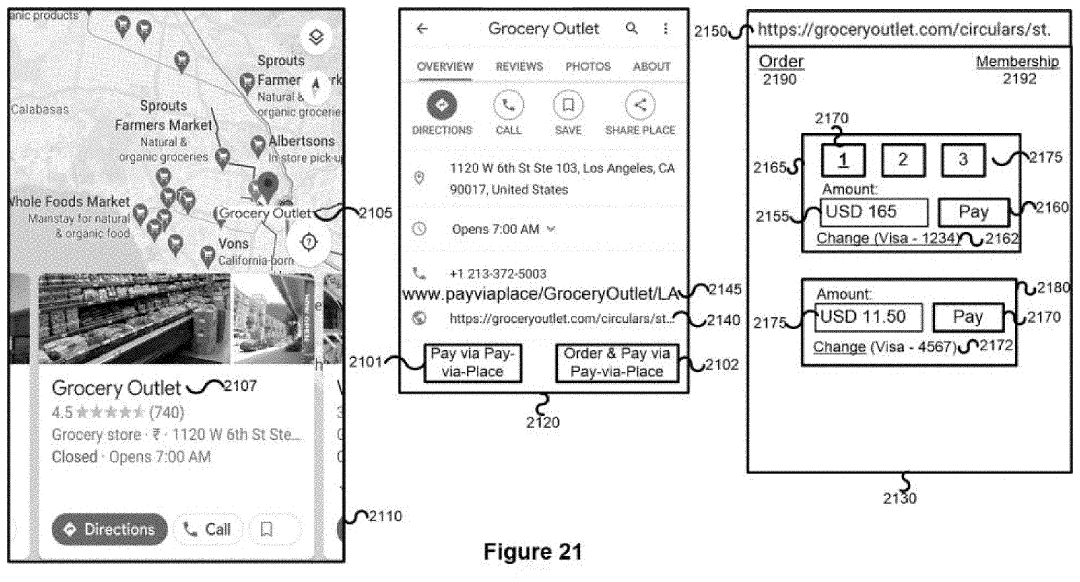

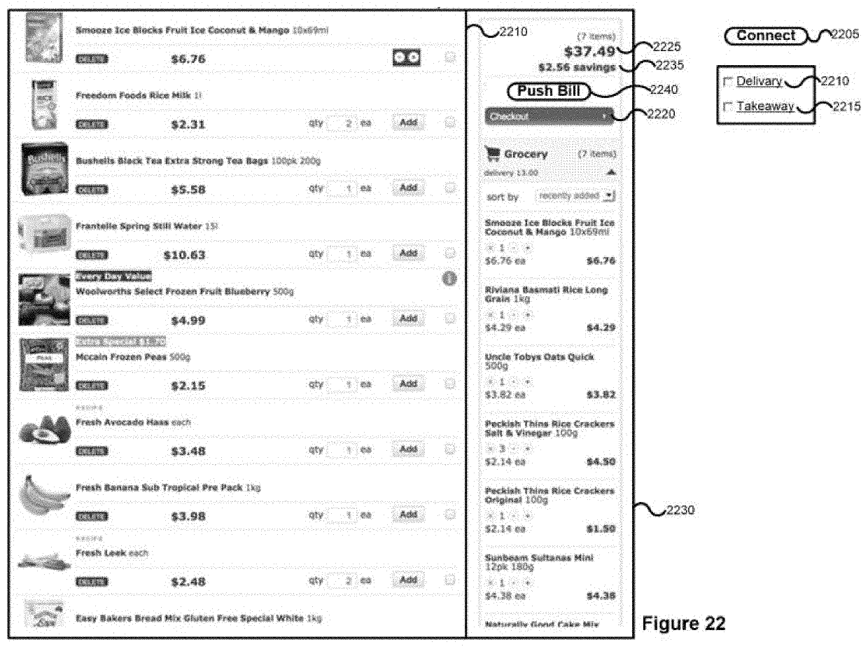

FIG. 21 illustrates graphical user interface of maps application including 3^{rd} parties maps (e.g. Google Maps online or mobile application), wherein user can select place, select current place, select current location of user client device 130 surround place, select place from nearby places, select “Groceries” category and select place from displayed nearby grocery stores. For example in the event of selecting particular grocery store 2105 on maps 2110 and in the event of clicking or tapping or inputting or selecting merchant's website uniform resource locator (URL) or web address 2140/2145 or in another embodiment directly inputting or selecting uniform resource locator (URL) 2150 in web browser 282, server 110 module 189 receives request to access said clicked or tapped or selected website uniform resource locator (URL) or web address 2140/2145 associated website or webpage from maps interface 2110 of maps application 281 or browser application 282 of user client device 130 (200). Server 110 module 189 invoking or opening said clicked or tapped or selected website URL or web address associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 2105 on maps 2110 associated integrated button or control 2101/2102, server 110 module 189 receives request to access said clicked or tapped or selected integrated button or control 2101/2102 associated payment user interface or payment flow 2165/2180 and/or order and payment user interface or order and payment flow FIG. 22.

After opening said website or webpage 2130 user can log-in and in the event of successful login, user can select counter number 2170 from displayed list of counter numbers 2175, enter amount 2155 and add or select additional charges, select or change and select account 2162 and make payment of said inputted 2155 and added or selected additional charge amount from said logged in identified user's said selected or pre-set or default identified account to said selected place 2105 associated clicked or tapped or selected uniform resource locator (URL) 2140 or 2145 associated identified merchant's account or said selected place 2105 associated identified merchant's account. After successful payment, user client application 290 and merchant client application 390 receives payment confirmation message with details including date and time f transaction, transaction number, user identity, user or customer name, photo or video or profile photo, profile details, amount, notes provided by user, type of account, applied promotion, coupon code, gift card, reward point or redeemable points, store credit, and used payment method. So merchant or authorized staff can view and confirm that payment received from particular customer.

In another embodiment user can select or tap or click on order and payment button or control or link 2190 and can view order webpage or user interface (FIG. 22) and can select one or more products 2210 and can select delivery option 2220 and make payment of total billed amount 2225 via tapping or clicking on checkout or pay button 2220 and instruct to deliver said product at user provided or selected shipping or delivery address or select takeaway option 2215 to collect from store or collection center as per schedule date and time and address provided by said selected place associated seller or merchant or make payment 2125 after collecting of said ordered products and services 2210 from store or collection center as per schedule date and time and address provided by said selected place associated seller or merchant.

In another embodiment in the event of selecting of current location associated place on maps or search nearby places or search category specific nearby places and select place or select current place 2105 on maps 2105 and selecting or tapping or clicking said selected place associated or displayed website or webpage uniform resource locator (URL) 2140/2145 or selecting or tapping or clicking on order and payment button or control 2102 by user 101 from client device 130 (200), invoking or opening or displaying webpage or user interface 2130 and enable user to click or tap on order link or button or control 2190 to make and in an embodiment automatically connect said user 101 user client application 290 of user client device 130 (200) with said place associated merchant application 390 of merchant client device 175 (300) based on sufficiently matching location of said user's monitored and tracked user client device 130 (200) with said selected place 2105 on maps 2110 associated identified location or selected place 2105 on maps 2110 associated URL associated location, wherein location of place of business comprises geo-coordinates, pointer on map, address, geocodes and pre-defined geofence on maps associated with said selected place on map associated identified merchant. So automatically connect user application 290 with merchant application 390 only when user 101 or user client device 130 (200) enters and dwell into said selected place on map associated merchant's offline store or location of place of business of said selected place on map associated merchant. In the event of exiting from location or geofence of said selected place on map associated place or place of business (e.g. store, shop, hotel, patrol pump, parking, toll, and like), automatically disconnect said user client application 290 from said merchant client application 390. In other embodiment user 101 can select connect button or control 2205 to send request to connect said selected place associated identified merchant client application 390 to server device(s) 100 module 193. Server device(s) 100 module 193, send said request to merchant client application 399 (390) on merchant client device 175 (300). In an embodiment based on settings provided by merchant 102 though merchant client application 390, automatically connect received request to connect from user client application 290 of user client device 130 (200). In another embodiment merchant can view received request or view received request with associated purpose to connect, requirement, task, required action detail and accept or reject request by selecting accept or reject button or ignore request or schedule connection. In another embodiment in the event of selecting of place 2105 on maps 2110 and selecting associated webpage or website uniform resource locator (URL) 2140 or 2145 or selecting place 2105 on maps 2110 and select order and payment button or control 2102 and ordering of selected products or services from user interface 2210 of user client application 290 of user client device 130 (200) then automatically connect said user or customer 101 with said selected place associated identified merchant 101 client application 390. In an embodiment after fulfillment of delivery or manually receiving of instruction from user or merchant to disconnect or exiting from pre-defined geofence of said place of business, automatically disconnect user from said connected merchant.

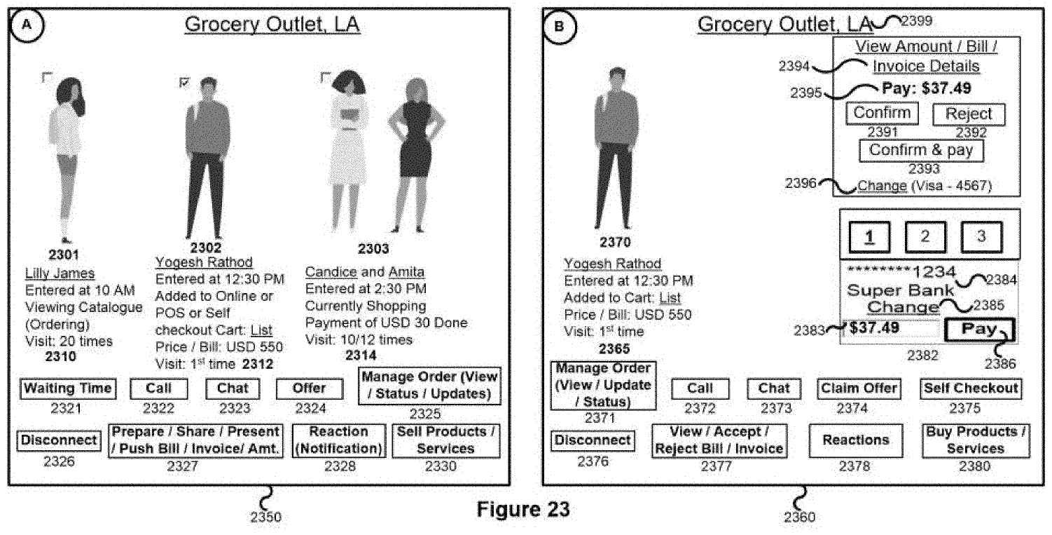

FIG. 23 (A) illustrates after establishing of connection between user 101 via user client application 290 with merchant 102 via merchant client application 290, merchant or authorized user having rights to access merchant client application 101 can view said connected user's or customer's details including avatar or photo or image or video or animation or graphical representation of connected user (2301/2302/2303), name, activity details and status, date & time and triggered event, associated call-to-actions, and statistics (2310/2312/2314), wherein status comprises user 101 arriving or entering at said connected merchant's 102 place of business 2105. Customer who made advance order remotely or online and wants to take away 2215 as per schedule date time or currently arriving at store or place of business to take away 2105 shows estimated time & distance to arrive, show customer's route from source to arriving at store on map. Merchant application 390 displaying arrived or entered status. Merchant application 390 shows order details including customer name, ordered products and/or services, quantity, amount or price, status, activity and status name a details statistic (2310/2312/2314). Merchant application 390 automatically sends welcome message on user client application 290 or merchant can send custom welcome message to said arrived user or customer. Merchant application 390 displays ordering status of said connected and arrived or entered user (user can manually order or select item(s) from menu or select products or services from catalogues and consume at store 2105). Merchant can establish communication session 2322/2323 with user or user establish communication session 2372/2373 with merchant to make order, ask queries, provide instruction and customization request. Merchant or authorized staff can view order details including name, quantity of ordered products and/or services, selected option including delivery 2210, takeway 2215 and eat at store 2105 and payment details including amount, payment method, date and time of payment, payment status including payment pending or done, updated order details and manually set ordered status 2325 or automatically set ordered status based on providing order by user from user client application 290. Merchant can provide order status 2325 including order accepted or rejected, order pending, order done or order ready, order updated, order served or delivered to customer of delivery person. Merchant can share or sent or push bill or updated bill or invoice 2240 or 2327 for said user or customer's approval including accept bill and make total billed amount payment or reject bill or request to change bill. After making of payment by user, merchant's application 390 can displays payment done status. Merchant can view length of duration of dwelling in store or place of business by said customer. Merchant 101 can provide offers 2324 including coupon code, gift card, membership, redeemable points, discount or free items or samples on next visit, provide rule based offer e.g. if advance book or amount or festival then provide offer), cross sell or up sell with customer, ask customer about customer's next visit, refer friends or contacts. Merchant can provide one or more types of reactions 2328 including like, rate, comment, get feedback or complaint or survey, take call-to-action from user including get contact information, request to follow or add to favorite. Merchant can view “Exit” status of user. Merchant can communicate with user if need e.g. remind for pending bill, forget phone and like. In an embodiment enable merchant 102 to disconnect 2326 with selected connected customer or user 101 or user client application 290.

In an embodiment FIG. 23 (B) illustrates after establishing of connection between user 101 via user client application 290 with merchant 102 via merchant client application 290, displaying user's avatar 2370 or profile photo or video or image or animation or graphical representation of user 2370, user name, activity and status details including type, name, date and time, ordered product details, and statistics 2365 associated with said ordered place or user visited place 2399, make order, view provided order, update order or view updated order details, view current order status. Connected user 101 can communicate 2372/2374 with connected merchant 102 via user client application 290, claim offer 2374, disconnect with connected merchant 2376, view pushed or received or presented bill or invoice 2377/2394 or total billed amount 2395 and can accept 2391 or reject 2392 or confirm and pay 2393 said billed amount 2394/2395 or cancel or ignore bill or request to change or update bill or invoice 2377 and in the event of accepting of said bill or invoice, automatically make payment of said billed amount from said user's 101 account to said connected merchant's 102 account, provide one or more types of reactions including like, dislike, rate, comment, feedback, complaint, suggestion, fill survey forms and buy merchant presented products and services 2380.

In an embodiment identifying entering or arriving status of said user in said merchant's place of business or pre-defined geofence associated with said place of business based on sufficiently matching location of said user's monitored and tracked user client device 130 (200) with said selected place 2105 on maps 2110 associated identified location or selected place 2105 on maps 2110 associated uniform resource locator (URL) associated location, wherein location of place of business comprises geo-coordinates, pointer on map, address, geocodes and pre-defined geofence on maps associated with said selected place on map associated identified merchant.

In an embodiment user 101 can make manually order or collect items manually from store (e.g. via physical trolly) and scan and add 2210 said products (e.g. via point of sale (POS)) at counter of merchant 102 by merchant staff, wherein in the event of selecting “connect” 2205 by customer 101 from user client application 290 of user client device 130 (200), connecting said user client application 290 with said merchant client application 390 or in another embodiment based on settings including store specific settings automatically connect user client application 290 with said merchant client application 390 based on sufficiently matching location of said user's monitored and tracked user client device 130 (200) with said selected or entered and dwell for pre-set duration place 2105 on maps 2110 associated identified location or selected place 2105 on maps 2110 associated uniform resource locator (URL) associated location, wherein location of place of business comprises geo-coordinates, pointer on map, address, geocodes and pre-defined geofence on maps associated with said selected place or entered or dwell for pre-set duration in place on map associated identified merchant.

After connecting with user client application 290, merchant can view name, photo(s)/video(s) of said user and identify current customer in queue (or automatically sort or order customers or identify user based on calculating nearby or nearest location of user devices in queue). After identifying current customer, merchant 102 can select customer from list of customers and can sent or present or push bill or invoice or total billed amount (after applying offer (e.g. discount), gift card, points, store credit, tax and like) from merchant client device 175 (300) to user client device 290 (200) via server 110 module 190. User client device 290 (200) can view said received bill or invoice and can accept or reject or cancel or ignore or request to update or change bill or invoice (provide reason to change bill or invoice). In the event of accepting (confirm and pay) 2393 said received bill or invoice, automatically make payment of said billed amount 2395 from said user's account 2396 to said connected merchant's account. In another embodiment merchant 102 directly tell amount to customer or user 101 to make payment of total billed amount. User can enter amount 2383 and use pre-set or default account 2384 or change or update 2385 and select account from list of added accounts 2385 or add new account and select account 2385 and click or tap on pay button control 2386 to make payment of said amount 2383 from said user's account to said connected merchant's account.

In an embodiment user can self-checkout 2375/2220 in-store collected and purchased items or products by scanning products via user client application 390 from user client device 130 (200) and make payment of total billed amount (apply offer (e.g. discount), gift card, points, voucher or coupon code, store credit, tax and like) from user selected payment method or payment account to said store associated connected merchant's account. Connected merchant client application 390 can view said added or purchased and scanned products and associated details including product or item name, price, quantity, applied redeemable points, coupon or voucher code, tax and like, total billed amount, user status including enter and dwell (shopping) in store, scanning and adding products, checkout and made payment, payment status including pending payment, requesting discount or negotiation or problem in applying discount or codes or making payment. At exit gate staff of merchant or authorized user of merchant client application 390 (300) can view and manually check added items or products and provide clearance indication to said user or tell user to add forgetter items or products and make pending payment. In another embodiment based on past purchases, number of times and/or total amount of purchase, current amount of purchases, types of items or products, user profile accessed from one or more linked or connected system, service, servers, databases and service providers including user profile from server 110 database 115, merchant can authorized said user to self-checkout or self-checkout and also exit from store without security check.

FIG. 24 illustrates graphical user interface of maps application 2410 including 3^{rd} parties maps (e.g. Google Maps), wherein user can select place, select current place, select current location of user client device 130 surround place, select place from nearby places, select “Pharmacy” or “Medical Store” or “Chemist” category and select place from displayed nearby pharmacies or medical stores or chemists. For example in the event of selecting medical store or place 2405 on maps 2410 and in the event of clicking or tapping or inputting or selecting merchant's website uniform resource locator (URL) or web address 2440 or 2442 or in another embodiment directly inputting or selecting uniform resource locator (URL) 2450 in web browser 282, server 110 module 189 receives request to access said clicked or tapped or selected website uniform resource locator (URL) or web address 2440 or 2442 associated website or webpage from maps 2410 or from selected place details interface 2420 of maps application 281 or from browser application 282 of user client device 130 (200). Server 110 module 189 invoking or opening said clicked or tapped or selected website uniform resource locator (URL) or web address 2442/2440 associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 2405 on maps 2410 associated integrated button or control 2401/2402, server 110 module 189 receives request to access said clicked or tapped or selected integrated button or control 2401/2402 associated payment user interface or payment flow 2460 or pushed bill or invoice or amount for requesting payment user interface or payment flow 2480.

After opening said website or webpage 1430 user can log-in and in the event of successful login, user can enter amount 2455, select or change and select account 2462 and make payment of said inputted 2455 amount from said logged in identified user's said selected or pre-set or default identified account to said selected place 2405 associated clicked or tapped or selected uniform resource locator (URL) 2440 or 2442 associated identified merchant's account or said selected place 2405 associated identified merchant's account. After successful payment send payment confirmation message with details including date and time, transaction number, user or patient identity number, photo or video, type or patient account, profile details, amount, notes provided by user, type of payment account, applied promotion, coupon code, gift card, reward point or redeemable points, medical store credit, type, name & number of insurance policy or plan, and used payment method to both user client application 290 and merchant client application 390.

In another embodiment user can make online order by clicking or tapping on “order” button or control 2453 from website or webpage 2430 and select medicines and products from catalogues or select medicines and products based on list of prescribed medicines and products and can select delivery option (provide delivery address) 2471 or takeaway option (schedule or as per date and time provided by merchant) 2472 and make payment of total billed amount 2455 by clicking or tapping on payment button or control 2465 or make payment of total billed amount 2455 after collecting ordered items at home or at delivery address or at store.

In an embodiment user 101 can make manually order or collect items manually from store (e.g. via physical trolly) and scan said products (e.g. via point of sale (POS)) at counter of merchant 102 by merchant staff, wherein in the event of selecting “connect” 2473 by customer 101 from user client application 290 of user client device 130 (200), connecting said user client application 290 with said merchant client application 390 or in another embodiment based on settings including store specific settings automatically connect user client application 290 with said merchant client application 390 based on sufficiently matching location of said user's monitored and tracked user client device 130 (200) with said selected or entered and dwell for pre-set duration place 2405 on maps 2410 associated identified location or selected place 2405 on maps 2410 associated uniform resource locator (URL) associated location, wherein location of place of business comprises geo-coordinates, pointer on map, address, geocodes and pre-defined geofence on maps associated with said selected place or entered or dwell for pre-set duration in place on map associated identified merchant.

After connecting with user client application 290, merchant can view name, photo(s)/video(s) of said user and identify current customer in queue (or automatically sort or order customers or identify user based on calculating nearby or nearest location of user devices in queue). After identifying current customer, merchant 102 can select customer from list of customers and can sent or present or push bill or invoice or total billed amount 2481 (after applying offer (e.g. discount), gift card, points, store credit, tax and like) from merchant client device 175 (300) to user client device 290 (200) via server 110 module 190. User client device 290 (200) can view said received bill or invoice 2481 and can confirm 2482 or reject 2483 or cancel or ignore or request to update or change bill or invoice (provide reason to change bill or invoice) or confirm and make payment 2480 of billed amount. In the event of accepting (confirm and pay) 2484 said received bill or invoice, automatically make payment of said billed amount 2481 from said user's account 1184 to said connected merchant's account. In another embodiment merchant 102 directly tell amount to customer or user 101 to make payment of total billed amount. User can enter amount 2455 and use pre-set or default account or change or update 2462 and select account from list of added accounts or add new account and select account 2462 and click or tap on pay button control 2465 to make payment of said amount 2455 from said user's account to said connected merchant's account.

In an embodiment user can self-checkout 2474 in-store collected and purchased items or products by scanning products via user client application 390 from user client device 130 (200) and make payment of total billed amount (apply offer (e.g. discount), gift card, points, voucher or coupon code, store credit, tax and like) from user selected payment method or payment account to said store associated connected merchant's account. Connected merchant client application 390 can view said added or purchased and scanned products and associated details including medicine or product or item name, item identity, price, quantity, applied redeemable points, coupon or voucher code, tax and like, total billed amount, user status including enter and dwell (shopping) in store, scanning and adding products, checkout and made payment, payment status including pending payment, requesting discount or negotiation or problem in applying discount or codes or making payment. At exit gate staff or in-store staff of merchant or authorized user of merchant client application 390 (300) can view and manually check added items or products and provide clearance indication to said user or tell user to add forgotten items or products and make pending payment. In another embodiment based on type of membership, past purchases, number of times and/or total amount of purchase, current amount of purchases, types of items or products, user profile accessed from one or more linked or connected system, service, servers, databases and service providers including user profile from server 110 database 115, merchant can authorized said user to self-checkout or self-checkout and also exit from store without security check.

In an embodiment in the event of visiting place of doctor or clinic or hospital, automatically connect patient's 101 client application 290 to said visited place associated merchant's client application 390 based on sufficiently matching location of said user's monitored and tracked user client device 130 (200) with said selected doctor or clinic or hospital's place e.g. 1405 on maps 1410 associated identified location or selected place 1405 on maps 1410 associated URL 1440/1442 associated location or selected place 1405 on maps 1410 associated location, wherein location of place of business comprises geo-coordinates, pointer on map, address, geocodes and pre-defined geofence on maps associated with said selected place on map associated identified merchant. So automatically connect user application 290 with merchant application 390 only when user 101 or user client device 130 (200) enters and dwell into said selected place 1405 on maps application 1410 associated merchant's offline location or place of business of said selected place on map associated merchant.

In other embodiment user 101 can select connect button or control 2473 from displayed selected place associated user interface 2430 of user client device 130 (200) to send request to connect said selected place associated identified merchant client application 390 to server device(s) 100 module 193. Server device(s) 100 module 193, send said request to merchant client application 399 (390) on merchant client device 175 (300). In an embodiment based on settings provided by merchant 102 though merchant client application 390, automatically connect received request to connect from user client application 290 of user client device 130 (200). In another embodiment merchant can view received request or view received request with associated purpose to connect, requirement, task, required action detail and accept or reject request by selecting accept or reject button or ignore request or schedule connection.

In an embodiment authorized user or doctor or medicine prescriber of connected merchant client application 390 can select currently attended patient from list of displayed connected penitents or from merchant client application 390 and can select prescribed medicines from central catalogues of medicines served by server device(s) 110 from connected or linked database 115 and if medicine not listed on list then said medicine prescriber can add and suggest medicine which will verified by server amin and can available for other medicine prescribers.

In an embodiment authorized user or doctor or medicine prescriber of connected merchant client application 390 share said prescribed or selected prescribed medicines with said selected currently attended patient from list of displayed connected penitents or from merchant client application 390 to selected patent's 101 client application 290. Server 110 matches said prescribed medicines for particular patient with linked systems and inventory databases of nearby medical stores based on monitored and tracked current location of user client device 130 (200) and identifies said prescribed all or available medicines or lowest priced available medicines or store having highest discount and available medicines and suggest said identified medical stores on maps or searched lists with details including name of medical store, available medicines in said prescribed medicines, address, price, offer including discount, keep ready for takeaway or free home delivery, uniform resource locator (URL), so user can click on or input in web browser said URL 2452/2450 and open said clicked URL associated website or webpage or user interface 2430 related to said medical store and enable user to make order online and make payment or make payment after collection (at home or at delivery address or at store) and select delivery option (select shipping or delivery address) or take away option (schedule or date & time to collect medicines provided by said store when they collect ordered medicine ready for hand delivery).

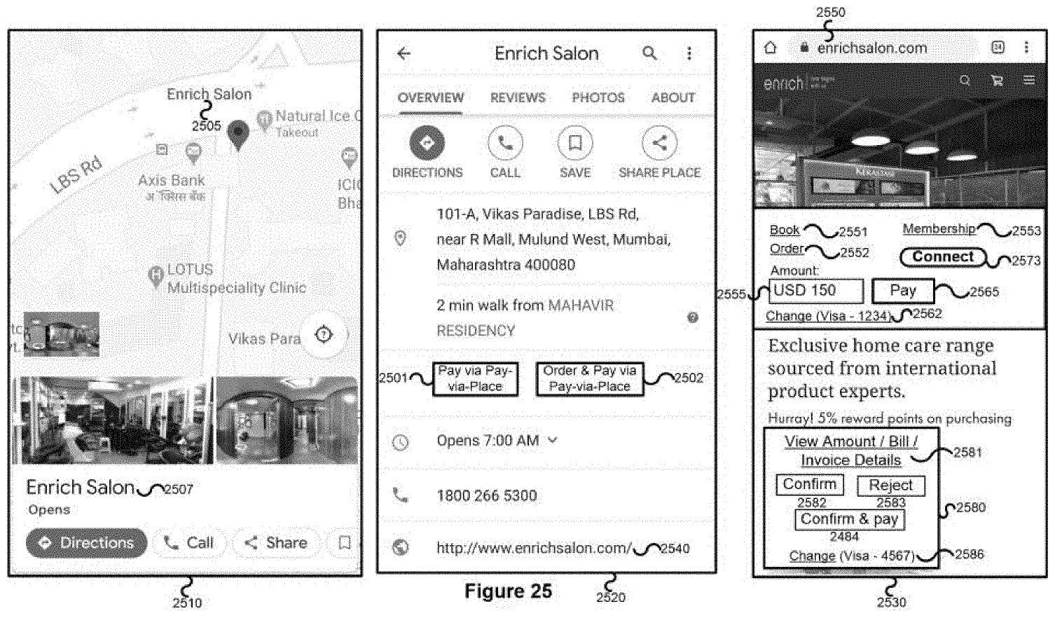

FIG. 25 illustrates maps graphical user interface 2510 including 3rd parties maps like Google Maps 2510, wherein user can select place or identified current place or current location surround or nearest place or search and select place or select place from nearby places or select category (e.g. “Beauty Salon”) and select place from displayed category specific places 2505. For example in the event of selecting place 2505 on maps 2510 and in the event of clicking or tapping or inputting or selecting merchant's website uniform resource locator (URL) or web address 2540 or in another embodiment directly inputting or selecting uniform resource locator (URL) 2550 in web browser 282, server 110 module 189 receives request to access said clicked or tapped or selected website uniform resource locator (URL) or web address 2540 associated website or webpage from maps 2510 or from selected place details interface 2520 of maps application 281 or from browser application 282 of user client device 130 (200). Server 110 module 189 invoking or opening said clicked or tapped or selected website uniform resource locator (URL) or web address 2540 associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 2505 on maps 2510 associated integrated button or control 2501/2502, server 110 module 189 receives request to access said clicked or tapped or selected integrated button or control 2501/2502 associated payment user interface or payment flow 2565 or pushed bill or invoice or amount for requesting payment user interface or payment flow 2580.

After opening said website or webpage 2530 user can log-in and in the event of successful login, user can enter amount 2555, select or change account 2586 and make payment of said inputted 2555 amount from said logged in identified user's said selected or pre-set or default identified account 2586 to said selected place 2505 associated clicked or tapped or selected uniform resource locator (URL) 2540 associated identified merchant's account or said selected place 2505 associated identified merchant's account. After successful payment send payment confirmation message with details including date and time, transaction number, user identity number, photo or video, type of membership account, profile details, amount, notes provided by user, type of payment account, applied promotion, membership benefits (reduced price or discount, free), coupon code, gift card, reward point or redeemable points, store credit and used payment method to both user client application 290 and merchant client application 390.

In an embodiment user can book or schedule an appointment 2551 with said selected place 2505 associated salon or merchant by selecting date and time from available date and time slot, selecting one or more service types or names (e.g. hair cut) from list of service types and names and selecting service person name (e.g. John) from list of service providers and view price, associated offer including membership benefits and discount. User can view total billed amount including tax and charges (e.g. service charges) and can apply membership benefits, store promotion, coupon voucher codes, redeemable points and make payment from user's account to said place 2505 associated merchant's account or said place 2505 associated uniform resource locator (URL) 2540 merchant's account. After successful payment user client application 290 and merchant client application 390 receives payment confirmation message with details including date and time, transaction number, user identity number, photo or video, type of membership account, profile details, amount, notes provided by user, type of payment account, applied promotion, coupon code, gift card, reward point or redeemable points, store credit and used payment method and booking details including date and time of appointment, service type(s) or name(s), service provider name(s).

In an embodiment user 101 can make order 2552 by searching, browsing and selecting products from catalogue and select option including takeaway (schedule or same as booking date & time) or delivery on provided shipping address. User can view total billed amount including tax and charges (e.g. service charges) and can apply membership benefits, store promotion, coupon voucher codes, redeemable points and make payment from user's account to said place 2505 associated merchant's account or said place 2505 associated uniform resource locator (URL) 2540 merchant's account. After successful payment user client application 290 and merchant client application 390 receives payment confirmation message with details including date and time, transaction number, user identity number, photo or video, type of membership account, profile details, amount, notes provided by user, type of payment account, applied promotion, coupon code, gift card, reward point or redeemable points, store credit and used payment method and selected and provided delivery option details including date and time of takeaway or delivery shipping address.

In an embodiment user 101 can make manually order or collect items manually from store (e.g. via physical trolly) and scan said products (e.g. via point of sale (POS)) at counter of merchant 102 by merchant staff, wherein in the event of selecting “connect” 2573 by customer 101 from user client application 290 of user client device 130 (200), connecting said user client application 290 with said merchant client application 390 or in another embodiment based on settings including store specific settings automatically connect user client application 290 with said merchant client application 390 based on sufficiently matching location of said user's monitored and tracked user client device 130 (200) with said selected or entered and dwell for pre-set duration place 2505 on maps 2510 associated identified location or selected place 2505 on maps 2510 associated uniform resource locator (URL) associated location, wherein location of place of business comprises geo-coordinates, pointer on map, address, geocodes and pre-defined geofence on maps associated with said selected place or entered or dwell for pre-set duration in place on map associated identified merchant.

After connecting with user client application 290, merchant can view name, photo(s)/video(s) of said user and identify current customer in queue (or automatically sort or order customers or identify user based on calculating nearby or nearest location of user devices in queue). After identifying current customer, merchant 102 can select customer from list of customers and can sent or present or push bill or invoice or total billed amount 2581 (after applying offer (e.g. discount), gift card, points, store credit, tax and like) from merchant client device 175 (300) to user client device 290 (200) via server 110 module 190. User client device 290 (200) can view said received bill or invoice 2581 and can confirm 2582 or reject 2583 or cancel or ignore or request to update or change bill or invoice (provide reason to change bill or invoice) or confirm and make payment 2584 of billed amount. In the event of accepting (confirm and pay) 2584 said received bill or invoice, automatically make payment of said billed amount 2581 from said user's account 2562 to said connected merchant's account. In another embodiment merchant 102 directly tell amount to customer or user 101 to make payment of total billed amount. User can enter amount 2555 and use pre-set or default account or change or update 2562 and select account from list of added accounts or add new account and select account 2562 and click or tap on pay button control 2565 to make payment of said amount 2555 from said user's account to said connected merchant's account.

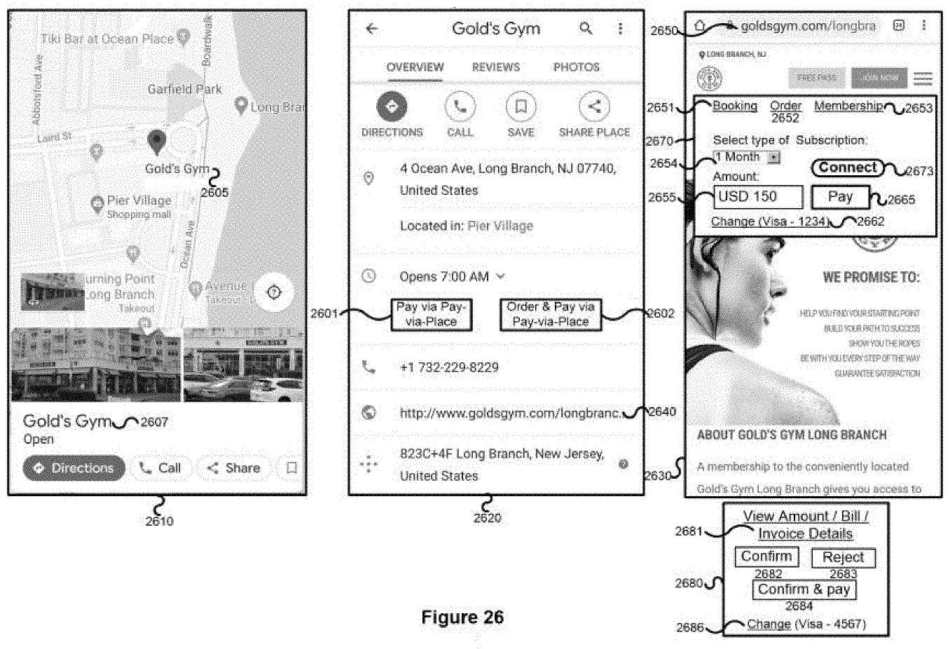

FIG. 26 illustrates maps graphical user interface 2610 including 3rd parties maps like Google Maps 2610, wherein user can select place or identified current place or current location surround or nearest place or search and select place or select place from nearby places or select category (e.g. “Gyms”) and select place from displayed category specific places 2605. For example in the event of selecting place 2605 on maps 2610 and in the event of clicking or tapping or inputting or selecting merchant's website uniform resource locator (URL) or web address 2640 or in another embodiment directly inputting or selecting uniform resource locator (URL) 2650 in web browser 282, server 110 module 189 receives request to access said clicked or tapped or selected website uniform resource locator (URL) or web address 2640 associated website or webpage from maps 2610 or from selected place details interface 2620 of maps application 281 or from browser application 282 of user client device 130 (200). Server 110 module 189 invoking or opening said clicked or tapped or selected website uniform resource locator (URL) or web address 2640 associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 2605 on maps 2610 associated integrated button or control 2601/2602, server 110 module 189 receives request to access said clicked or tapped or selected integrated button or control 2601/2602 associated payment user interface or payment flow 2670 or pushed bill or invoice or amount for requesting payment user interface or payment flow 2680.

After opening said website or webpage 2630 user can log-in and in the event of successful login, user can enter amount 2655 and make payment of said inputted 2655 amount from said logged in identified user's said selected or pre-set or default identified account 2686 to said selected place 2605 associated clicked or tapped or selected uniform resource locator (URL) 2640 associated identified merchant's account or said selected place 2605 associated identified merchant's account. In another embodiment user can select subscription plan including daily, weekly, monthly, yearly, free (trial period), and offer, set automatically make recurring payment as per subscription plan, select or change account 2662 and make total billed amount of payment 2655 from said logged in identified user's said selected or pre-set or default identified account 2662 to said selected place 2605 associated clicked or tapped or selected uniform resource locator (URL) 2640 associated identified merchant's account or said selected place 2605 associated identified merchant's account. After successful payment send payment confirmation message with details including transaction date and time, transaction number, user identity, photo or video, type of membership account, shared profile details, amount, notes provided by user, type of payment account, applied promotion, membership benefits (reduced price or discount, free), coupon code, gift card, reward point or redeemable points, store credit and used payment method to both user client application 290 and merchant client application 390.

In an embodiment user can book or schedule an appointment 2651 with said selected place 2605 associated salon or merchant by selecting date and time from available date and time slot, selecting one or more service types or names (e.g. training class) from list of service types and names and selecting service person name (e.g. John) from list of service providers and view price, associated offer including membership benefits and discount. User can view total billed amount including tax and charges (e.g. service charges) and can apply membership benefits, store promotion, coupon voucher codes, redeemable points and make payment from user's account to said place 2605 associated merchant's account or said place 2605 associated uniform resource locator (URL) 2640 merchant's account. After successful payment user client application 290 and merchant client application 390 receives payment confirmation message with details including date and time, transaction number, user identity number, photo or video, type of membership account, profile details, amount, notes provided by user, type of payment account, applied promotion, coupon code, gift card, reward point or redeemable points, store credit and used payment method and booking details including date and time of appointment, service type(s) or name(s), service provider name(s).

In an embodiment user 101 can make order 2652 by searching, browsing and selecting products from catalogue and select option including takeaway (schedule or same as booking date & time) or delivery on provided shipping address or eat or consume at gym. User can view total billed amount including tax and charges (e.g. service charges) and can apply membership benefits, store promotion, coupon voucher codes, redeemable points and make payment from user's account to said place 2605 associated merchant's account or said place 2605 associated uniform resource locator (URL) 2640 merchant's account. After successful payment user client application 290 and merchant client application 390 receives payment confirmation message with details including date and time, transaction number, user identity number, photo or video, type of membership account, profile details, amount, notes provided by user, type of payment account, applied promotion, coupon code, gift card, reward point or redeemable points, store credit and used payment method and selected and provided delivery option details including date and time of takeaway or delivery shipping address or eat or consume at gym.

In an embodiment user 101 can make manually order or collect items manually from store (e.g. via physical trolly) and scan said products (e.g. via point of sale (POS)) at counter of merchant 102 by merchant staff, wherein in the event of selecting “connect” 2673 by customer 101 from user client application 290 of user client device 130 (200), connecting said user client application 290 with said merchant client application 390 or in another embodiment based on settings including store specific settings automatically connect user client application 290 with said merchant client application 390 based on sufficiently matching location of said user's monitored and tracked user client device 130 (200) with said selected or entered and dwell for pre-set duration place 2605 on maps 2610 associated identified location or selected place 2605 on maps 2610 associated uniform resource locator (URL) associated location, wherein location of place of business comprises geo-coordinates, pointer on map, address, geocodes and pre-defined geofence on maps associated with said selected place or entered or dwell for pre-set duration in place on map associated identified merchant.

After connecting with user client application 290, merchant can view name, photo(s)/video(s) of said user and identify current customer in queue (or automatically sort or order customers or identify user based on calculating nearby or nearest location of user devices in queue). After identifying current customer, merchant 102 can select customer from list of customers and can sent or present or push bill or invoice or total billed amount 2681 (after applying offer (e.g. discount), gift card, points, store credit, tax and like) from merchant client device 175 (300) to user client device 290 (200) via server 110 module 190. User client device 290 (200) can view said received bill or invoice 2681 and can confirm 2682 or reject 2683 or cancel or ignore or request to update or change bill or invoice (provide reason to change bill or invoice) or confirm and make payment 2684 of billed amount. In the event of accepting (confirm and pay) 2684 said received bill or invoice, automatically make payment of said billed amount 2681 from said user's account 2686 to said connected merchant's account. In another embodiment merchant 102 directly tell amount to customer or user 101 to make payment of total billed amount. User can enter amount 2655 and use pre-set or default account or change or update 2662 and select account from list of added accounts or add new account and select account 2662 and click or tap on pay button control 2670 to make payment of said amount 2655 from said user's account to said connected merchant's account.

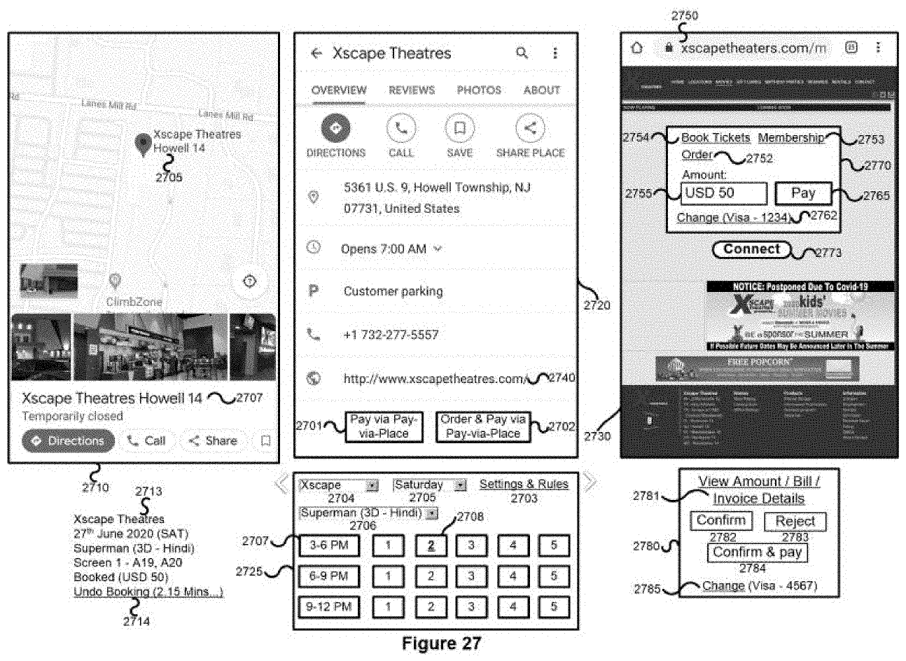

FIG. 27 illustrates maps graphical user interface 2610 including 3rd parties maps like Google Maps 2710, wherein user can select place or identified current place or current location surround or nearest place or search and select place or select place from nearby places or select category (e.g. “Films” or “Theatre”) and select place 2705 from displayed said category specific places. For example in the event of selecting place 2705 on maps 2710 and in the event of clicking or tapping or inputting or selecting merchant's website uniform resource locator (URL) or web address 2740 or in another embodiment directly inputting or selecting uniform resource locator (URL) 2750 in web browser 282, server 110 module 189 receives request to access said clicked or tapped or selected website uniform resource locator (URL) or web address 2740 associated website or webpage from maps 2710 or from selected place details interface 2720 of maps application 281 or from browser application 282 of user client device 130 (200). Server 110 module 189 invoking or opening said clicked or tapped or selected website uniform resource locator (URL) or web address 2740 associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 2705 on maps 2710 associated integrated button or control 2701/2702, server 110 module 189 receives request to access said clicked or tapped or selected integrated button or control 2701/2702 associated payment user interface or payment flow 2770 or pushed bill or invoice or amount for requesting payment user interface or payment flow 2780.

After opening said website or webpage 2730 user can log-in and in the event of successful login, user can enter amount 2755 and make payment of said inputted 2755 amount from said logged in identified user's said selected or pre-set or default identified account 2762 to said selected place 2705 associated clicked or tapped or selected uniform resource locator (URL) 2740 associated identified merchant's account or said selected place 2705 associated identified merchant's account. In another embodiment user can select movie name, date and show time, number of tickets and select seats or in another embodiment based on settings automatically select theatre 2704 based on said selected place 2705 on maps 2710, select pre-set or rule base date or day 2705 based on pre-set day, today, next festival date, movie name 2706 based on rank, marked as hit or determine or identify as hit movie or top ranked movie in this week which not seen by user, show time 2707 based on pre-set show time or available next show time or available next show time within pre-set ranges of timings and number of tickets or highlight number of tickets 2708 and enable user to one tap or click or select on number of tickets 2708 or any ticket number selected by user from displayed ticket number list, seat numbers based on behind available row and corner seats then behind available row next available seats and book and make payment based on pre-set automatically make payment setting, select pre-set or default account 2762 and make payment of said total billed amount 2755 from said logged in identified user's said selected or pre-set or default identified account 2762 to said selected place 2705 associated clicked or tapped or selected uniform resource locator (URL) 2740 associated identified merchant's account or said selected place 2705 associated identified merchant's account. In another embodiment based on settings automatically select theatre 2704 based on said selected place 2705 on maps 2710, select movie name 2706 based on rank, marked as hit or determine or identify as hit movie or top ranked movie in this week which not seen by user, select particular movie show time displayed in particular date or day from displayed calendar user interface, select pre-set number of tickets and enable user to one tap or click or select on show time, select seat numbers based on pre-set behind available row and corner seats, if not then behind available row next available seats and book and make payment based on pre-set automatically make payment setting, select pre-set or default account 2762 and make payment of said total billed amount 2755 from said logged in identified user's said selected or pre-set or default identified account 2762 to said selected place 2705 associated clicked or tapped or selected uniform resource locator (URL) 2740 associated identified merchant's account or said selected place 2705 associated identified merchant's account. After successful payment send payment and booking confirmation message 2713 with details including transaction date and time, transaction number, user identity, photo or video, type of membership account, shared profile details, amount, notes provided by user, type of payment account, applied promotion, membership benefits (reduced price or discount, free), coupon code, gift card, reward point or redeemable points, theatre credit and used payment method and booked ticket details to user client application 290 and merchant client application 390. In an embodiment user can undo booking by clicking or tapping on “Undo Booking” option 2714.

In an embodiment user 101 can make order 2752 by searching, browsing and selecting products from catalogue and select option including takeaway (schedule or same as booking date & time) or delivery at particular date, time, screen number and seat number. User can view total billed amount including tax and charges (e.g. service charges) and can apply membership benefits, store promotion, coupon voucher codes, redeemable points and make payment from user's account to said place 2705 associated merchant's account or said place 2705 associated uniform resource locator (URL) 2740 merchant's account. After successful payment user client application 290 and merchant client application 390 receives payment confirmation message with details including transaction date and time, transaction number, user identity, user photo or video, type of membership account, shared profile details, amount, notes provided by user, type of payment account, applied promotion, coupon code, gift card, reward point or redeemable points, store credit and used payment method and selected and provided delivery option details including date and time of takeaway or date and time, screen number and seat number of delivery.

In an embodiment user 101 can make manually order or collect items manually from store (e.g. from counter inside theatre) and scan said products (e.g. via point of sale (POS)) at counter of merchant 102 by merchant staff, wherein in the event of selecting “connect” 2773 by customer 101 from user client application 290 of user client device 130 (200), connecting said user client application 290 with said merchant client application 390 or in another embodiment based on settings including store specific settings automatically connect user client application 290 with said merchant client application 390 based on sufficiently matching location of said user's monitored and tracked user client device 130 (200) with said selected or entered and dwell for pre-set duration place 2705 on maps 2710 associated identified location or selected place 2705 on maps 2710 associated uniform resource locator (URL) associated location, wherein location of place of business comprises geo-coordinates, pointer on map, address, geocodes and pre-defined geofence on maps associated with said selected place or entered or dwell for pre-set duration in place on map associated identified merchant.

After connecting with user client application 290, merchant can view name, photo(s)/video(s) of said user and identify current customer in queue (or automatically sort or order customers or identify user based on calculating nearby or nearest location of user devices in queue). After identifying current customer, merchant 102 can select customer from list of customers and can sent or present or push bill or invoice or total billed amount 2781 (after applying offer (e.g. discount), gift card, points, store credit, tax and like) from merchant client device 175 (300) to user client device 290 (200) via server 110 module 190. User client device 290 (200) can view said received bill or invoice 2781 and can confirm 2782 or reject 2783 or cancel or ignore or request to update or change bill or invoice (provide reason to change bill or invoice) or confirm and make payment 2784 of billed amount. In the event of accepting (confirm and pay) 2784 said received bill or invoice, automatically make payment of said billed amount 2781 from said user's account 2785 to said connected merchant's account. In another embodiment merchant 102 directly tell amount to customer or user 101 to make payment of total billed amount. User can enter amount 2755 and use pre-set or default account or change or update 2762 and select account from list of added accounts or add new account and select account 2762 and click or tap on pay button control 2765 to make payment of said amount 2755 from said user's account to said connected merchant's account.

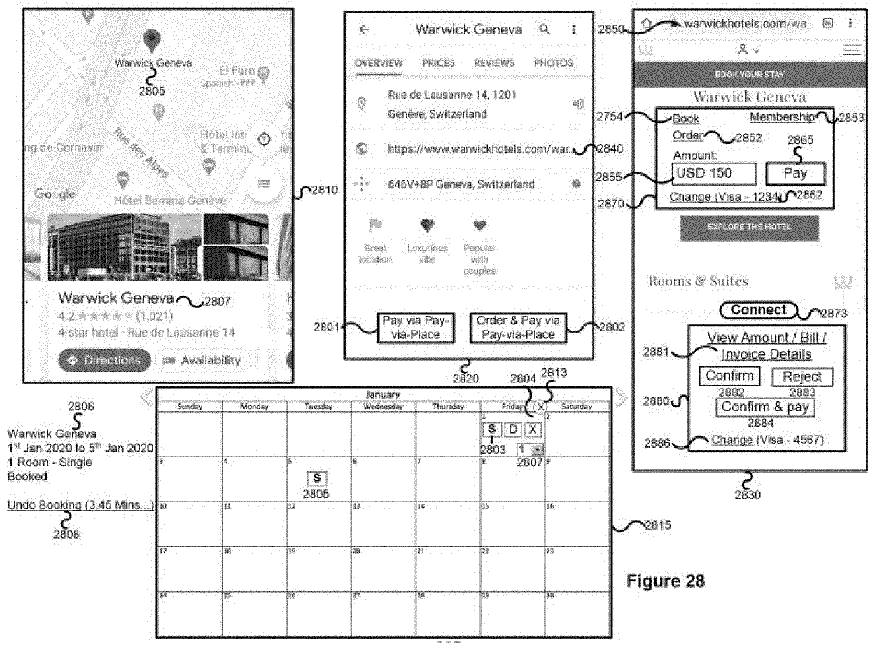

FIG. 28 illustrates maps graphical user interface 2810 including 3rd parties maps like Google Maps 2810, wherein user can select place or identified current place or current location surround or nearest place or search and select place or select place from nearby places or select category (e.g. “Hotels”) and select place 2805 from displayed said selected category specific places. For example in the event of selecting place 2805 on maps 2810 and in the event of clicking or tapping or inputting or selecting merchant's website uniform resource locator (URL) or web address 2840 or in another embodiment directly inputting or selecting uniform resource locator (URL) 2850 in web browser 282, server 110 module 189 receives request to access said clicked or tapped or selected website uniform resource locator (URL) or web address 2840 associated website or webpage from maps 2810 or from selected place details interface 2820 of maps application 281 or from browser application 282 of user client device 130 (200). Server 110 module 189 invoking or opening said clicked or tapped or selected website uniform resource locator (URL) or web address 2840 associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 2805 on maps 2810 associated integrated button or control 2801/2802, server 110 module 189 receives request to access said clicked or tapped or selected integrated button or control 2801/2802 associated payment user interface or payment flow 2870 or pushed bill or invoice or amount for requesting payment user interface or payment flow 2880.

After opening said website or webpage 2830 user can log-in and in the event of successful login, user can enter amount 2855 and make payment of said inputted 2855 amount from said logged in identified user's said selected or pre-set or default identified account 2862 to said selected place 2705 associated clicked or tapped or selected uniform resource locator (URL) 2840 associated identified merchant's account or said selected place 2805 associated identified merchant's account. In another embodiment user can book hotel name by selecting type of room 2803 (e.g. single room) from list of types of rooms displayed inside selected date 2804 in calendar user interface 2815 and in the event of selecting said start date and type of room, displaying said type of room symbol “S” 2805 in all other dates after the start date in calendar user interface, so user can click or tap or select on said symbol 2805 to provide indication of end date of booking of room and based on pre-set automatically make payment setting, select pre-set or default account 2862 and make payment of said total billed amount 2855 from said logged in identified user's said selected or pre-set or default identified account 2862 to said selected place 2805 associated clicked or tapped or selected uniform resource locator (URL) 2840 associated identified merchant's account or said selected place 2805 associated identified merchant's account. User can select number of rooms from list 2807. After successful payment send payment and booking confirmation message 2806 with details including transaction date and time, transaction number, user identity, photo or video, type of membership account, shared profile details, amount, notes provided by user, type of payment account, applied promotion, membership benefits (reduced price or discount, free), coupon code, gift card, reward point or redeemable points, hotel credit and used payment method and booked ticket details 2806 including hotel name, number of rooms, stat and end date, and type of room to user client application 290 and merchant client application 390. In an embodiment user can undo booking by clicking or tapping on “Undo Booking” option 2808.

In an embodiment user 101 can make order 2852 by searching, browsing and selecting products from catalogue and select option including takeaway (schedule) or delivery at particular date & time or now at user's or guest's booked room. User can view total billed amount including tax and charges (e.g. service charges) and can apply membership benefits, store promotion, coupon voucher codes, redeemable points and make payment from user's account to said place 2805 associated merchant's account or said place 2805 associated uniform resource locator (URL) 2840 merchant's account. After successful payment user client application 290 and merchant client application 390 receives payment confirmation message with details including transaction date and time, transaction number, user identity, user photo or video, type of membership account, shared profile details, amount, notes provided by user, type of payment account, applied promotion, coupon code, gift card, reward point or redeemable points, store credit and used payment method and selected and provided delivery option details including date and time of takeaway or date & time and room number for delivery at room.

In an embodiment user 101 can make manually order or collect items manually from store (e.g. from counter inside theatre) and scan said products (e.g. via point of sale (POS)) at counter of merchant 102 by merchant staff, wherein in the event of selecting “connect” 2873 by customer 101 from user client application 290 of user client device 130 (200), connecting said user client application 290 with said merchant client application 390 or in another embodiment based on settings including store specific settings automatically connect user client application 290 with said merchant client application 390 based on sufficiently matching location of said user's monitored and tracked user client device 130 (200) with said selected or entered and dwell for pre-set duration place 2805 on maps 2810 associated identified location or selected place 2805 on maps 2810 associated uniform resource locator (URL) associated location, wherein location of place of business comprises geo-coordinates, pointer on map, address, geocodes and pre-defined geofence on maps associated with said selected place or entered or dwell for pre-set duration in place on map associated identified merchant.

After connecting with user client application 290, merchant can view name, photo(s)/video(s) of said user and identify current customer in queue (or automatically sort or order customers or identify user based on calculating nearby or nearest location of user devices in queue). After identifying current customer, merchant 102 can select customer from list of customers and can sent or present or push bill or invoice or total billed amount 2881 (after applying offer (e.g. discount), gift card, points, store credit, tax and like) from merchant client device 175 (300) to user client device 290 (200) via server 110 module 190. User client device 290 (200) can view said received bill or invoice 2881 and can confirm 2882 or reject 2883 or cancel or ignore or request to update or change bill or invoice (provide reason to change bill or invoice) or confirm and make payment 2884 of billed amount. In the event of accepting (confirm and pay) 2884 said received bill or invoice, automatically make payment of said billed amount 2881 from said user's account 2886 to said connected merchant's account. In another embodiment merchant 102 directly tell amount to customer or user 101 to make payment of total billed amount. User can enter amount 2855 and use pre-set or default account or change or update 2862 and select account from list of added accounts or add new account and select account 2862 and click or tap on pay button control 2865 to make payment of said amount 2855 from said user's account to said connected merchant's account.

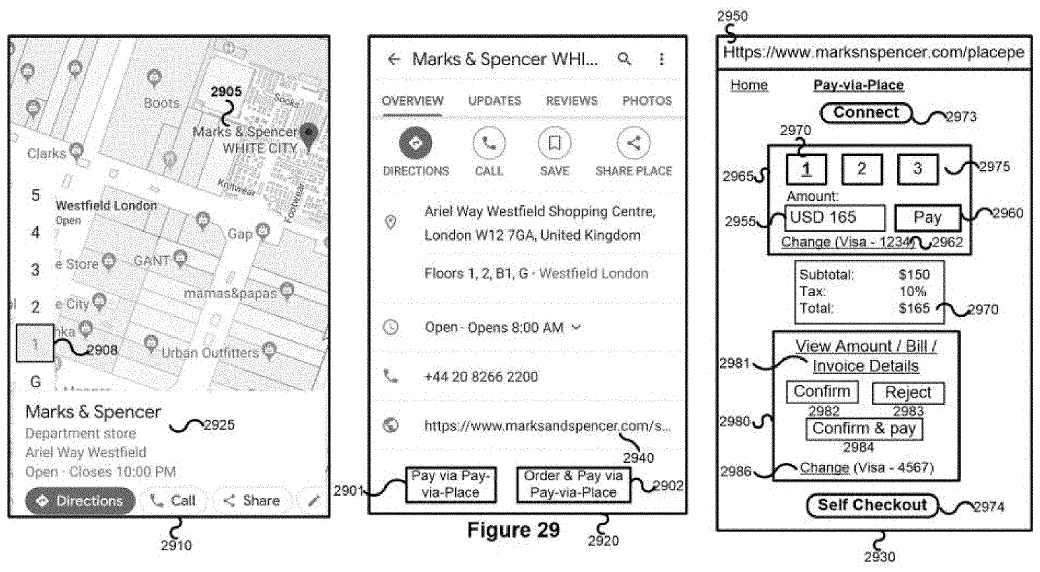

FIG. 29 illustrates graphical user interface wherein in multi-stories building or mall with indoor maps 2910 including 3rd parties maps like Google Maps, user can simply zoom in and out of a building (e.g. mall) and go floor to floor with indoor maps and can switch floors or select particular floor 2908 with a tap and then select place or identified current place or current location surround or nearest place or search and select place or select place from nearby places or select category (e.g. “Clothing”) and select place from displayed category specific places 1205. For example in the event of selecting place 2905 on maps 2910 and in the event of clicking or tapping or inputting or selecting merchant's website uniform resource locator (URL) or web address 2940 or in another embodiment directly inputting or selecting uniform resource locator (URL) 2950 in web browser 282, server 110 module 189 receives request to access said clicked or tapped or selected website uniform resource locator (URL) or web address 2940 associated website or webpage from maps 2910 or from selected place details interface 2920 of maps application 281 or from browser application 282 of user client device 130 (200). Server 110 module 189 invoking or opening said clicked or tapped or selected website uniform resource locator (URL) or web address 2940 associated website or webpage associated with registered merchant or open said website or webpage from merchant's server and load integrated payment user interface (UI) or child webpage from sever 110, wherein said invoked or opened website or webpage is integrated with pay-via-place payments webpage or pay-via-place user interface (UI) flows or pre-made user interface (UI) components via Web (API) or payments APIs provided by server 110/API server (162). In another embodiment in the event of clicking or tapping on said selected place 2905 on maps 2910 associated integrated button or control 2901/2902, server 110 module 189 receives request to access said clicked or tapped or selected integrated button or control 2901/2902 associated payment user interface or payment flow 2965 or pushed bill or invoice or amount for requesting payment user interface or payment flow 2980.

After opening said website or webpage 2930 user can log-in and in the event of successful login, select counter number 2970 (if more than one counter) from displayed list of counter 2975, user can enter amount 2955, select or change account 2962 and make payment of said inputted 2955 amount from said logged in identified user's said selected or pre-set or default identified account to said selected place 2905 associated clicked or tapped or selected uniform resource locator (URL) 2940 associated identified merchant's account or said selected place 2905 associated identified merchant's account. After successful payment send payment confirmation message with details including date and time, transaction number, user identity number, photo or video, type of membership account, profile details, amount, notes provided by user, type of payment account, applied promotion, coupon code, gift card, reward point or redeemable points, store credit and used payment method to both user client application 290 and merchant client application 390.

In an embodiment user 101 can make manually order or collect items manually from store (e.g. via physical trolly) and scan said products (e.g. via point of sale (POS)) at counter of merchant 102 by merchant staff, wherein in the event of selecting “connect” 2973 by customer 101 from user client application 290 of user client device 130 (200), connecting said user client application 290 with said merchant client application 390 or in another embodiment based on settings including store specific settings automatically connect user client application 290 with said merchant client application 390 based on sufficiently matching location of said user's monitored and tracked user client device 130 (200) with said selected or entered and dwell for pre-set duration place 2405 on maps 2410 associated identified location or selected place 2905 on maps 2910 associated uniform resource locator (URL) associated location, wherein location of place of business comprises geo-coordinates, pointer on map, address, geocodes and pre-defined geofence on maps associated with said selected place or entered or dwell for pre-set duration in place on map associated identified merchant.

After connecting with user client application 290, merchant can view name, photo(s)/video(s) of said user and identify current customer in queue (or automatically sort or order customers or identify user based on calculating nearby or nearest location of user devices in queue). After identifying current customer, merchant 102 can select customer from list of customers and can sent or present or push bill or invoice or total billed amount 2981 (after applying offer (e.g. discount), gift card, points, store credit, tax and like) from merchant client device 175 (300) to user client device 290 (200) via server 110 module 190. User client device 290 (200) can view said received bill or invoice 2981 and can confirm 2982 or reject 2983 or cancel or ignore or request to update or change bill or invoice (provide reason to change bill or invoice) or confirm and make payment 2984 of billed amount. In the event of accepting (confirm and pay) 2984 said received bill or invoice, automatically make payment of said billed amount 2981 from said user's account 2962 to said connected merchant's account. In another embodiment merchant 102 directly tell amount to customer or user 101 to make payment of total billed amount. User can enter amount 2955 and use pre-set or default account or change or update 2962 and select account from list of added accounts or add new account and select account 2962 and click or tap on pay button control 2960 to make payment of said amount 2955 from said user's account to said connected merchant's account.

In an embodiment user can self-checkout 2974 in-store collected and purchased items or products by scanning code including bar code, QR code and nay other on or more types of codes associated with products via camera application (by employing object recognition techniques) of user client application 390 from user client device 130 (200) and make payment of total billed amount (apply offer (e.g. discount), gift card, points, voucher or coupon code, store credit, tax and like) from user selected payment method or payment account 2962 to said store associated connected merchant's account. Connected merchant client application 390 can view said added or purchased and scanned products and associated details including product or item name, item identity, price, quantity, applied redeemable points, coupon or voucher code, tax and like, total billed amount, user status including enter and dwell (shopping) in store, scanning and adding products, checkout and made payment, payment status including pending payment, requesting discount or negotiation or problem in applying discount or codes or making payment. At exit gate staff or in-store staff of merchant or authorized user of merchant client application 390 (300) can view and manually check added items or products and provide clearance indication to said user or tell user to add forgotten items or products and make pending payment. In another embodiment based on type of membership, past purchases, number of times and/or total amount of purchase, current amount of purchases, types of items or products, user profile accessed from one or more linked or connected system, service, servers, databases and service providers including user profile from server 110 database 115, merchant can authorized said user to self-checkout or self-checkout and also exit from store without security check.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media. Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims. Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

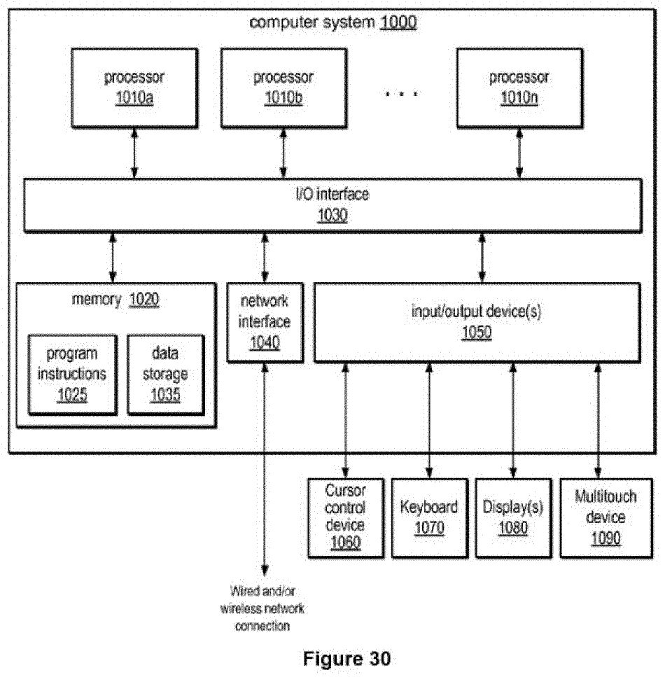

Various components of embodiments of methods as illustrated and described in the accompanying description may be executed on one or more computer systems, which may interact with various other devices. One such computer system is illustrated by FIG. 30. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010. Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

As shown in FIG. 30, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Additionally, or alternatively, the communication interface may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies. Links may connect client system 130 (200), 175 (300), platform system 110, and third-party system (e.g. 135) to communication network 125 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 100. One or more first links may differ in one or more respects from one or more second links.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense. The terms “comprises”, “comprising”, or any other variations thereof, are intended to cover a non-exclusive inclusion, such that a process or method that comprises a list of steps does not include only those steps but may include other steps not expressly listed or inherent to such a process or a method. Similarly, one or more devices or sub-systems or elements or structures or components preceded by “comprises . . . a” does not, without more constraints, preclude the existence of other devices, other sub-systems, other elements, other structures, other components, additional devices, additional sub-systems, additional elements, additional structures, or additional components. Appearances of the phrase “in an embodiment”, “in another embodiment” and similar language throughout this specification may, but do not necessarily, all refer to the same embodiment.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof. Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

I claim:

1. The computer implemented method comprising:
a) in the event of selecting place on maps and selecting said selected place associated unique website or webpage uniform resource locator (URL) or link or web address, opening or invoking said selected or tapped or clicked uniform resource locator (URL) associated website or webpage;
b) identifying identity of merchant and associated merchant account including merchant bank account or debit card details based on said selected identified place on maps or selected place on maps associated selected website or webpage uniform resource locator (URL) or link or web address; and
c) transferring entered or selected or pushed or default amount from user selected or pre-set or default user account to said identified merchant account.

2. The computer implemented method of claim 1 wherein, from the opened or invoked said selected or tapped or clicked uniform resource locator (URL) associated website or webpage, enabling user to select sub-place within or inside said selected place or geofence associated with said selected place from displayed list of sub-places; identifying identity of merchant and associated merchant account including merchant bank account or debit card details based on said selected sub-place; and transferring entered or selected or pushed or default amount from user selected or pre-set or default user account to said selected sub-place associated identified merchant account.

3. The computer implemented method of claim 1 wherein enable user to select number including floor number from list of numbers including floor numbers; enable user to use the level switcher to move from floor to floor in the building or switch floors including zoom in and out of a building and go floor to floor with maps including indoor maps or use indoor maps to view floor plans, wherein building may comprises airports, malls, stadiums; receiving, from the user, selection of particular number including floor number; displaying maps including indoor maps or maps of indoor locations or indoor floor plan of a building related to said selected number including floor number; displaying said selected number including floor number associated places on maps including indoor maps or maps of indoor locations or indoor floor plan; enabling user to search and select or select place from said selected number including floor number associated places on maps including indoor maps or maps of indoor locations or indoor floor plan.

4. The computer implemented method of claim 1 wherein displaying on maps or list or maps linked list, current location associated place or current location surround place(s) or one or more searched places or nearby places or selected category specific places or bookmarked, favorite, liked, suggested, visited, transacted place(s).

5. The computer implemented method of claim 1 wherein identifying user based on log-in information including unique user identity or one or more types of unique user device identity.

6. The computer implemented method of claim 1 wherein associating unique website or webpage uniform resource locator (URL) or link or web address with unique place identity or merchant identity.

7. The computer implemented method of claim 1 wherein said invoked or opened website or webpage enables user to make entered or selected or pushed amount of payment from user's selected or default or selected account or payment methods including one or more debit cards, credit cards, digital wallets, direct bank transfer or net baking, unified payment interface (UPI), crypto currency, pay later, pay via installments or EMI, payment account, direct carrier billing (DCB) and pay via offers or redeemable points or vouchers or coupons or gift card or store credit to said selected place on maps associated merchant's account or said selected place on maps associated selected website or webpage uniform resource locator (URL) or web address associated merchant's account.

8. The computer implemented method of claim 1 wherein invoke said website or webpage from pay-via-place server.

9. The computer implemented method of claim 1 wherein invoke said website or webpage from server of merchant and load integrated payment user interface (UI) or child webpage from pay-via-place sever, wherein said invoked or opened website or webpage is integrated with pay-via-place payments webpage or pay-via-place user interface (UI) flows or pre-made user interface (UI) components via Web application programming interface (API) or payments APIs provided by pay-via-place server or application programming interface (API) server.

10. The computer implemented method of claim 1 wherein detect, identify and calculate that selected place is near to monitored and tracked current location of user client device else notify user that said selected place is far from monitored and tracked current location of user client device, wherein near or far is calculated based on pre-set distance in number of meter(s).

11. The computer implemented system comprises:
a) in the event of selecting place on maps and selecting said selected place associated unique website or webpage uniform resource locator (URL) or link or web address, open or invoke said selected or tapped or clicked uniform resource locator (URL) associated website or webpage;
b) identify identity of merchant and associated merchant account including merchant bank account or debit card details based on said selected identified place on maps or selected place on maps associated selected website or webpage uniform resource locator (URL) or link or web address; and
c) transfer entered or selected or pushed or default amount from user selected or pre-set or default user account to said identified merchant account.

12. The computer implemented system of claim 11 wherein, from the opened or invoked said selected or tapped or clicked uniform resource locator (URL) associated website or webpage, enable user to select sub-place within or inside said selected place or geofence associated with said selected place from displayed list of sub-places; identify identity of merchant and associated merchant account including merchant bank account or debit card details based on said selected sub-place; and transfer entered or selected or pushed or default amount from user selected or pre-set or default user account to said selected sub-place associated identified merchant account.

13. The computer implemented system of claim 11 wherein enable user to select number including floor number from list of numbers including floor numbers; enable user to use the level switcher to move from floor to floor in the building or switch floors including zoom in and out of a building and go floor to floor with maps including indoor maps or use indoor maps to view floor plans, wherein building may comprises airports, malls, stadiums; receiving, from the user, selection of particular number including floor number; displaying maps including indoor maps or maps of indoor locations or indoor floor plan of a building related to said selected number including floor number; displaying said selected number including floor number associated places on maps including indoor maps or maps of indoor locations or indoor floor plan; enabling user to search and select or select place from said selected number including floor number associated places on maps including indoor maps or maps of indoor locations or indoor floor plan.

14. The computer implemented system of claim 11 wherein display on maps or list or maps linked list, current location associated place or current location surround place(s) or one or more searched places or nearby places or selected category specific places or bookmarked, favorite, liked, suggested, visited, transacted place(s).

15. The computer implemented system of claim 11 wherein identify user based on log-in information including unique user identity or one or more types of unique user device identity.

16. The computer implemented system of claim 11 wherein associate unique website or webpage uniform resource locator (URL) or link or web address with unique place identity or merchant identity.

17. The computer implemented system of claim 11 wherein said invoked or opened website or webpage enables user to make entered or selected or pushed amount of payment from user's selected or default or selected account or payment methods including one or more debit cards, credit cards, digital wallets, direct bank transfer or net baking, unified payment interface (UPI), crypto currency, pay later, pay via installments or EMI, payment account, direct carrier billing (DCB) and pay via offers or redeemable points or vouchers or coupons or gift card or store credit to said selected place on maps associated merchant's account or said selected place on maps associated selected website or webpage uniform resource locator (URL) or web address associated merchant's account.

18. The computer implemented system of claim 11 wherein invoke said website or webpage from pay-via-place server.

19. The computer implemented system of claim 11 wherein invoke said website or webpage from server of merchant and load integrated payment user interface (UI) or child webpage from pay-via-place sever, wherein said invoked or opened website or webpage is integrated with pay-via-place payments webpage or pay-via-place user interface (UI) flows or pre-made user interface (UI) components via Web application programming interface (API) or payments APIs provided by pay-via-place server or application programming interface (API) server.

20. The computer implemented system of claim 11 wherein detect, identify and calculate that selected place is near to monitored and tracked current location of user client device else notify user that said selected place is far from monitored and tracked current location of user client device, wherein near or far is calculated based on pre-set distance in number of meter(s).

21. A computer implemented method for completing a transaction, the method comprising:
identifying merchant identity and associated merchant details, merchant bank account details or debit card details based on user selected website URL associated with selected place on maps or selected place on maps associated merchant bank account details or debit card details;
generating, by a merchant client application of merchant client device, a payload for the transaction, wherein the payload comprises at least an encrypted payment information;
establishing a connection with the merchant client application of merchant client device, by a user client application of a user client device;
fetching or receiving or pulling, by the user client application of the user client device, the payload for the transaction from the merchant client application of the merchant client device;
communicating, by the user client application of the user client device, the payload for the transaction to an authentication server; and
completing the transaction, by the user client application of the user client device, upon successful authentication of the payload for the transaction by the authentication server.

22. The computer implemented method of claim 21, wherein generating the payload for the transaction is based at least on an input from a user of the merchant client device.

23. The computer implemented method of claim 21, wherein broadcasting the presence of the merchant client device comprises allow to access location of the merchant client application of the merchant client device or turn on use location service of merchant client device and turn on or allow to Wi-Fi scanning and Bluetooth scanning for location accuracy by the user of the merchant client device.

24. The computer implemented method of claim 21, wherein authenticating the payload for the transaction by the authentication server comprises: receiving the payload for the transaction from the user device; locating the user device to determine a location of the merchant client device; and authenticating the payload for the transaction if the location of the merchant client device is within a pre-defined location to complete the transaction.

25. The computer implemented method of claim 21 wherein in the event of selecting place on maps or in the event of selecting place on maps and selecting said selected place associated website URL and selecting connect button or control from said website or webpage URL associated opened or displayed website or webpage, establishing a connection with the merchant client application of merchant client device, by a client application of a user client device.

26. The computer implemented method of claim 21, further comprising allowing to connect merchant client application of merchant client device with user client application of user client device by authorized user(s) of merchant client application of merchant client device or allowing to connect user client application of user client device with merchant client application of merchant client device by user client application of user client device may base on sufficiently matching location of said monitored and tracked user client device with said user selected place associated identified location or selected place on maps associated URL associated identified location, wherein location of place of business comprises geo-coordinates, pointer on map, address, geocodes and pre-defined geofence on maps associated with said selected place on map associated identified merchant or said selected place on map associated selected website or webpage uniform resource locator (URL) associated identified merchant.

27. A computer implemented system for completing a transaction, the system comprises:
identify merchant identity and associated merchant details, merchant bank account details or debit card details based on user selected website URL associated with selected place on maps or selected place on maps associated merchant bank account details or debit card details;
generate, by a merchant client application of merchant client device, a payload for the transaction, wherein the payload comprises at least an encrypted payment information;
establish a connection with the merchant client application of merchant client device, by a user client application of a user client device;
fetch or receive or pull, by the user client application of the user client device, the payload for the transaction from the merchant client application of the merchant client device;
communicate, by the user client application of the user client device, the payload for the transaction to an authentication server; and
complete the transaction, by the user client application of the user client device, upon successful authentication of the payload for the transaction by the authentication server.

28. The computer implemented system of claim 27, wherein generate the payload for the transaction is based at least on an input from a user of the merchant client device.

29. The computer implemented system of claim 27, wherein broadcast the presence of the merchant client device comprises allow to access location of the merchant client application of the merchant client device or turn on use location service of merchant client device and turn on or allow to Wi-Fi scanning and Bluetooth scanning for location accuracy by the user of the merchant client device.

30. The computer implemented system of claim 27, wherein authenticate the payload for the transaction by the authentication server comprises: receiving the payload for the transaction from the user device; locating the user device to determine a location of the merchant client device; and authenticating the payload for the transaction if the location of the merchant client device is within a pre-defined location to complete the transaction.

31. The computer implemented system of claim 27 wherein in the event of selecting place on maps or in the event of selecting place on maps and selecting said selected place associated website URL and selecting connect button or control from said website or webpage URL associated opened or displayed website or webpage, establishing a connection with the merchant client application of merchant client device, by a client application of a user client device.

32. The computer implemented system of claim 27, further comprise allow to connect merchant client application of merchant client device with user client application of user client device by authorized user(s) of merchant client application of merchant client device or allowing to connect user client application of user client device with merchant client application of merchant client device by user client application of user client device may base on sufficiently matching location of said monitored and tracked user client device with said user selected place associated identified location or selected place on maps associated URL associated identified location, wherein location of place of business comprises geo-coordinates, pointer on map, address, geocodes and pre-defined geofence on maps associated with said selected place on map associated identified merchant or said selected place on map associated selected website or webpage uniform resource locator (URL) associated identified merchant.
